(19) United States
(12) Patent Application Publication
(10) Pub. No.: US 2007/0067373 A1
(43) Pub. Date: Mar. 22, 2007

(54) Methods and apparatuses to provide mobile applications

(76) Inventors: Steven Higgins, Glen Mills, PA (US); James M. Collins, Barrington Hills, IL (US); Peter Clare, Tiburon, CA (US); Stewart A. Skomra, Poway, CA (US)

Correspondence Address: GREENBERG TRAURIG, LLP, 1900 UNIVERSITY AVENUE, FIFTH FLOOR, EAST PALO ALTO, CA, 94303, US

(21) Appl. No.: 11/485,572

(22) Filed: Jul. 11, 2006

Related U.S. Application Data
(63) Continuation-in-part of application No. 11/387,245, filed on Mar. 22, 2006.
Application No. 11/387,245 is a continuation-in-part of application No. 10/947,566, filed on Sep. 22, 2004.
(60) Provisional application No. 60/517,114, filed on Nov. 3, 2003.
(60) Provisional application No. 60/579,379, filed on Jun. 12, 2004.
(60) Provisional application No. 60/698,676, filed on Jul. 12, 2005.
(60) Provisional application No. 60/737,579, filed on Nov. 16, 2005.

(51) Int. Cl. G06F 17/30

(52) U.S. Cl. 707/206

(57) ABSTRACT

Methods and apparatuses to enable the development, deployment and update of composite applications on mobile devices. In one embodiment, a method processor in a mobile device uses a workflow engine to load modules for execution according to a workflow that specifies the execution flow directions based on the outcomes of the modules. Detached object managers can be used to manage locally data that are checked out from data sources. A object manager can maintain multiple versions of the data locally, receive changes, submit changes, and/or detect conflicts. Conflicts can be resolved over time. Using a check-out check-in model, different devices can work on the same data without having to synchronize with a server sequentially. Data and workflow can be packaged together for transmission over a sometime connected network (e.g., via email) such that a method processor does not have to wait for response if the network connection is not available.

The present patent application is a continuation in part application of: co-pending U.S. patent application Ser. No. 11/387,245, filed on Mar. 22, 2006, which is a continuation in part application of U.S. patent application Ser. No. 10/947,566, filed on Sep. 22, 2004 and claimed the priority from Provisional U.S. Patent Application Ser. No. 60/517,114 filed on Nov. 3, 2003 and the priority from Provisional U.S. Patent Application Ser. No. 60/579,379 filed on Jun. 12, 2004. The present patent application claims the priority from Provisional U.S. Patent Application Ser. No. 60/698,676, filed Jul. 12, 2005 and the priority from Provisional U.S. Patent Application Ser. No. 60/737,579, filed Nov. 16, 2005. These prior applications are hereby incorporated herein by reference.

### TECHNOLOGY FIELD

At least some embodiments of the present invention relate to computing systems and, more particularly to systems involving mobile computing with flexible architecture for application development, deployment and customization.

### BACKGROUND

Traditionally, an application program for mobile platforms is developed and deployed as one monolithic program with highly inter-dependent parts optimized for performance on a specific hardware platform.

It is very difficult to adapt such monolithic programs to meet the different needs of different users. Since parts of these monolithic programs are highly inter-dependent, a small change in one part of an application program may lead to a chain of changes in many other parts of the application program. Thus, such monolithic programs are typically specially designed and developed only for a specific customer with very high cost and very limited functionality.

Further, when such a monolithic program is to be updated to fix bugs or add functionality, the entire monolithic program is to be re-loaded to the mobile device. Since the size of the entire monolithic program is large, updating mobile devices with such monolithic programs can require very high bandwidth. Thus, Over-the-Air (OTA) updating of such monolithic programs for a large population of mobile devices can be very difficult, if not impossible.

Further, since the monolithic programs are specifically designed for specific customers by different vendors, it is very difficult, if not impossible, for the customers to re-arrange the programs to meet the changing needs of the customers. Typically, source code level access is required to reuse the components of the monolithic programs. However, software vendors are typically reluctant to reveal the source code of the monolithic programs. Thus, it would be a very difficult task for the customers to combine certain features of the monolithic programs to make a new composite application.

In general, many application programs are designed for a more or less specified targeted environment, a platform, which may be identified by a particular configuration of hardware and/or software. A platform may be based substantially on software, called a virtual machine.

A virtual machine may be a virtual machine emulator, which includes a software program that emulates a hardware system.

A virtual machine may be a virtual machine environment, which includes an operating system running in a virtualized computer. A virtual machine monitor can be used between the hardware and the operating system such that two or more instances of the same operating system, or two or more different operating systems, can run together on the same hardware. From a user perspective, these multiple operation system instances run in the virtualized computer simultaneously or concurrently, as if the virtualized computer were equivalent to a virtual set of multiple computers each running a separate one of the multiple operating system instants, although the operating system instances actually share the same hardware in time. Each operating system instance on the virtualized computer runs its own applications as if the operating system were running on the hardware alone.

An operating system is typically the master software, which controls the hardware of a specific data-processing system, provides a set of interfaces for application programs to access the hardware, and provides functions in a number of common areas, such as user interface, memory management, device management, security, process/job management, etc. Thus, an operating system may be considered as a virtual machine.

An operating system may be called an “executive” or “supervisor.” A virtual machine monitor may be called a “hypervisor.”

A virtual machine may be a virtual machine interpreter, which includes an interpreter for a programming language. A virtual machine interpreter typically runs an application program in an interpretive mode, or in a just-in-time (JIT) compilation mode.

The executable environment in which a program runs can be called the runtime environment, which typically includes the hardware, operating system and other system programs (database, network, etc.). Typically, application programs running in an operating system call upon routines in the operating system to perform input/output, graphical interface and other functions. An application running in a virtual machine interpreter calls upon runtime software in execution. Runtime software of a virtual machine interpreter implemented on a specific operating system provides interpretation services between the application program and the operating system.

For example, Java application programs typically use the Java Virtual Machine runtime environment for execution. The runtime software may interpret the programming language one line at a time and use library routines to implement the instructions of the application program, or compile the entire application program to a set of native instructions of the computer just in time before execution.

An application program written in the Java programming language can be compiled into an intermediate programming language called Java byte code, which may be executed in a number of different ways. For example, in an interpretative mode, Java byte code can be interpreted one line at a time by a Java virtual machine for conversion into a native programming language of a processor for execution. Alternatively, in a just-in-time compilation mode, the entire application program in the Java byte code can be compiled by a just-in-time compiler into the native programming language of the processor, just before the execution of the application program. Alternatively, the application program in the Java programming language may be compiled and optimized directly into the native programming language for execution on the processor. Alternatively, a processor designed with native support for the Java byte code can execute the application program in Java byte code without further software compilation or interpretation.

In general, different programming languages may be compiled into a same intermediate programming language for execution by a virtual machine interpreter. For example, different .NET programming languages, including C# and VB.NET, can be compiled into the Microsoft Intermediate Language (MSIL), which is typically executed by the Common Language Runtime (CLR) software in a computer running an operating system from Microsoft. Microsoft's .NET platform uses the Common Language Runtime (CLR) to compile .NET applications into the native machine language for execution. A subset of the Common Language Runtime (CLR) has been standardized by European Computer Manufacturers Association (ECMA).

Java virtual machine can be implemented in a variety of environments, such as web browser, web server, desktop, etc. A Java program that runs in a web page rendered in a web browser can be called a Java applet. A Java program that runs on a server to assist a web server can be called a Java servlet.

Java 2 Platform, Micro Edition (J2ME) is a version of Java designed for cell phones, Personal Digital Assistances (PDAs) and consumer appliances. J2ME uses a Java interpreter specialized for devices with limited memory. J2ME includes different Java profiles, which can be implemented by different J2ME devices. For example, the Mobile Information Device Profile (MIDP) is designed for mobile devices, such as cell phones, with support for a graphical interface, networking and storage; and the Personal Profile is designed for consumer products and embedded devices, such as Set-top boxes and PDAs. Java profiles are based on Java configurations, such as the Connected Limited Device Configuration (CLDC) designed as the strict subset of Java class library and the minimal environment for a Java virtual machine.

Binary Runtime Environment for Wireless (BREW) is an application development environment for enhanced cell phone services (e-mail, games, etc.). BREW applications run on a BREW-enabled cell phone handset independent of the underlying system software of the handset. A software development tool for BREW can compile applications developed for the BREW platform from a number of different programming languages, such as C/C++, into a native programming language of the processor of a BREW-enabled cell phone handset.

On a BREW-enabled device, Java virtual machine can be implemented as an extension to BREW. A Java extension can be installed on top of BREW to allow the execution of Java byte code on a BREW platform. When the Java virtual machine is implemented as an extension to BREW, the implementation can be actually smaller than a Java virtual machine implemented natively and directly on the system software of cellular phones, since an optimized BREW-extension for Java virtual machine can use the existing phone-specific application programming interfaces (APIs) provided by BREW.

In a networked environment, a client computer that requests services may communicate with a server that provides the services through a variety of communication channels.

For example, HyperText Transfer Protocol (HTTP) can be used to request and receive files (e.g., web pages) over a computer network, such as the Internet.

For example, remote procedure call allows one program running in one machine to use the services of another program in a remote machine. Using a set of library routines, a calling program can send a message and data to the remote program, which after being executed can pass the result back to the calling program. Library routines for remote procedure call are designed to carry out the networking details for the communication.

Email provides a way to transmit messages electronically and reliably over a computer network. In an email system, messages may be queued on a sending computer, waiting for a scheduled time slot to upload or transmit the messages, or waiting for the network connection to a receiving computer to become available; on the receiving computer, the messages are typically queued, waiting for the user to process. In certain systems, filter programs may be used to automatically process some incoming messages according to pre-defined rules. Email systems typically support the transmission of electronic messages of a variety of formats, such as plain text, executable code, image files, sound clips, web pages, etc.

Instant messaging uses a real time connection to transmit messages. When the real time connection is broken, messages may be lost. For real time delivery, instant messages are not queued.

### SUMMARY OF THE DESCRIPTION

Methods and apparatuses to enable the development, deployment and update of composite applications on mobile devices are described herein. Some but not all embodiments of the present invention are summarized in this section.

In one embodiment, a method processor in a mobile device may include a workflow engine and a cache manager which looks ahead of the current execution of a workflow to preload modules. The method processor may present modal user interfaces in a non-modal way to eliminate flicker, and use a logger to stamp the workflow related data with real time measurements, such as time, location, and vehicle bus information. The logger may capture screen images and global data of the workflow during the execution. The log data stream may be collected and sent from the mobile device in real time, or in a batch mode, for monitoring, debugging, diagnosing or tuning the execution of a workflow, for providing hot update, help and guidance against deviation during the execution, and for other features.

The present invention includes methods and apparatuses which perform methods as described, including data processing systems which perform these methods, and computer readable media which when executed on data processing systems cause the systems to perform these methods.

Other features of the present invention will be apparent from the accompanying drawings and from the detailed description which follows.

### BRIEF DESCRIPTION OF THE DRAWINGS

The present invention is illustrated by way of example and not limitation in the figures of the accompanying drawings, in which like references indicate similar elements.

FIG. 1 illustrates a system with an integration server to connect mobile devices and an authoritative data source.

FIG. 2 shows an architecture structure of a mobile device.

FIG. 3 illustrates a visual representation of a workflow.

FIG. 4 illustrates a way to construct a workflow method.

FIG. 5 illustrates a software architecture structure for providing composite applications.

FIG. 6 illustrates a way to build a composite application.

FIG. 7 shows a process at an integration server to provide data connection between mobile devices and an authoritative data source.

FIG. 8 shows a flow diagram of a process to render user interfaces for sequential display.

FIG. 9 shows a flow diagram of another process to render user interfaces for sequential display.

FIG. 10 shows a flow diagram of a process to selectively pre-construct forms.

FIG. 11 illustrates a way to obtain log data.

FIG. 12 shows a flow diagram of a process to log screen images of user interfaces by a method processor.

FIG. 13 shows a flow diagram of a process to improve workflows using log data.

FIG. 14 shows a flow diagram of another process to improve workflows using log data.

FIG. 15 illustrates an integrated development environment with a self documenting feature.

FIG. 16 shows a flow diagram of a process to utilize patterns in a stream of log data to provide a monitoring feature.

FIG. 17 shows a flow diagram of a process to replay an execution of a workflow.

FIG. 18 shows a flow diagram of a process to display an execution of a workflow with a time shifting feature.

FIG. 19 shows a flow diagram of a process to monitor deviation from a reference execution of a workflow.

FIG. 20 shows a flow diagram of a process to perform prediction and optimization based on monitoring an execution of a workflow.

FIG. 21 shows a diagram of a data management system for the management of detached objects.

FIG. 22 shows a process at an integration server to provide data connection between mobile devices and an authoritative data source.

FIG. 23 illustrates a process to manage changes to a data record.

FIG. 24 shows a flow diagram to maintain versions of a data record.

FIG. 25 shows a data connection system.

FIG. 26 illustrates a combined data and execution model.

FIG. 27 illustrates a way to collect changes to data from mobile devices.

FIG. 28 illustrates another way to collect changes to data from mobile devices.

FIG. 29 shows a flow diagram of a process to upload data from the mobile device.

FIG. 30 illustrates an integrated development process for the access and management of detached objects.

FIG. 31 shows a process to segment an object tree into object groups for data management.

FIG. 32 shows a flow diagram of a process to segment an object tree.

FIG. 33 shows a flow diagram of a process to determine changes in data.

FIG. 34 shows a flow diagram of another process to determine changes in data.

FIG. 35 illustrates a way to implement transactions for consistency.

FIG. 36 shows a flow diagram of another process to implement transactions for consistency.

FIG. 37 illustrates a way to execute applications over a sometime connected network.

FIG. 38 illustrates a way to implement eMethods.

FIG. 39 illustrates user-level eMethods.

FIG. 40 illustrates a way to delegate tasks from one system to another.

FIG. 41 illustrates a way to push tasks from one system to another.

FIG. 42 shows a flow diagram of a process to transfer task from a remote device in response to a need for data from the remote device.

FIG. 43 illustrates a way to break a workflow into sub workflows that are coupled by an event loop.

FIG. 44 shows a flow diagram of a process to request a service from a remote system and to prepare entering an event loop.

FIG. 45 shows a flow diagram of a process to handle communication needs.

FIG. 46 illustrates a way to provide over the air (OTA) update.

FIG. 47 illustrates a way to implement a portion of a virtual machine using a workflow.

FIG. 48 illustrates a way to generate composite applications through joining attributes of workflows.

FIG. 49 illustrates a way to connection applications based on context.

FIG. 50 illustrates a way to provide content based on context.

FIGS. 51-52 illustrate a way to distribute information.

### DETAILED DESCRIPTION

The following description and drawings are illustrative of the invention and are not to be construed as limiting the invention. Numerous specific details are described to provide a thorough understanding of the present invention. However, in certain instances, well known or conventional details are not described in order to avoid obscuring the description. References to one or an embodiment in the present disclosure can be, but not necessarily are, references to the same embodiment; and, such references mean at least one. Various features described in the present disclosure may be in some embodiments but not in others.

Mobile Environment

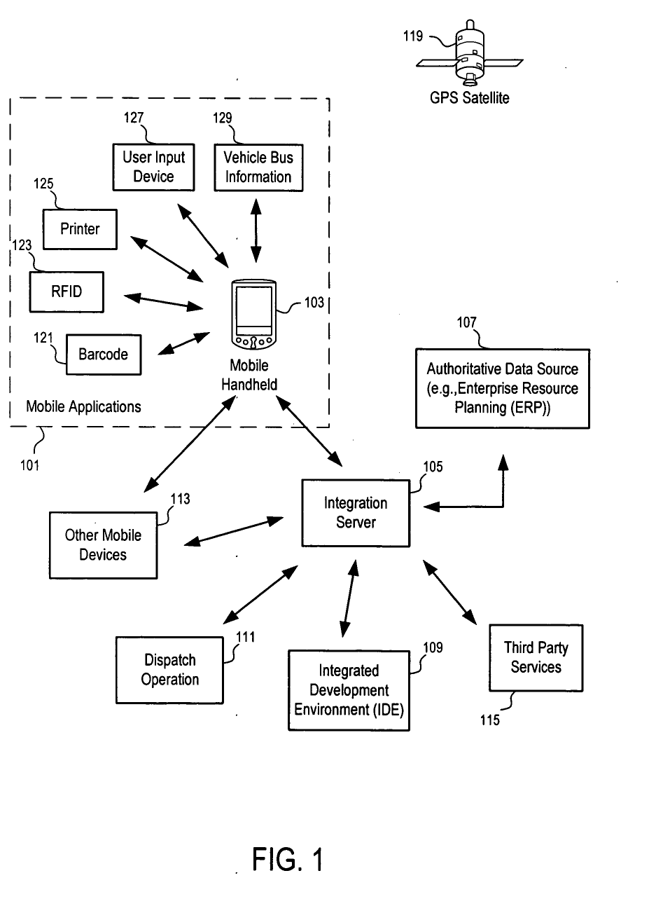

FIG. 1 illustrates a system with an integration server to connect mobile devices and an authoritative data source.

In one embodiment of the present invention, a mobile device (e.g., 103) can be used for a variety of different mobile applications (101), such as accessing barcode (121), radio frequency identification (RFID) (123), printer (124), user input device (127, such as scanner), vehicle bus information (129), etc.

The mobile handheld (103) may include a Global Positioning System (GPS) receiver to determine the location of the mobile handheld (103) and provide location-dependent services. The mobile handheld (103) may automatically determine its position and record various information in association with the determined position and time. Alternatively, or in combination, the mobile handheld (103) may use other positioning systems to determine its location, such as a cellular positioning system, a hybrid positioning system which uses both satellite positioning system signals and cellular positioning system signals, or other types of satellite positioning system, such as the GLObal NAvigation Satellite System (GLONASS) in Russia and proposed Galileo positioning system in Europe.

In FIG. 1, an integration server (105) is used between an authoritative data source (107) and mobile devices (e.g., 103, 113) to facilitate data access and integration. For example, the integration server (105) may retrieve the data that is being requested by the mobile device (103) and cache the data for access by other mobile devices (113). When changes to the data are checked in from the mobile devices, the integration server (105) can detect and resolve any conflict and store a consistent version of the changed data back to the authoritative data source (107). Thus, the integration server implements the logic to maintain data integrity and consistency while providing data access to multiple mobile devices which may use unreliable, sometime unavailable, slow network connections for data communication.

One example of an authoritative data source is Enterprise Resource Planning (ERP), which is an integrated information system that serves various aspects of an enterprise organization, such as manufacturing, order entry, accounts receivable and payable, general ledger, purchasing, warehousing, transportation and human resources, etc. The data may be under control of a database manager which provides data service using a Structured Query Language (SQL). The data may be stored in a flat file, or a directory tree of a file system.

The integration server (105) may be capable to access multiple different data sources and provide a uniform interface for the mobile devices to access authoritative data. Thus, the integration server (105) shields the mobile devices (and mobile applications) from the detailed implementation of the authoritative data.

The integration server (105) may be used to distribute applications and updates to the mobile devices. For example, new business processes can be developed using an integrated development environment (109) and distributed to the mobile devices (e.g., 103 or 113) for execution through the integration server (105).

In one embodiment of the present invention, a novel architecture of the mobile applications allows the mobile applications to be developed quickly, modified, tested, and deployed easily to mobile devices over-the-air (OTA). The mobile applications may be developed as composite applications that use components of existing applications. The novel architecture includes a workflow engine based method processor, which may be implemented on a virtual machine interpreter for a programming language (e.g., Java byte code or Microsoft Intermediate Language, Python, or other programming language). The method processor loads task modules in the programming language for execution by the virtual machine interpreter. The method processor loads task modules according to a description of a workflow (e.g., in an extensible markup language (XML), or other markup languages, or a custom format) which is interpreted by the method processor. The method processor may load modal user interface forms in a non-modal way to prevent flickers and to improve user friendliness. The method processor may include a hardware abstraction layer to encapsulate the implementation details of various types of peripheral devices from the mobile applications.

In FIG. 1, dispatch operations (111) can be in the form of sending, through the integration server (105), workflow applications that embodies business logic. The actual components of the execution codes are typically preloaded in the mobile devices and transmitted over-the-air when needed. The workflows can be easily modified, updated and dispatched to the mobile devices, even during the execution of the workflows.

Further, the integration server may provide to mobile devices the access to third party services (115), such as services provided through third party web sites. For example, the mobile handheld (103) may request the integration server to perform a task which requires resources from the third party services (115).

In the present description, various mobile platforms include cell phones, PDAs, handheld computers, notebook computers, etc. For example, mobile devices can be suitable for being held in one hand of a human user. Mobile devices may have one or more wireless communication capabilities, such as Bluetooth (e.g., in accordance with IEEE 802.15), WiFi (e.g., in accordance with IEEE 802.11), WiMax (e.g., in accordance with IEEE 802.16), cellular data communication access, etc. Mobile devices can have wired connections to the network at certain locations, such as when being placed in a cradle or being connected to a network access port via a cable.

In general, the physical communication channels between the mobile devices (e.g., 103, 113) and the servers (e.g., 105) may not be secure. The data communication can be secured through encryption. For example, a virtual private network can be configured within a public network (e.g., Internet) to provide a secure data communication environment for the mobile application system. For example, digital certificates can be used to identify the devices and systems such that the devices and systems are in a trusted group, in which application programs can be safely transmitted from one to another for execution.

Further, a communication layer can be configured to apply data compression schemes to reduce the data transmission time. For example, data compression can be selectively applied, just-in-time (or, on-the-fly) based on the type of data content. Data records retrieved from the authoritative source are compressed to reduce the time period for data transmission. For example, the communication layer can automatically determine whether components of a data package have already been cached (stored) to avoid receiving the cached components once again over the network connection.

In one embodiment of the present invention, the communication layer performs a cost-benefit analysis to determine when and which communication channel is to be used for transmitting what data. For example, various communication channels (e.g., Bluetooth, WiFi, WiMax, cellular phone communications, local area network, etc.) can be assigned different cost indicators. Various different types of data can be assigned different benefit (priority) indicators. The availability of different communication channels can be determined/estimated (e.g., based on statistical data collected through a period of operations and/or tests). The time delay to when a network channel may become available can have a corresponding cost indicator. The mobile devices may automatically collect statistical data (heuristics) about the time and date when the communication connections and network resources are available and the location where the communication connections and network resources are available. The statistical data are used to determine the availability of communication connections and network resources. The communication layer performs a cost-benefit analysis to schedule specific data for delivery over a specific network channel at specific time range. Thus, the transmission of data and access to network resources can be scheduled to reduce cost and increase system performance.

Optionally, the cost/benefit indicators can be adjusted to optimize or customize the system for specific needs.

In FIG. 1, the integration server (105) is implemented on a data processing system separate from one or more data processing systems for the dispatch operations, integrated development environment (IDE) and/or authoritative data source. Alternatively, the integration server (105) may be implemented on a data processing system which also performs other operations, such as dispatch operations, integrated development environment (IDE) and/or authoritative data source, etc.

In general, a mobile device, or a server system, is implemented as a data processing system, which includes memory and at least one processor.

A processor can be a general-purpose microprocessor used as a Central Processing Unit (CPU), an Application Specific Integrate Circuit (ASIC) which is custom designed for a specific application, or a Field Programmable Gate Array (FPGA). In some implementations, a processor may include memory to store embedded software in a configuration called “system on a chip” (SoC). In some implementations, a data processing system may include multiple CPUs (e.g., for a server system).

Typically, a data processing system includes an inter-connect (e.g., bus, system core logic, etc.), which interconnects a processor and memory which is used to store instructions for execution by the processor and related data.

Typically, the inter-connect further connects the processor and memory to other components, such as a display controller and display device, peripheral devices such as input/output (I/O) devices controller(s) to control I/O devices, such as mice, keyboards, modems, network interfaces, printers, scanners, video cameras, GPS receiver, and/or other devices.

The inter-connect may include one or more buses connected to one another through various bridges, controllers and/or adapters, such as USB (Universal Serial Bus) port, IEEE-1394 bus adapter, etc.

The memory may include ROM (Read Only Memory), and volatile RAM (Random Access Memory) and other non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, or an optical drive (e.g., a DVD RAM), or other type of memory system which maintains data even after power is removed from the system, such as flash memory. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

A data processing system may have more or less components, dependent on the configuration and usage. For example, a server data processing system may not include certain components, such as display, keyboard, etc. A mobile device may include an integrated display (e.g., a liquid-crystal display (LCD) panel). The display may have the capability to receive input (e.g., a touch screen panel). Further, a mobile device may include the circuitry for telephonic communications, such as a two-way radio subsystem for cellular communication.

The above description of a data processing system is not intended to represent any particular architecture or manner of interconnecting the components. In general, other systems that have fewer or more components may also be used with the present invention.

In general, the routines executed to implement the embodiments of the invention may be implemented as part of an operating system or a specific application, component, program, object, module or sequence of instructions referred to as “programs.” An application program typically includes one or more instructions set at various times in various memory and storage devices in a computer, and that, when read and executed by one or more processors in a computer, cause the computer to perform operations necessary to execute elements involving the various aspects of the invention. An application program is typically tangibly stored on a machine/computer-readable media.

A machine readable medium can be used to store software and data which when executed by a data processing system causes the system to perform various methods of the present invention. The executable software and data may be stored in various places including for example ROM, volatile RAM, non-volatile memory and/or cache. Portions of this software and/or data may be stored in any one of these storage devices.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media, such as Compact Disk Read-Only Memory (CD ROMS), Digital Versatile Disks, (DVDs), etc. An application program can also be embodied in digital and analog communication links as electrical, optical, acoustical or other forms of propagated signals, such as carrier waves, infrared signals, digital signals, etc.

In general, a machine readable medium includes any mechanism that provides (e.g., stores and/or transmits) information in a form accessible by a machine (e.g., a computer, network device, personal digital assistant, manufacturing tool, any device with a set of one or more processors, etc.).

Aspects of the present invention may be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

In various embodiments, hardwired circuitry may be used in combination with software instructions to implement the present invention. Thus, the techniques are not limited to any specific combination of hardware circuitry and software, nor to any particular source for the instructions executed by the data processing system.

In this description, various functions and operations are described as being performed by or caused by software code to simplify description. However, those skilled in the art will recognize what is meant by such expressions is that the functions result from execution of the code by a processor, such as a microprocessor.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the operations could be implemented in hardware, firmware, software or any combination thereof.

Architecture

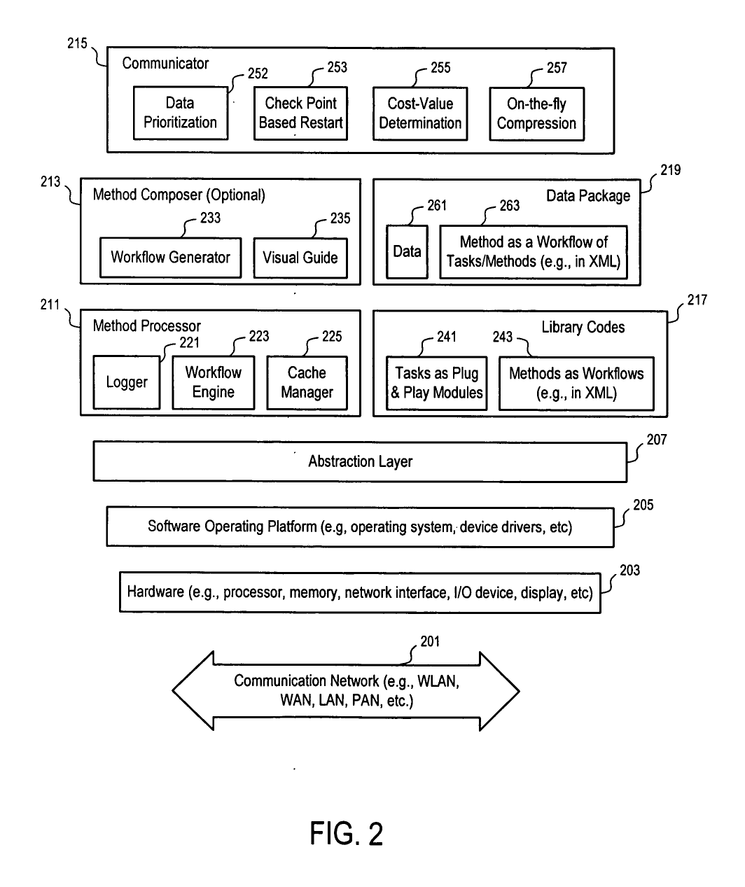

FIG. 2 shows an architecture structure of a mobile device. In FIG. 2, a mobile device is designed to perform some operations locally using the hardware (203), which may include processor, memory, network interface, I/O device, display, etc., and some other operations via a communication network, such as one or more of Wireless Local Area Network (WLAN), Personal Area Network (PAN), Wide Area Network (WAN), Local Area Network (LAN), etc., or a combination of networks, such as the Internet.

In FIG. 2, the mobile device has a software operating platform, which may include an operating system, device drivers, etc. The software operating platform controls the low level operations of the hardware (203) and provides a conventional environment for the application programs. For example, the software operating platform may include the BREW platform, an operating system from mobile devices, a Java runtime environment, and/or a Common Language Runtime environment, etc.

In one embodiment of the present invention, a method processor (211) is developed on the software operating platform (205) for execution on the hardware (203). An abstraction layer (207) is used to encapsulate the differences between different implementations of various types of peripheral devices, such as printer, scanner, radio controller, etc. The abstraction layer for the method processor (211) allows the program modules for the method processor to be developed in a way independent of the implementation details of devices of the same type.

In FIG. 2, the method processor (211) includes a workflow engine (223), a cache manager (225) and a logger (221).

The workflow engine (223) and the cache manager (225) may run in different threads while communicating with each other to pre-load and cache task modules in a programming language (e.g., Java byte code) for execution.

The workflow engine (223) parses a definition of a workflow and loads corresponding modules of the workflow for execution. The task modules in the programming language (e.g., Java byte code) can be loaded into the same process and the same thread of the workflow engine (223).

A unit of a workflow can be defined in a method file (e.g., as an application and/or as a module), which specifies the data connections between the modules in the workflow and the execution paths among the modules. The workflow engine causes the modules that are specified in the method file to be executed one after another, in accordance with the outcomes of modules and the direction of flow specified in the method file.

In general, a method file can be designed as a standalone application and/or a module which can be used in another method file. When the workflow defined in a method file is used as a module in another method file, the method file can be considered as a method module. The workflow defined in the method module can be considered a sub-workflow of the application. A method module may be referred to as a workflow method module, or a sub-workflow method, or a workflow method, or a sub-method. Some method files can be used both as standalone applications or as modules in other applications.

The logger (221) is coupled with the workflow engine (223) to collect data related to the execution of a workflow. The logger (221) may run in the same thread as the workflow engine (223) or in a separate thread.

The logger (221) may be designed to have access to real time sensor data about the location, time and environment of the mobile device, such as the location of the mobile device, date and time of any event occurred on the mobile device, temperature, vehicle bus information (e.g., vehicle speed, amount of remaining fuel), etc. Such sensor data are obtained and recorded before and/or after the execution of a module of the workflow. Thus, the logger (221) can automatically collect such sensor data in connection with the execution of the workflow, such that the circumstances of the execution of the workflow can be recorded for further analysis, which can be used for various improvements. The logger (221) can also automatically collect execution data in response to events related to sensors, such as when a measurement reaches a threshold, when a type of sensor data becomes available (e.g., through a network connection), etc.

Further, the logger (221) can be coupled to the workflow engine to record the data that flows into and/or out of the modules of the executed workflow, in connection with the sensor data. Thus, the circumstances of the data flows can be recorded for further analysis.

The logger (221) may record at least a portion of the sensor data in response to events generated by the workflow engine (223). For example, the workflow engine (223) generates events in response to entering or exiting a module of a workflow. The logger (221) associates the sensor data (e.g., time, location, temperature, phone data, camera data, network input, etc.) with the event data supplied from the workflow engine (223), which may include the identification of the module, data to be supplied to the module or copied from the module, the status of the workflow engine (e.g., memory state, etc.), screen images, and others.

The cache manager (225) is coupled to the workflow engine (223) to improve the performance of the execution of a workflow. The method processor (211) can automatically cache frequently executed modules and perform look-ahead analysis in combination with past execution history to predict what module might be needed next and to pre-load the execution code for the module into memory. When the past execution history on the mobile device is not available, the statistic data based on execution on one or more other mobile devices can be used. When no real world execution history is available (or when no sufficient real world execution history is available), pre-designed parameters, such as weighting factors which may be determined based on the knowledge of the designer or based on speculation, can be used to perform look-ahead analysis. The pre-designed weighting factors may be weighted against the available execution history such that, when sufficient execution history is available, the look-ahead analysis is mainly (or entirely) based on the past execution history.

For example, during the time period in which the processor is not fully busy, such as when a user interface form is displayed to the user for user interaction, the method processor may look ahead of the current task in the workflow and determine the modules that are likely to be executed after the current module, according to statistics of past results generated from the current module. The method processor can then load the modules into memory in anticipation of the flow to the subsequent modules. The cache manager (225) keeps in memory the modules that are likely to be used and purges other modules out of the memory.

Further, the method processor may pre-load and execute a portion of a user interface module without mapping the user interface form to the display. Thus, when the user interface form is needed, the time to display the user interface form is reduced, since the user interface form has been pre-rendered and cached.

When the execution of a user interface module is completed, the method processor may not immediately destroy the user interface form (or a portion of the form). Instead, the user interface form as rendered may be cached and re-initialized when needed. Such caching operations can improve the responsiveness of the mobile device and provide better user experience.

A module of a workflow can be a set of instructions in a programming language to be executed through the interpretation via the software operating platform (205), or a set of instructions in a programming language executable directly by the hardware (203). A module can be provided as a shared library, which can be dynamically loaded into the method processor for execution and/or dynamically unloaded. A shared library includes a unit of instructions in a programming language that can be dynamically loaded into a running application program that is in the same programming language, so that the instructions dynamically becomes part of the running application program. Example formats of shared libraries include a dynamic link library (dll) file, a Java archive (jar) file, etc.

A module of a workflow can also be a method file which describes a sub-workflow. Such a method file may be called a sub-method file, in the context in which it is used as a module. In general, any method file may later be used in other method files as a sub-workflow and thus be called a sub-method file.

In FIG. 2, the mobile device includes a set of library codes (217), which may include tasks (241) as plug & play modules of instructions which are in one or more programming languages executed on the software operating platform (205) and/or the hardware (203). The library codes (217) may further include methods as workflows (243) (e.g., in XML), to be processed by the workflow engine (223). The methods as workflows (243) are method modules which may call upon task modules (e.g., 241) to perform operations.

An application can be provided as a data package (219), which includes input data (261) and a method as a workflow of tasks/methods (sub-methods). The data package (workflow application) is processed for execution by the method processor which includes the workflow engine. Since the data package (219) contains the input data and the definition of the workflow but typically not the detailed instructions to perform the tasks (which are typically in the mobile device as library codes (217)), the data package (219) can be quickly dispatched to the mobile device for execution, even when dispatched over-the-air. When needed, a portion of the library codes (217) that is not already downloaded may also be downloaded over-the-air.

Optionally, the mobile device may include a method composer (213) for the development of a new method file, which may be executed on the method processor (211) or transmitted to a remote location (e.g., another mobile device or a server) for execution.

For example, the user of the mobile device may modify the workflow of a module or an application even during the execution of the workflow. For example, the user of the mobile device may load a graphical representation of the workflow into the method composer, make changes to the workflow while the method processor is executing the previous version of the workflow, and save the new version of the workflow. When the new version of the workflow is saved, the method processor can continue the execution according to the new version of the workflow, starting from the module that is currently being executed. Thus, a workflow can be modified on-the-fly.

Further, the method processor may automatically adjust, or optimize, a workflow based on the usage pattern of a user. For example, if the user routinely skips a user interface form under certain conditions and comes back to the user interface form later, the method processor may optimize the workflow based on the typical execution paths of the user to avoid the presentation of the user interface form under these conditions, so that the user does not have to provide the input to skip the user interface form. Thus, the method processor may transform the workflow to allow the typical execution paths while eliminating the need to render the user input forms that are skipped.

The user interface forms may be designed to receive inputs that indicate whether the forms are skipped. Certain forms may provide information to the user without receiving input from the user. Other forms may be capable to receive user inputs. The user may skip a form because the user becomes familiar with the information provided in the form, or because the form does not provide useful information at this stage, or because the user prefers to deal with the form at a later time, or because a specific condition. The indication of skipping the form can be used by the method processor to automatically optimize the workflow according to the preference of the user as indicated by the actual execution paths. Further, when the user skips a user interface form, the user may be presented with an option to specify conditions, if any, under which the user interface form should be skipped. Thus, the method processor may customize the workflow for the user according to the user specified conditions. In general, different users may have different preferences; and the preference of a user may change as the user becomes familiar to the workflow.

A workflow may have a number of versions designed for users with different levels of familiarity with the task. Based on the statistical data collected from the execution of a workflow, the method processor may estimate the level of familiarity of the user with the task and automatically determine an appropriate version of the workflow for the user (e.g., to promote efficiency).

In one embodiment, a user interface module may be customizable for a number of different situations, which may be determined based on the location of the execution of the module, the time of the execution of the module, the customer for which the module is executed, and/or the user who executes the module, etc. The user interface module may be customized to have different graphics (e.g., for a decorative purpose), have different layouts, to have different sets of optional items/entries, to have different labels, help information, tutorial/training modules, etc.

Certain customization information, such as rules, preferred execution sequence, customized workflow/sub-workflow, graphics and settings, etc., can be dynamically received in the mobile device when the mobile device is at the service site. The customization information may be obtained from the customer at the service site, or from an integration server of the enterprise that dispatches the mobile device (e.g., based on the location of the mobile device).

For example, the customer at the service site may develop their customized version of a workflow, which can be pushed/downloaded to the mobile device for the execution of a workflow application for the customer. The workflow may have a number of customizable rules; and the customer at the service site may push the customized rules to the mobile device for the execution of a workflow application for the customer.

Alternatively, a user may customize the workflow using the composer running on the mobile device (e.g., in collaboration with the customer) to obtain a customized version of the workflow, which is then transmitted to an integration server for distribution to other mobile devices which may subsequently serve the same customer using the customized version of the workflow.

In FIG. 2, the method composer (213) includes a workflow generator (233) which is coupled to the visual guide (235) to allow the user to visually develop the workflow.

The method composer (213) may automatically determine the input/output data variables of the modules through introspection to help user to visually develop the workflow. After the user indicates the correspondence between the input/output data variables of the modules and a pool of global variables for the method file, the method composer (213) can automatically generate, in the method file, the links between the input/output data variables of the modules and the global variables of the method file. The method composer (213) can further be used to compose and compile task modules.

In general, method files and task modules can be developed on a computer with more processing power than a mobile device. For example, the method files and task modules so developed may be dispatched to the mobile device via an integration server (e.g., 105 in FIG. 1).

In FIG. 2, the mobile device includes a communicator (215) which includes various modules for data prioritization (252), check point based restart (253), cost-value determination (255), on-the-fly compression (257). The communicator (215) is used by the method processor (211) to download library code or updates to library code, data package (219), and to send request as a method module/application to a remote location for execution.

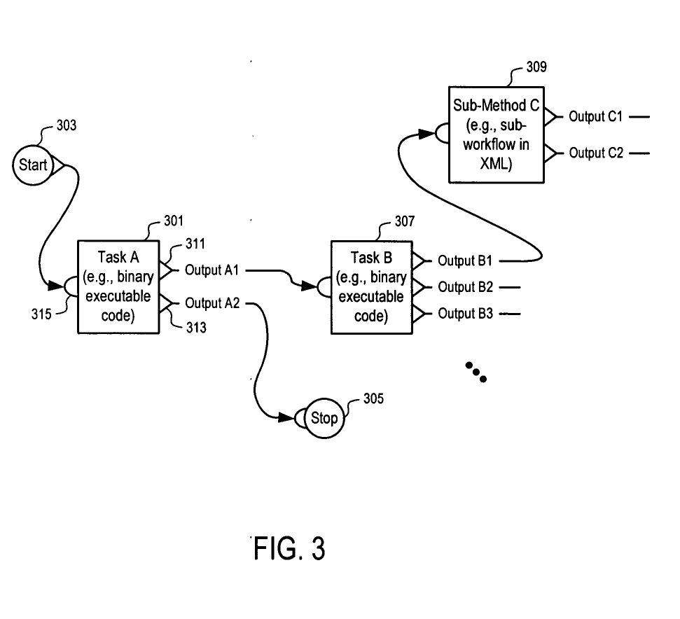

FIG. 3 illustrates a visual representation of a workflow. In FIG. 3, a workflow defined in a method file includes one start module (303). The workflow may or may not include a stop module (305). The workflow shows directed links from one module (e.g., 301) to another (e.g., 307) to indicate the flow. The workflow may call task modules (e.g., 301, 307) which may be in the same programming language as the workflow engine and method modules (e.g., 309) which may be in an XML format.

In FIG. 3, a module has an input port (e.g., 315). A link to an input port (e.g., 315) indicates a flow into the module (e.g., 301). A module has one or more output ports (e.g., 311, 313), corresponding to one or more different outcomes of the module. A link from an output port (e.g., 311) indicates a flow from the module to a direction indicated by the link under the condition that the module produces the corresponding outcome.

The condition under which the workflow flows from one module to another module may be based on a number of conditions, or based on simply the status of one (or more) outcome of the exiting module. For example, each module can be designed to output an outcome that is used by the workflow engine to determine the direction of the subsequent execution flow.

In general, the condition under which the workflow flows from one module to another module can be based on an expression which is a function of a number of variables accessible at the level of the workflow. For example, the expression may be a function of a number of global variables accessible to the modules in the workflow. The modules may update the values of the global variables during the execution.

A workflow can include a variety of modules, such as a user interface task module, a system task module, a sub-method workflow module, a remote module, etc.

A task module is in a programming language that is to be executed by the software and/or hardware platform which runs the method processor. The task module may be loaded into the same process of the method processor and executed in the same thread of the workflow engine. A workflow method (method module) may be in a programming language (e.g., Extensible Markup Language (XML), other markup languages, a custom designed language) that is to be interpreted by the method processor.

During the execution of a workflow method which calls a method module (or a task module), the method processor may check for the latest version of the method module (or the task module). If the latest available version of the method module is different from what is in the cache, the method processor can replace the version of the method module in the cache with the latest available version of the method module. Thus, the application can be hot updated without having to restart or shutdown the application.

For example, when an updated version of a method module is developed, an integration server may dispatch the method module in an XML file to the mobile devices, some of which may actually running an application which uses the method module. After the updated version of the method module is dispatched to a mobile device, the updated version of the method module becomes immediately available for use by the mobile device. For example, when the execution of a workflow application on the mobile device reaches the method module, the updated version of the method module can be executed without having to restart the workflow application. The cache manager may periodically determine whether the cached version of the method module is outdated. If the cached version is outdated, the cache manager can reload the latest version of the method module to update the cache. Thus, the application can be modified on-the-fly while the application is being executed.

An integration server may monitor the versions of modules on various mobile devices, keep a data set showing different method versions on different mobile devices, and manage the version control on the mobile devices. For example, the integration server may send out a list of customers that need customization. As the mobile device approaches a customer on the list, a customized version of a module can be downloaded (e.g., from the integration server, or from a server of the customer). The customized version may include a configuration file for a workflow application, a customized method file, a customized resource file, etc. The customization may be performed on the mobile device using a composer running on the mobile device; and the customization may be submitted back to the integration server for propagation to other mobile devices. The integration server may query the mobile devices to preload customizations to the mobile devices. Alternatively, a mobile device may check with the integration server for customization when the mobile device arrives at the site of the customer (or when the mobile device starts to execute a workflow for an identified customer). The customized version of a workflow may be downloaded and hot swapped to replace the non-preferred version after downloading the customized version. Further, the method processor may look ahead of the current execution of the workflow to anticipate the need for customized version of workflows for a scheduled task, so that the customized version may be downloaded before the module is needed.

When an updated version of a task module is developed, an integration server may dispatch the task module (e.g., in a programming language such as Java byte code or Microsoft Intermediate Language) to the mobile devices. After the updated version of the task module is dispatched to a mobile device, the updated version of the task module becomes immediately available for use by the mobile device. For example, when the execution of a workflow application on the mobile device reaches the task module, the updated version of the task module can be executed without having to restart the workflow application. The cache manager may periodically determine whether the currently loaded version of the task module is outdated. If the currently loaded version is outdated, the cache manager can unload the outdated version and load the latest version of the task module. Thus, the application can be modified on-the-fly while the application is being executed.

Further, in one embodiment, modules of a workflow application can be supplied on demand, after the workflow application is started. For example, the workflow application may be started on a mobile device in the absence of one or more modules (e.g., a task module or a method module). Before the workflow reaches the missing modules, the method processor may execute the application as if the modules have been pre-loaded in the mobile device. The method processor can attempt to obtain the missing modules from available network resources while the application is being executed. Thus, the modules can be hot supplied and updated, while the application is running.

When multiple versions of a module are provided to a mobile device, the method processor may be configured to execute the latest version, a particular version identified based on a version number of time of arrival at the mobile device, or provide an option to the user to select a version for execution. The configuration parameter may be presented in a configuration file for the mobile device, or a configuration file specific for the application, or a method file that specifies the workflow, or based a combination of these configuration parameters presented in different locations.

For example, the configuration file for the mobile device may specify the general preference of whether to run the latest version according to the version number or according to the time of arrival at the mobile device. The preference may be overwritten by the method file for the workflow, and/or be overwritten by a preference in the application specific configuration file, if provided. Version selection may also be performed based on other factors related, such as customer identity, location, performance goal, etc.

In one embodiment of the present invention, an updated version of a workflow may be provided to a method processor while a previous version of the workflow is being executed in the method processor. When the method processor is at a module that is used in both versions of the workflow, the method processor can load the updated version of the workflow and continue the execution of the workflow according to the updated version without having to stop or restart the workflow. It is not necessary to stop the execution of the previous version of the workflow and start the execution of the updated version of the workflow again from the beginning. Thus, the workflow can be modified while the workflow is being executed in the method processor, without having to stop the current execution of the workflow. Under certain conditions, the method processor may use an old version for a certain period of time.

For example, during the execution of a workflow, the log data of the execution of the workflow may be transmitted to a dispatcher for monitoring. When the dispatcher determines that the workflow is to be modified according to a recent event, the dispatcher may modify the workflow and transmit the modified version of the workflow to the mobile device (e.g., to include a bug fix, a new feature, a customization into the workflow). The modification may include altering one or more execution paths, inserting one or more execution path and/or references to new modules, and/or eliminating one or more modules. The modified version of the workflow can be transmitted to the mobile device. At a point where the workflow engine is at a module that is in both versions of the workflow, the workflow engine can hot swap the previous version of the workflow out of memory and continue the execution of the same module in the updated version of the workflow and direct the subsequent execution of the workflow according to the updated version of the workflow without restarting the execution of the workflow. Thus, the dispatcher may dynamically inject a sub-workflow into the workflow currently being executed on the method processor, or remove a scheduled sub-workflow out of the workflow that is currently being executed on the method processor.

Further, the method processor may operate in a loop of continuously receiving applications in the form of method files and selectively executing the method files. Thus, the workflow in the method processor may never end. For example, the method processor can be designed to process the applications in a queue. New applications can be added to the queue. When the queue is empty, the method processor waits for the arrival of new applications (e.g., via a network connection). Thus, the method processor may be considered as a virtual machine.

Further, in one embodiment, the method processor may lunch or start workflow applications in response to external events, such as in response to a change in availability of a network resource, or a signal detected by a sensor (e.g., controlled by the logger of the mobile device), or the start or end of an event, such as the start or end of a module or a workflow application. Thus, the method processor may process the workflow applications based on events generated at the mobile device, or based on the priority of the workflow applications, or based on the order of the queue for the workflow applications, or based on user selection.

The modules and/or workflow applications can be digitally signed to prevent tampering. To generate the digital signature, a digest is computed from the content of a module or workflow application using a one-way hash function, such as Message Digest 5 (MD5) or Secure Hash Algorithm-1 (SHA-1). The one-way hash function is such that a small change in the content would lead to a change in the computed digest; and it is very difficult to make a change in the content without changing the computed digest. The sender encrypts the digest using the private key of the sender so that the digest can be decrypted using the public key of the sender. If the digest is not encrypted with the private key of the sender, the digest cannot be correctly decrypted using the public key of the sender. The public key of the sender can be distributed to the recipients. Thus, when the recipient the decrypted digest matches the digest computed from the received the module or workflow, it can be determined that the digest is provided by the holder of the private key of the sender and the content of the module or the workflow application has not been tampered.

A method processor can be configured to execute modules and/or workflow applications that are digitally signed by a trusted entity (e.g., provided by one or more trusted entities who are in possession of the private keys of known public keys). When a module and/or workflow application is not from a trusted entity, the method processor may refuse to execute the module and/or workflow application, or present to the user of the method processor an option to determine the trustworthy of the received module and/or workflow application.

The digital signature of the trusted entity can also be used to create the digital certificate for distributing the public keys of other entities whose identity have been verified by the trusted entity. For example, the trusted entity may digitally sign the certificate that includes a public key of the holder of the certificate and information describing the holder of the certificate. When the public key of the holder of the certificate can be used to verify the digital signature of a module or workflow application, it can be determined that the sender of the module or workflow application is as described in the certificate. The recipient of the module or workflow application may decide the trustworthy of the module or workflow application and/or the sender based on the description of the holder of the certificate.

Further, to protect the content of the module or workflow application from authorized access, which may contain confidential data and/or business process, the sender may further encrypt the content with a public key of the recipient, such that those who do not have the private key of the recipient cannot correctly decrypt the content. The module or workflow application can be further compressed to reduce transmission time and transmission bandwidth requirement.

Further, secret key cryptography (symmetric encryption) in which the same key is used for both encryption and decryption can be used to protect the modules and/or workflow applications from tampering and unauthorized access. The method processor can be configured to execute the modules and/or workflow applications that are from authorized providers.

Different modules of a workflow application may be executed in a same thread. Alternatively, a method module which defines a sub-workflow can be executed in a separate thread. For example, the calling method file may specify whether the method module that is called in the calling method file is to be executed in a separate thread. When the method module is executed in a separate thread, the main thread may or may not wait for the completion of the thread of the method module. For example, when the outcome of the method module is not used to select the execution path following the method module, the main thread may not wait for the completion of that separate thread of the method module.

Further, for example, one execution path may lead to multiple method modules which are executed asynchronously in separate threads. Thus, a main thread may fork into multiple threads for asynchronous parallel processing.

Similarly, a task module may also be executed in a separate thread.

In one embodiment of the present invention, the behavior of the cache manager is configurable. The cache manager may be configured for all applications running in the method processor or for a specific application. For example, the method processor may use a general configuration file to indicate the default behavior of the cache manager. When the general configuration file is updated (e.g., modified or overwritten with a new version), the method processor can reload the configuration parameters automatically. Further, for a specific application, a configuration file can be used to adjust the configuration parameters for the specific application. For example, a configuration parameter can be used to specify the maximum number of tasks modules that can be cached by cache manager, or the maximum amount of memory that can be consumed by the cache. Thus, the cache manager can avoid consuming excessive memory resources and avoid degrading the performance of the workflow engine.

One embodiment of the present invention uses a Model View Control (MVC) paradigm. In the MVC paradigm, the user input, the modeling of the external world, and the visual feedback to the user are explicitly separated and handled by three types of objects, each specialized for its task.

The view manages the graphical and/or textual output to the portion of the bitmapped display that is allocated to its application.

The controller interprets the mouse and keyboard inputs from the user, commanding the model and/or the view to change as appropriate.

The model manages the behavior and data of the application domain, responds to requests for information about its state (usually from the view), and responds to instructions to change state (usually from the controller).

The formal separation of these three tasks can be particularly suited to mobile applications where the basic behavior can be embodied in three types of objects: View, Controller, and Model. The MVC behavior of the objects can be then inherited, added to, and modified as necessary to provide a flexible and powerful system. The division of labor within the MVC triad helps to design a flexible and powerful system.

Subclasses of View and Controller can be made available to provide ready made starting points for designing modules that can be used in a workflow. Applications can then be built through defining a workflow among the modules.

The separation of view and model allows the development of different ways to present the same data quickly. For example, different user interface task modules can be developed to present different user interface forms to manipulate the same data. Thus, the look and feel of the graphical user interface to manipulate the data can be changed without breaking the logic.

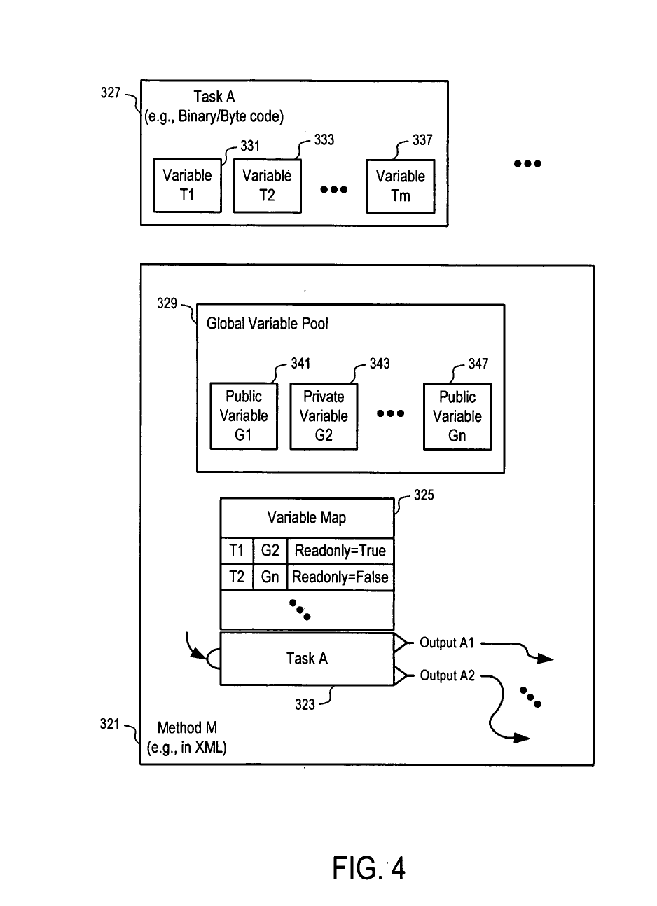

FIG. 4 illustrates a way to construct a workflow method. In FIG. 4, a workflow method (321) can be defined in an Extensible Markup Language (XML). A global variable pool (329) of the workflow method (321) includes a number of global variables (e.g., 341, 343, . . . , 347). The global variables of the global variable pool (329) are accessible to modules in the workflow method (321).

Some of the global variables can be defined as “public” (e.g., 341, 347) such that these public global variables are accessible to another workflow method (not shown in FIG. 4) when the workflow method (321) is used as a sub-workflow module in that method. Some of the global variables can be defined as “private” (e.g., 343) such that these private global variables are accessible only to the modules used within the workflow method (321).

The workflow method (321) identifies the modules (e.g., 323) used in the workflow method (321) and specifies flow directions from one module to another based on the outcome statuses of the modules.

A module (e.g., 323) of the workflow method (321) can be a task module (327) which can be in the form of binary code for the processor, or byte code for virtual machine in which the method processor is running. The task module (327) includes a number of variables (e.g., 331, 333, . . . , 337) accessible to the method processor at the workflow level.

In one embodiment, the workflow method not only identifies the task module (327), but also specifies the location from which the task module (327) can be obtained if the task module (327) is not already on the mobile device. For example, the location of the task module can be specified using a Uniform Resource Locator (URL). If the method processor determines that the task module (327) is not already on the mobile device, the method processor may start to download the task model according to the Uniform Resource Locator (URL). Further, in one embodiment, the method processor may use the Uniform Resource Locator (URL) to check for an updated version of the task module, based on a set of pre-determined rules.

The instructions for the task module (327) may be stored separated from the workflow method (321). The workflow method (321) contains a reference to the task module (327), which specifies the location where the instructions for the task module (327) can be found. A cache manager may use information of the location of the task module to pre-load the module into memory.

The workflow method (321) may include a variable map (325) which specifies the relation between the global variables of the workflow method (321) and the variables of the task modules.

For example, in FIG. 4, variable T1 (331) of the task module (327) is to be linked to the global variable G2 (343), in which the global variable G2 (343) is readonly to the variable T1 (331) of the task module (327). Thus, before the execution of the task module (327), the method processor provides the value of the global variable G2 (343) as an input to initialize the variable T1 (331) of the task module (327); since the global variable G2 (343) is readonly to the task module (327), the execution of the task module (327) has no effect on the global variable G2 (343).

For example, in FIG. 4, variable T2 (333) of the task module (327) is to be linked to the global variable Gn (347), in which the global variable Gn (347) is not readonly to the variable T2 (333) of the task module (327). Thus, before the execution of the task module (327), the method processor provides the value of the global variable Gn (347) as an input to initialize the variable T2 (333) of the task module (327); since the global variable Gn (347) is not readonly to the task module (327), the method processor uses the content of the variable T2 (333) of the task module (327) to update the global variable Gn (347) after the execution of the task module (327).

Thus, the variable map (325) specifies the way the method processor provides the data to the modules from the global variable pool (329) and updates the global variable pool (329) according to the variables of the task modules.

The method file may further specify whether or not a local variable or a global variable in the method file is to be logged. When a variable is flagged for logging, the method processor automatically records the state of the variable when the variable is accessed by the workflow engine. The method file can specified that an entry for a variable is to be recorded to show the value of the variable at the time of entering a module, exiting a module, or both, or none. The logging of local and/or global variables can be part of a more comprehensive logging capability of a method processor.

The state of an instance of a workflow method can be maintained by the corresponding global variable pool. Thus, different instances of the same workflow method may co-exist on a same method processor.

A workflow method may present the output of the last executed module as the output status of the workflow method. A stop module can be optional. When a stop module is used, the stop module takes the output of the module which is executed just before the stop module as the output of the workflow method. In general, a workflow method may have a number of modules which can be the last executed one, depending on the execution results. The set of possible outputs of the workflow method includes the possible outputs of these modules that can be the last executed module of the workflow method.

A workflow method may select a global variable of the sub-workflow method as the outcome variable such that the value of the outcome variable can be used as the status of the outcome of the sub-workflow method.

Alternatively, a workflow method may designate a global variable as the outcome variable such that the value of the outcome variable can be used as the status of the outcome of the workflow method when the workflow method is used as a module in another workflow method.

Alternatively, a workflow method may designate a global variable as the default outcome variable; and a calling workflow method that uses the workflow method as a sub-workflow can use the default outcome variable to direct the subsequent flow or specify an alternative public global variable of the sub-workflow method as the outcome variable.

A calling workflow method may define a proxy to another workflow method that is to be used as a sub-workflow. The proxy specifies which of the public global variables of the workflow method are the local variables of the sub-workflow. A variable mapping between the local variables of the sub-workflow method and the global variables of the calling workflow method allows the method processor to feed the sub-workflow according to the data stored in the global variables of the calling workflow when entering the sub-workflow method and to update the global variables of the calling workflow according to the corresponding variables of the sub-workflow method when exiting the sub-workflow method.

The global variable pools of workflow methods can be used to link calling workflows with sub-workflows through variable mapping so that the workflows can be built in a hierarchical way.

A remote module may be a user interface task module, a system task module, or a sub-method workflow, which is to be executed at a location that is remote to the method processor.

Composite Application

One embodiment of the present invention provides a flexible architecture for composite applications (e.g., for mobile devices).

Composite applications are new applications that are built from parts of existing applications. One embodiment of the present invention provides architecture to build composite applications quickly and use them in the mobile applications.

Route accounting, as a vertical market application for the enterprise, is an example of a composite application. It blends account receivables, invoicing, material return authorization, and CRM (Customer Relationship Management). Using the architecture according to present invention, composite applications for mobile applications can be quickly developed, configured, tested, debugged, and deployed.

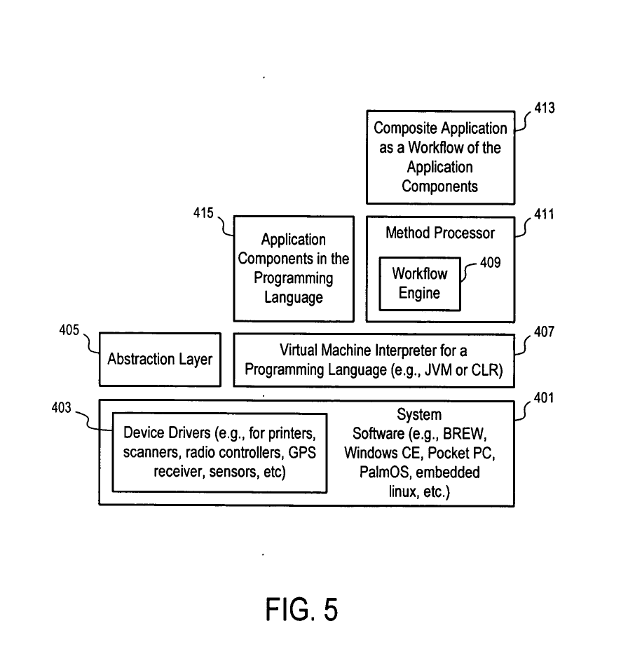

FIG. 5 illustrates a software architecture structure for providing composite applications. In FIG. 5, a method processor (411) including a workflow engine (409) runs on top of a virtual machine interpreter (407) for a programming language, such as a Java Virtual Machine (JVM) or a Common Language Runtime (CLR).

The virtual machine interpreter (407) can be implemented as a software platform running in the environment of system software (401), such as BREW, Window CD, Pocket PC, PalmOS, embedded linux, etc. The system software typically includes device drivers for peripheral devices, such as printers, scanners, radio controllers, GPS receiver, sensors, etc.

In FIG. 5, an abstraction layer (405) is used by the method processor (411) to encapsulate implementation details of various different types of devices from the application programs to be developed for the method processor.

The application components (e.g., task modules) can be developed in the programming language of the virtual machine interpreter (407). The method processor (411) (including the workflow engine (409)) can also be in the programming language of the virtual machine interpreter (407).

During the execution, the method processor dynamically and selectively loads applications components as part of the running process of the method processor. Thus, the capability of the method processor to process different workflows can change dynamically during the execution, through loading and unloading the application components.

Application components originally developed for different applications can be loaded into the method processor without distinction. Thus, the application components (e.g., task modules or sub-workflow methods) from different applications can be re-arranged in a new workflow for a new application.

For example, a composite application (413) can be developed quickly by specifying a workflow of the application components which are previously developed for one or more different applications. Further, the components of an original application can also be easily re-arranged to update the high level business logic/process.

Thus, even when the source code of the application components (415) is not available (and may be obfuscated), access to the interface definition of the components (e.g., the task modules) is still available. The method processor (411) uses the interface definition of the components to load the modules, provide data to the modules and obtain data from the modules. Such interface definition can be used in the construction of new workflow methods.

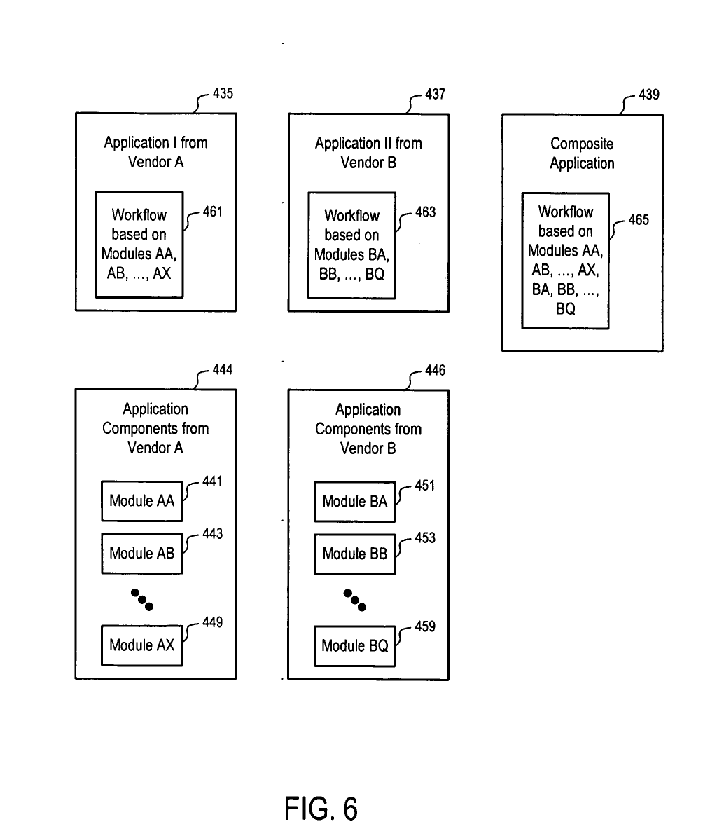

FIG. 6 illustrates a way to build a composite application. For example, in FIG. 6, a vendor A may provide application components (444) (e.g., coding and compiling the modules from source code), including a number of modules (441, 443, . . . , 449). The vendor A may provide an application (435) which is in the form of a workflow (461) based on the modules (441, 443, . . . , 449) from the vendor A.

Similarly, in FIG. 6, a vendor B may provide application components (446), including a number of modules (451, 453, . . . , 459). The vendor B may provide an application (437) which is in the form of a workflow (463) based on the modules (451, 453, . . . , 459) from the vendor B.

In one embodiment of the present invention, a new composite application (439) can be developed as a workflow based on modules (441, 443, . . . , 449) from the vendor A and modules (451, 453, . . . , 459) from the vendor B, without the need for source code access to any of the modules (441, 443, . . . , 449 and 451, 453, . . . , 459).

Thus, components of existing application can be used to generate customized versions of applications that are tailored to the individual needs of the mobile application users and/or their customers.

User Interface Processing

In one embodiment of the present invention, a method processor is designed to load a subsequent user interface task module before the closing of the current user interface task module.

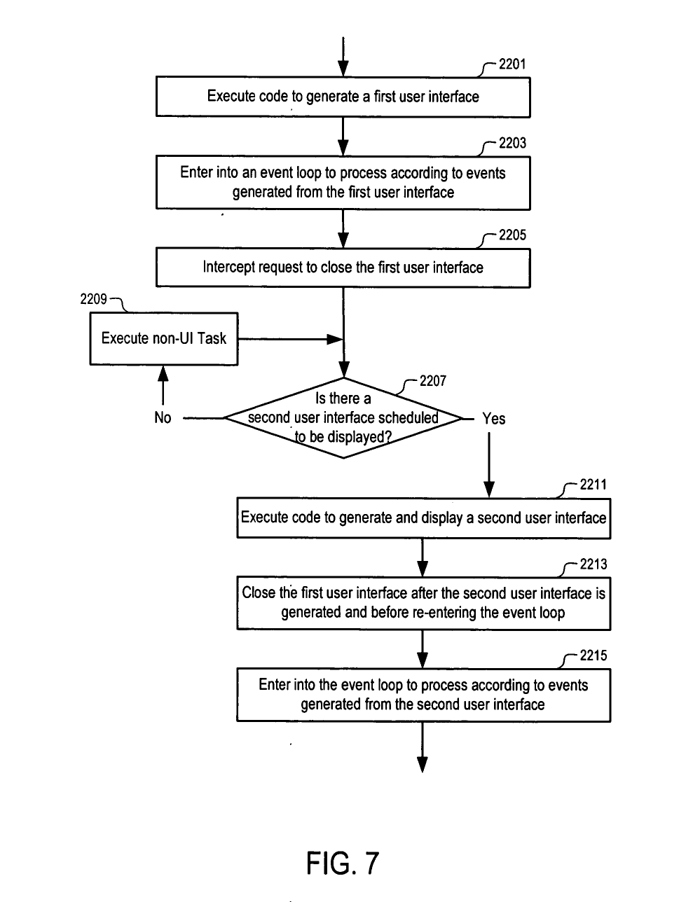

FIG. 7 shows a flow diagram of a process to render user interfaces for sequential display. In FIG. 7, after the code for a task module is executed (2201) to generate a first user interface (e.g., a user interface form), the system enters (2203) into an event loop to process according to events generated from the first user interface.

After the method processor intercepts (2205) the request to close the first user interface, it is determined (2207) whether there is a second user interface scheduled to be displayed.

If there is no user interface scheduled to be displayed, one or more non-UI tasks are executed (2209), which may lead to a user interface task along a path in a workflow.

If there is a second user interface scheduled to be displayed, the code for a task module is executed (2211) to generate and display the second user interface. After the second user interface is generated and ready for display, the first user interface is closed before re-entering the event loop to handle user events for the second user interface. The system then enters (2215) into the event loop to process according to the events generated from the second user interface.

The second user interface can be generated and painted over the background (or buffered) before the first user interface is closed. The second user interface may be painted above the first user interface or just underneath the first user interface. Thus, when the first user interface is closed, the second user interface is displayed over the background. Since the closing of the first user interface is delayed, the time duration between closing the first user interface and displaying the second user interface is reduced/eliminated. Such an arrangement can eliminate/reduce the flash/flicker which is caused by briefly displaying the background after the first user interface is closed and before the second user interface is displayed.

Thus, the method processor can intelligently schedule the closing of the user interface of one module of a workflow and pre-load/cache the user interface of another module of the workflow to eliminate the brief display of a background (or another form).

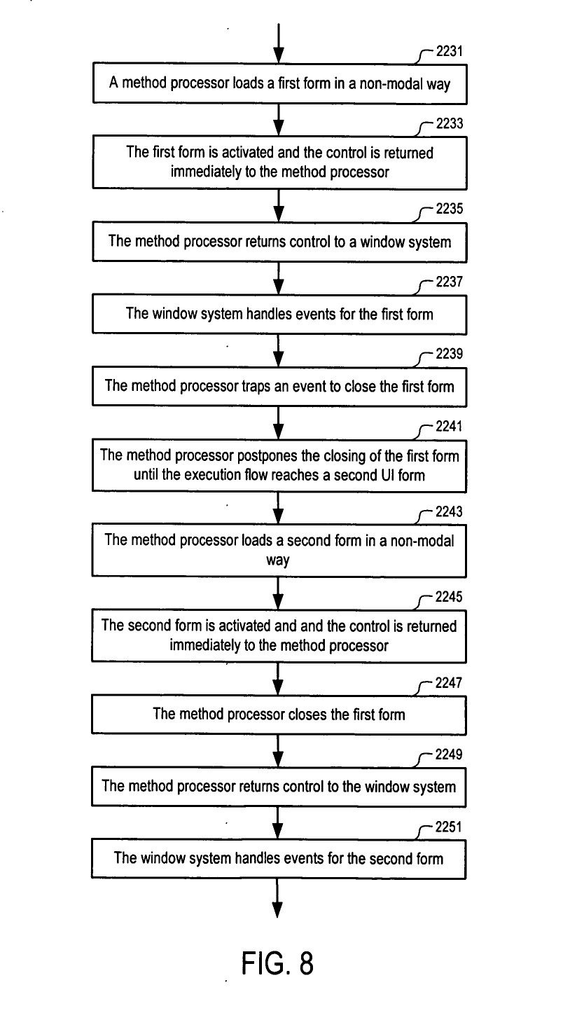

FIG. 8 shows a flow diagram of another process to render user interfaces for sequential display. In FIG. 8, after a method processor loads (2231) a first form in a non-modal way, the first form is activated and the control is returned immediately to the method processor (2231). The method processor returns (2235) control to a window system, so that the window system can handle (2237) events for the first form.

After the method processor traps an event to close the first form, the method processor postpones (2241) the closing of the first form until the execution flow reaches a second UI form. After the event to close the first form, the processor may execute one or more non-UI modules, if there are any according to the workflow, before the execution flow reaches the second UI form. The method processor loads (2243) a second form in a non-modal way such that, after the second form is activated, the control is returned immediately to the method processor (2245). The method processor then closes (2247) the first form and returns (2249) the control to the window system to handle (2251) events for the second form.

Thus, the method processor loads modal forms in a non-modal way to allow the subsequent form to be displayed over the background (and over other forms), before the previous form is closed.

Different user interfaces for different task modules in a workflow are typically designed to be loaded in a modal way to prevent the user from interacting with the subsequent form before the current form is closed. The method processor (virtual machine for workflow) can load the forms in a non-modal way to allow the subsequent form to be generated over the background before closing the previous form (thus, allow both forms to coexist briefly). The method processor allows the forms to coexist briefly, between the user input to close the previous form and the system gaining the control to handle events for the subsequent form. The method processor can prevent the user from interacting the subsequent form before the previous form is closed (e.g., loading the subsequent form after trapping the event to close the current form and closing the form before entering the event loop to hand user inputs for the subsequent form).

A UI form may take up the entire screen of the display device, or the entire main window of an application, or a portion of the screen, or a portion of the main window. The screen may show the windows/forms of multiple workflow applications or modules that are executed asynchronously in different threads. Forms of an application may be rendered inside one main window or different windows. Flash/flicker may be the result of the brief display of the desktop/screen background, or the background of the main window, or a portion of the desktop/screen background, or a portion of the background of the main window, or a portion of another window/form, in a time period between the close of the old form and the display of the new form. The screen background is displayed when no application window is displayed in at least a portion of the screen. The background of the main window is displayed when no form/window is displayed over at least a portion of the main window. To remove the flash/flicker, a new UI form may be rendered on top of the old UI form that is to be closed, or be rendered under the old form but above other forms, windows, and the desktop/screen background. The size of the new form and the old form that is to be closed may be the same or different.

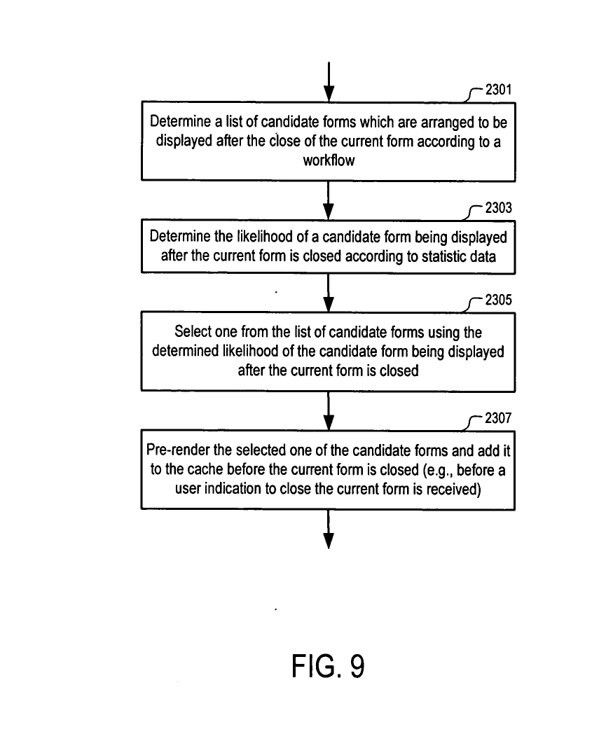

FIG. 9 shows a flow diagram of a process to selectively pre-construct forms. In FIG. 9, a list of candidate forms are determined (2301), which are arranged to be displayed after the close of the current form according to a workflow. The likelihood of a candidate form being displayed after the current form is closed is determined (2303) according to statistic data. The method processor selects (2305) one from the list of candidate forms using the determined likelihood of the candidate form being displayed after the current form is closed. The selected one of the candidate forms is pre-rendered (2307) and added to the cache before the current form is closed (e.g., before a user indication to close the current form is received).

The example in FIG. 9 includes the caching of user interface modules. However, the pre-loading and caching operations may also be performed for other types modules also. For example, a cache manager may look ahead of the current module that is being executed in the workflow engine and determine candidate modules that are arranged to be executed after the current module. The likelihood of a candidate modules being executed after the current module can be determined. For example, the likelihood may be determined based on statistical data obtained from past execution of the workflow on this mobile device and/or other mobile devices and/or based on predetermined weighting factors. One or more modules can be selected from the set of candidate modules for pre-loading and caching based on the determined likelihood.

A cache manager may run in a thread separate from the workflow engine to avoid degrading the performance of the workflow engine which runs the high priority operations. The cache manager can determine the list of candidates, determine the likelihood and select forms for pre-rendering and/or caching. The cache manager becomes active when the thread of the workflow engine is in a time period in which the demand for computation power is low (e.g., when the system is idle, when waiting for user to provide input to a user interface module, or when waiting for a network connection or other events).

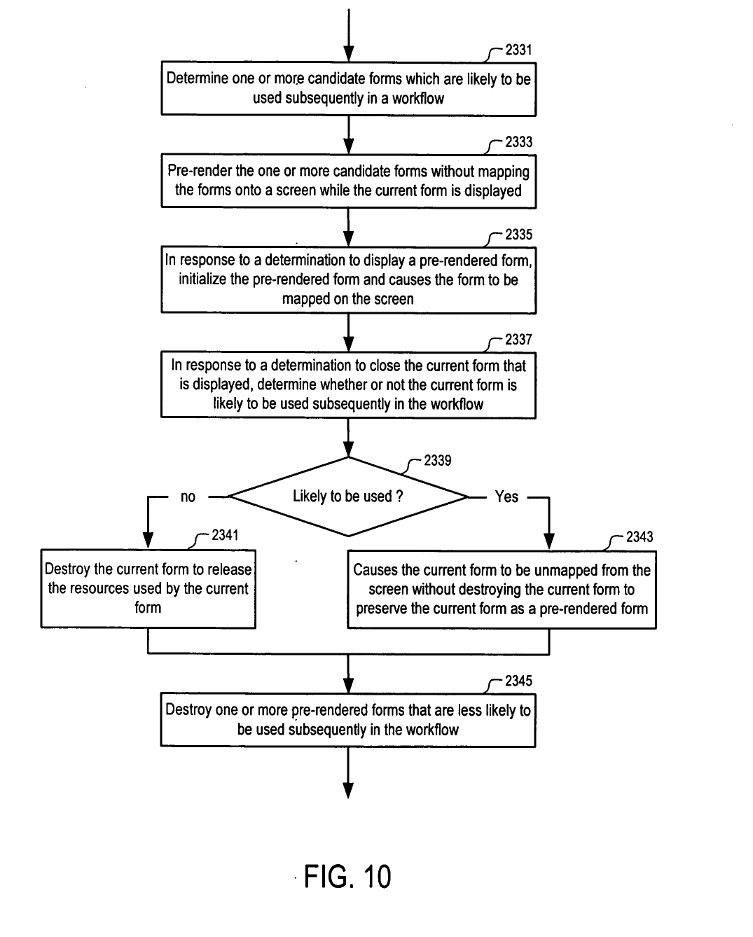

FIG. 10 shows a flow diagram of a process to selectively pre-construct forms. In FIG. 10, after one or more candidate forms which are likely to be used subsequently in a workflow is determined, the one or more candidate forms are pre-rendered without mapping the forms onto a screen while the current form is displayed.

In response to a determination to display a pre-rendered form, the pre-rendered form is initialized (2335) and caused to be mapped on the screen.

In response to a determination to close the current form that is displayed, it is determined (2337) whether or not the current form is likely to be used subsequently in the workflow.

If operation 2239 determines that it is likely to be used, the method processor causes (2343) the current form to be unmapped from the screen without destroying the current form to preserve the current form as a pre-rendered form.

If operation 2239 determines that it is not likely to be used, the method processor destroys (2341) the current form to release the resources used by the current form.

Further, the method processor can optionally destroy (2345) one or more other pre-rendered forms that are less likely to be used subsequently in the workflow.

Data Collection and Utilization

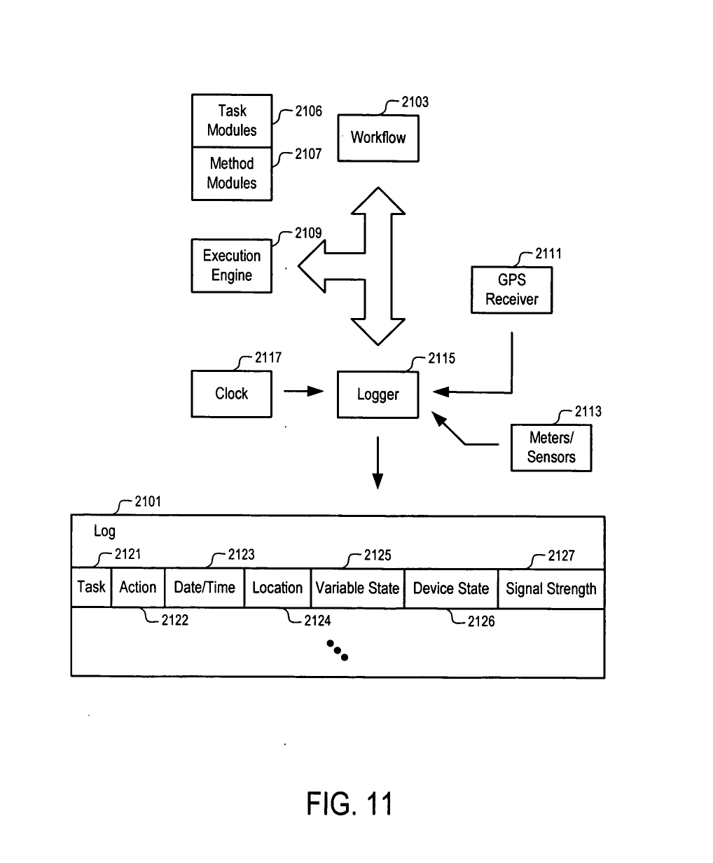

FIG. 11 illustrates a way to obtain log data. In FIG. 11, a logger (2115) is coupled to the execution engine (2109) to record time, location and other sensor/meter information relative to events and/or data associated with the execution of the workflow (2103).

The workflow (2103) is typically provided to the execution engine (2109) in a method file (e.g., in XML) which specifies the direction of flow among a number of modules, such as task modules (2106) and method modules (2107). The task modules (2106) can be in the same programming language as the execution engine (2109) so that the task modules can be loaded (e.g., as a shared library) into the execution engine (2109) and executed as part of the execution engine. The method modules (2107) can be in method files (e.g., in XML) which specifies the direction of flow among task modules and/or other method modules.

At a time of an event in the execution engine (2109) which causes the logger (2115) to generate a record, the logger (2115) can retrieve the corresponding time information from clock (2117), the corresponding location information from GPS receiver (2111), and other sensor/meter information from meters/sensors (2113) and record the time, location and sensor/meter information together with event information obtained from the execution engine (2109) and/or system information about the mobile device.

For example, the logger can record the time when a module (e.g., a task module or a method module) is started, the memory status when the module is started, the immediate prior module which leads to the current module, information about the module such as the name, resource, type, and the source of the module (e.g., where the module comes from, the provider of the module), any access to the global variable pool (e.g., reading, writing, etc.), the outcome of the module when the module exits, the duration of the execution of the module, which is the next executed module, etc. The logger provides the location stamp and the time stamp for the information logged. The logged data can be used to determine duration of the execution of subparts of a workflow. The logged data may further include user input such as keystroke or data input sequencing, typos, errors, connections, data entry types (e.g., scanner, keyboard, etc.)

In one embodiment of the present application, the execution engine is designed to process the method files received as workflow applications in a queue. When the queue is empty, the execution engine waits for the arrival of new workflow applications (e.g., received over a network connection, or generated by the execution engine). A graphical user interface may be presented to display the queue. The execution of a workflow application may be in response to a user selection of the workflow application or in response to a determination that the workflow application has a sufficiently high priority to be initiated automatically. Some workflow applications may be executed once and be removed from the queue. Some workflow applications may be executed and returned to the queue for future execution. Thus, the execution engine can be considered executing a queue processing application which may never end; and the workflow applications in the queue can be considered as method modules of the queue processing application. The queue processing application may also be described as a workflow which can run various other workflow applications as sub-workflows (synchronously or asynchronously). Thus, multiple workflow applications may run asynchronously in different threads.

The logger can record the information about when the workflow application is received, load, executed, etc. The logger can further record when updates to the modules are received and from where.

In general, the logger stamps the information obtained the execution engine with information obtained from various sensors and meters, such as clock, GPS receiver, etc.

For example, a signal sensor can be used to determine the signal strength of a wireless communication connection (e.g., Bluetooth, WiFi, WiMax, or cellular data communication connection). For example, a meter can be used to determine the gas level in the tank of a vehicle (e.g., through a connection to a vehicle bus). For example, a temperature sensor can be used to determine the current temperature (e.g., of the mobile device, a compartment of the vehicle in which the mobile device is placed, etc.).

For example, a mobile device may be equipped with, or connected with, a digital camera (e.g., a still picture camera or a video camera) and/or a microphone. The mobile device may use the camera to capture images, and/or use the microphone to capture sound clips, as log data. For example, a mobile device may be equipped with, or connected with, a phone; and the mobile device may use the phone to collect information as part of the log data.

The mobile device may further log data based on the usage of the camera or phone or other peripheral devices, such as a printer, a scanner, a bar code reader, a Radio Frequency Identification (RFID) reader, etc. For example, when the camera is operated by the user, or when the phone starts or ends a call, the mobile device may automatically log the event in association with other sensor data (e.g., the time, location, temperature) and workflow related data (e.g., the state of the workflow engine and the memory status). Thus, from the log data it may be determine when, with who, for how long and in what circumstance (e.g., relative to the execution of a workflow application) the user makes phone calls. For example, the Radio Frequency Identification (RFID) reader may be used to poll surrounding RFID tags to obtain RFID tag information as part of the log data.

Further, for example, the mobile device may be equipped with one or more network communication interfaces for wired and/or wireless communication connections. The mobile device may automatically determine the availability of the communication connections. Changes in the availability of the network communication connections may be events to cause the mobile device to create log entries. And other events that cause the creation of log entries may also cause the mobile device to determine the current availability of the network communication connections and save the availability data in association with other sensor data and/or workflow data in the log entries.

Further, the mobile device may use the network communication connections as data sensors to collect data as part of the log data. For example, at the time of a log event, the mobile device may use the network connection to poll a “remote sensor” for data that can be include with the log entry. The “remote sensor” may be an application running on another mobile device, an application running on a server, a web page for accessing certain data, the status of an equipment or system, etc. For example, the mobile device may communicate with a temperature sensor installed in a cooler of a customer (e.g., through a Bluetooth or WiFi connection) generate a log entry when a temperature from the sensor is available, and add the temperature data to entries that are logged in response to events while the temperature data is available. For example, the mobile device may retrieve inventory information from the customer as log data. For example, the mobile device may include an RFID reader, which reads the RFID tags at the site of the customer (e.g., for the products that have been previously delivered to the customer) to perform an inventory operation for the customer; and the inventory data may be further pushed to a server of the customer as a service for the customer. Thus, a sensor may be a software based sensor, a hardware based sensor, or a sensor partially implemented in software and partially implemented in hardware. The sensor may be hardwired to the mobile device, or coupled to the mobile device through wired or wireless communication links. An log event may cause the mobile device to poll the remote sensor for data; and the certain events associated with the remote sensor may also generate a log event to poll other data.

The mobile device may analysis log data related to a customer and provide feedback and/or suggestion to the customer. For example, the mobile device may determine a performance indicator of the customer and compare that to an organizational goal of the customer. The mobile device may optimize a workflow based on the performance indicator for execution on the mobile device, or for execution on a device of the customer. The mobile device may analyze the log data related to the customer and provide additional offers to the customer based on the result of the analysis. Based on the analysis of the log data, the mobile device may change certain terms of service on-the-fly, with or without further communication with a dispatcher. Further, incentive programs for each customer may be customized based on the result of the analysis of the log data related to the corresponding customer.

Thus, the logging of data may be in response to events generated in the execution engine and/or in response to events generated in the peripheral devices and/or remote sensors.

Further, the network connections may be used to push log data out to a “data sink”, in additional to poll remote sensors to collect data. For example, a mobile device may deliver log data to one or more “data sinks”, in additional to creating a log entry on the mobile device. A data sink may be an application running on another mobile device, an application running on a server, a web site for collecting certain data, etc. For example, the mobile devices of one company may be used to push log data of workflows executed for its customers to servers of their respective customers so that the customers may analyze the log data to improve their business practice. The data may be transmitted to the respective customers at the time the data is logged, if network connections is available, or transmitted in batch mode. For example, at the time of log data creation a log data entry may be provided through a Bluetooth or WiFi connection to a customer, if the connection is available at that time, to provide the log data to the customer. The log data can be useful to the customer. Thus, the customer may receive the data collection service in additional to the regular service from the user of the mobile devices. For example, the log data may provide the customer the indication of how the representative of the customer (e.g., an employee or a sale person) performs during a transaction based on a workflow executed on the mobile device, while the mobile device is at a location of the customer. For example, the mobile device may poll a RFID tag that is indicative of identity of the representative of the customer (or take a digital picture, or record a sound clip); the mobile device may provide to the customer the time and duration of tasks performed in cooperation with the representative of the customer; the mobile device may provide statistical averages for the durations to perform these tasks as performance indicators, etc.

When the workflow enters a module (e.g., a task module or a method module), the execution engine (2109) provides the name of the module and the action of entering the module to the logger (2115) so that the logger may record the task (2121) and action (2122) with the date/time (2123) obtained from clock (2117), the location (2124) obtained from GPS receiver (2111), and/or other sensor data. Further, the execution engine (2109) can provide the values of the variables related to the module (e.g., global variables of a global variable pool and/or local variables of the module) to record the variable state (2125). The logged data can further include the device state (2126) (such as the memory usage level and CPU usage level) and signal strength (2127) obtained from a sensor for a wireless communication connection.

For example, the logger may record the time when and the location where the wireless communication connection and other network resources are available, as the execution engine enters or exits modules of a workflow and/or as the availability changes.

The execution engine (2109) and the logger (2115) may run in a same thread so that the data logging is synchronous with the execution of the workflow (2103). Alternatively, the logger (2115) and the execution engine (2109) may run asynchronously in separate threads to reduce/limit the impact of activity of the logger on the execution of the workflow (2103).

During the execution of the workflow (2103), the execution engine performs various operations, such as feeding a module with data from a global variable pool when entering the module, retrieving data from local variables of the module, storing the retrieved data into the global variable pool when exiting the module, and intercepting user interface events for the user interface module, etc. The operations of the execution engine can generate events to cause the logger (2115) to recorded the time, location (when available), and other available sensor/meter data in connection with data supplied from the execution engine related to the operation, such as the value of the global/local variables, the memory state of the execution engine, etc.

In general, any activities by the execution engine (2109) in connection with the execution of the workflow (2103) can be used to generate data logging events to record information about the activities together with the corresponding time, location, and meter/sensor information. Thus, the log data can be collected without having to code the individual task modules to perform the data logging operations.

The intensity of data collection by the logger (2115) may be controlled in a number of ways. For example, a method file for the workflow (2103) may associate level identifiers with the modules used in the workflow. For example, one module in the workflow may be designated at level 1; and another module in the workflow may be designated at level 3. When the method processor is instructed to collect data from modules designated at level 3 and above, the data logging events associated with modules that are designated at level 2 or below are ignored or not generated at all; and the data logging events associated with modules that are designated at level 3 or above are acted upon to record data records. For example, a threshold level indicator can be provided to the execution engine; if the execution engine determines that the current module is designated at a level lower than the threshold level indicator, the execution engine does not generate data logging events for the module; otherwise, the execution engine generates the data logging events for the module (e.g., as the workflow enters or exits the module or accesses the global variable pool, etc.).

There can be a number of different ways to inform the method processor about the threshold level indicator. For example, a configuration parameter may be specified as part of the method file which defines the workflow application; and the configuration parameter specifies the threshold level such that, when a module used in the application is designated at a level on or above the threshold level, data is logged for that module; otherwise, data is not logged for that module. The designation of the levels of the modules can be also be specified in the method file (e.g., in the tag where the module is identified, as an element or an attribute). Thus, the same module may be designated at different levels in different method files.

Further, for example, the configuration parameter may be specified in a configuration file for the workflow application. Further, a configuration file for the mobile device can specify a threshold level for the configuration parameter, which can be used as a default when the parameter is neither specified in the application specific configuration file, nor in the method file of the workflow application.

The data items to be collected may also be configured in a number of ways. For example, some of the global variables/local variables may be configured in the method file so that the variables are logged when entering the module, and/or existing the module, or not to be logged.

For example, a configuration file for the mobile device or for a specific application may specify which meter/sensor data should be logged when available and which meter/sensor data could be ignored even when available.

For example, a configuration file for the mobile device may define a number of log profiles, each of which indicates a set of data items to be logged when available and a set of events that would cause logging; and a configuration file for a specific application, or the method file of the workflow application, can specify a log profile to be used by the method processor to control the logging activity.

In general, different ways to specify the level of data logging intensity can be used in combination to provide a hierarchical system to specify filtering criteria to control the logging intensity. Thus, a suitable amount of data can be collected during the execution of the workflow application.

The log data generated by the logger (2115) can be transmitted as a live data stream from the mobile device to a server system (or another mobile device) for real time monitoring and control. The log data can also be stored on the mobile device for batch delivery through a network connection. Further, different types of log data may be assigned different level of benefits. Based on a cost-benefit analysis, different types of log data can be transmitted at different time through different types of network connections.

In one embodiment of the present invention, a method processor can capture and log the screen images of user interface tasks (e.g., for documentation).

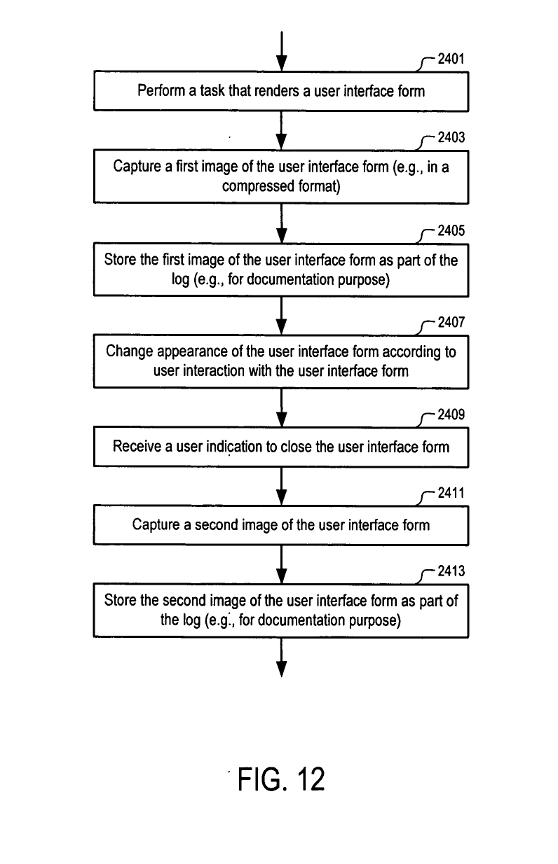

FIG. 12 shows a flow diagram of a process to log screen images of user interfaces by a method processor. In FIG. 12, after a task that renders a user interface form is performed (2401), the method processor can capture (2403) a first image of the user interface form (e.g., in a compressed format) and store (2405) the first image of the user interface form as part of the log (e.g., for documentation purpose). The screen image may be captured in a pixel format and compressed using a lossless compression technique. When a lossless compression technique is used, the decompressed image data will be the same as the original image data. Alternatively, or in combination, a lossy compression technique can also be used. When a lossy compression technique is used, the decompressed image data may be different from the original image data. The method processor may dynamically determine whether to compress the image data and the compression technique to be used if it is determined to compress the image data, based on one or more factors such as network connection availability, bandwidth of available network connection, current processor load status, memory status of the mobile device, etc., to optimize the performance of the system. The mobile device may also use a circuitry other than the main processor to perform image compressing.

The stored log data can be transmitted in a batch mode. Alternatively, the captured screen image can be transmitted (e.g., substantially in real time) to a server system (or to a mobile device) through an available network connection (e.g., through a local area network connection, or a WiFi connection, etc.).

In FIG. 12, after the appearance of the user interface form is changed (2407) according to user interaction with the user interface form, a user indication to close the user interface form may be received (2409). The method processor can then capture (2411) a second image of the user interface form and store (2413) the second image of the user interface form as part of the log (e.g., for documentation purpose).

In one embodiment of the present invention, when the method processor is instructed to run in a documentation mode (e.g., through an application specific configuration file, or a configuration file for the method processor), the method processor can automatically run through modules to capture the screen images of graphical user interfaces as part of the log stream.

For example, when in a documentation mode (or other execution mode), the method processor can load a user interface task module, capture the screen image of the form generated by the task module, automatically close the form (without user input or user interaction with the form), and automatically select a path that has not been previously followed in the documentation run of the workflow, and repeat the execution of workflow to cover all task modules and all execution paths among the modules. Thus, without user interaction, the method process can automatically run through the modules of the workflow to capture screen images of various user interface forms.

An indication to run the workflow in a documentation mode may be provided in a configuration file for the device, in the configuration file for the workflow application, or in the method file of the workflow application.

Alternatively, the method processor may also capture screen images of user interface forms in a mode in which the user can provide input and interact with the user interface forms.

Further, the method processor may selectively intercept user interface events which may cause the change of appearance of the user interface forms and capture screen images in response to such user interface events.

The captured screen images can be used for the documentation of the workflow application, used as a training tool (e.g., when compiled into a training video), etc.

One embodiment of the present invention includes the use of log data to optimize/improve the business process of a mobile application.

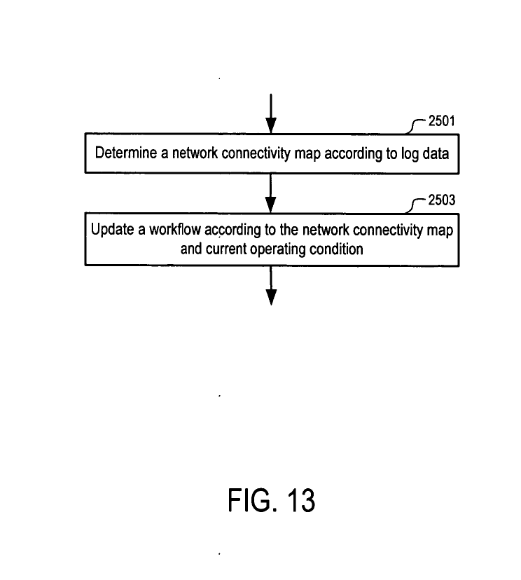

FIG. 13 shows a flow diagram of a process to improve workflows using log data. A network connectivity map according to log data is determined (2501) and used to update (2503) a workflow according to the network connectivity map and current operating condition. For example, based on the current speed and travel direction of the mobile device, the method processor may predict the time to outage of network connection (e.g., moving into a region where wireless network connection is not available). The estimation may be improved with past log data that are generated during the execution of the same or similar workflow application. In anticipation of the network outage, the method processor may reschedule the execution of the current workflow or decrease the priority of the current workflow to allow communication operations which require the network connection to be perform before the outage of network connection.

Further, based on the pattern of network outage relative to the execution of the workflow application, the flow of modules in the workflow application can be rearranged/updated to make use of the available wireless network connection and reduce or eliminate the dependency on network connection for the time period in which the mobile device is in the region without network connections. For example, data and/or modules which may be needed during the execution of the workflow while the mobile device is in such a region can be pre-loaded into the mobile device before the mobile device reaching this region.

The network connectivity map may be generated based on the log data of the mobile device and/or other similar mobile devices.

Further, the network connectivity maps which show the location and/or time of network availability can be collected from different mobile devices into a server to generate a composite map for a service area. Portions of the composite map may then be selectively transmitted to individual mobile devices to aid the mobile devices in predicting the outage of network connection.

Based on the availability map of the service area (e.g., as a function of time of the day), the dispatcher or application developer can optimize the mobile applications by avoiding the dependency of network resources while mobile devices are in the “blind spots” in which network connectivity is not available (in specific time and space location).

For example, before a mobile device enters a “blind spot” for network connectivity, the method processor of the mobile device may start a communication session which may or may not be previously scheduled. The communication session may be the last communication opportunity before the mobile device enters and stays in the “blind spot” for a period of time. The mobile device may determine any communication needs (e.g., based on looking ahead of the workflow and/or statistical data for executing workflows related to this blind spot). For example, the communication session may be started to determine whether there is any network communication needs in near future. A period of time until the mobile device comes out of the blind spot can be estimated (e.g., (e.g., based on log data and/or statistical analysis of log data which may be collected by the same mobile device and/or other mobile device). The estimation may be made by the mobile device, or by the server, or based on a combination of estimations made by the mobile device and the server. The mobile device may query a server to determine whether the server may need to communicate with the mobile device for the estimated period of time.

For example, the mobile device may determine whether there are data scheduled to be transmitted from the mobile device and perform the data transmission before reaching the “blind spot” when there exist such data. For example, the mobile device may check with a server to determine whether there are pending updates, data, workflow applications, service requests, instructions, etc., that are to be transmitted to the mobile device and start to download from the server if there exist such scheduled communications. For example, the mobile device may download from the server the next service request, service instruction, or dispatch workflow for a task that is scheduled to be carried out by the user of the mobile device (e.g., the workflow application for the next stop of delivery), so that the mobile device gets the next task before the current task is completed, in anticipation that the mobile device may be in the “blind spot” at the time the mobile device finishes the current task; the mobile device may download the data that may be used to carry out the current and/or the next task, such as product recall information, price adjustment information (e.g., in view of a competitor's offer), list of supply/parts needed for the next service, product details for the service. For example, the mobile device may report to the server that a customer or the deliver truck is running out of a particular type of supply. The mobile device may report that an equipment (e.g., a cooler) is broken, receive a workflow application to address the situation, and run the workflow application to work through a diagnose process, and place an order of parts needed to repair the equipment. The mobile device may report the need for transportation and require a dispatcher to make an arrangement.

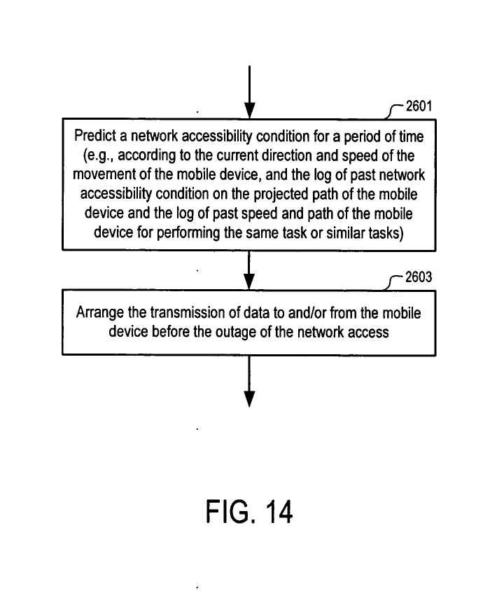

FIG. 14 shows a flow diagram of another process to improve workflows using log data. In FIG. 14, a network accessibility condition for a period of time is predicted (2601). The prediction may be made according to the current direction and speed of the movement of the mobile device, the log of past network accessibility condition on the projected path of the mobile device, and the log of past speed and path of the mobile device for performing the same task or similar tasks, etc. Based on the prediction, the transmission of data to and/or from the mobile device before the outage of the network access can be arranged (2603).

For example, the method processor may automatically increase the priority of communication tasks to allow the communication operations to be performed earlier (e.g., before the outage of network connection).

For example, the method processor may prompt the user to execute a pending workflow application which requires network connectivity in a high priority thread and decrease the priority of the workflow of the thread that may not need the network connectivity during the time period in which the mobile device is in the “blind spot.”

For example, a dispatcher may modify the workflow and transmit the updated workflow to the mobile device before the mobile device reaches the blind spots. For example, the dispatcher/controller may push applications and data to the mobile device before the mobile device reaches the “blind spot.”

For example, the mobile device may transmit data (e.g., log data, or application data such as changes to check-out version of data, etc.) to the server before the mobile device reaches the “blind spot.”

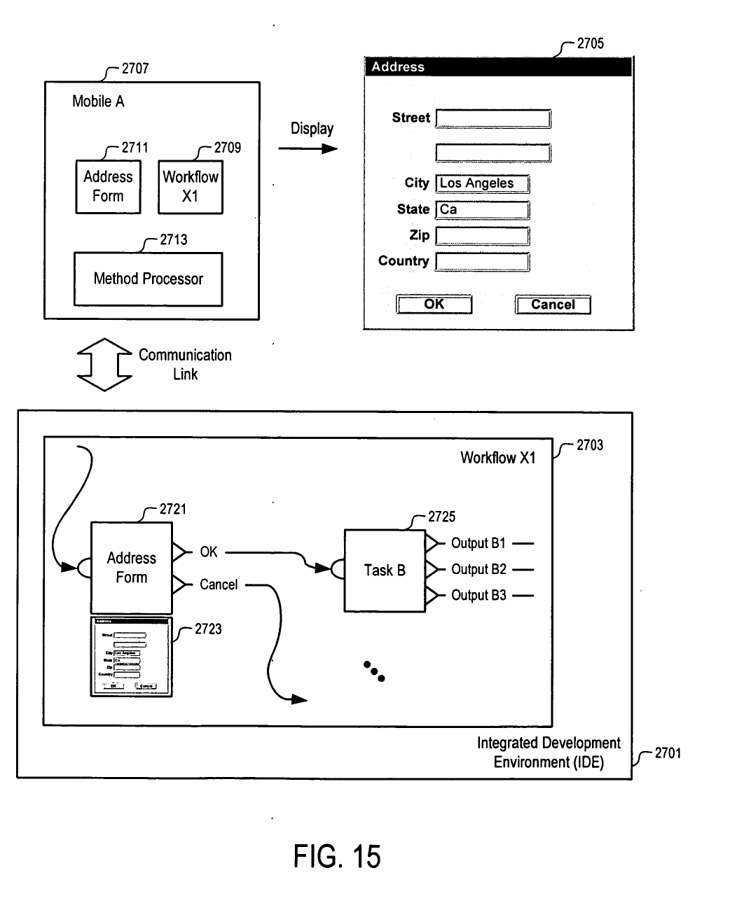

FIG. 15 illustrates an integrated development environment with a self documenting feature. In FIG. 15, a display of the integrated development environment (IDE) (2701) shows a graphical representation of a workflow (2703). The workflow (2703) specifies the direction of flow among a number of modules, such as flowing from address form (2721) to task (2725) when the output of the address form is “OK”. For example, when the “OK” button of the address form is pressed, the address form generates the outcome “OK”; when the “Cancel” button of the address from is pressed, the address from generated the outcome “Cancel”.

After the address form (2711) is loaded into the mobile device (2707) and the workflow is transmitted to the mobile device (2707), the definition of the workflow (2709) (e.g., in XML) can be loaded by the method processor (2713) for execution on the mobile device (2707). When the flow reaches the address form and the code for the address form (2711) is executed on the mobile device, a display of the address form (2705) is generated on the screen of the mobile device.

The method processor can capture the screen image of the display of the address form (2705) and transmit the captured screen image to the Integrated Development Environment (2701), which can then display a thumbnail-size version of the captured image (2723) near the iconic representation of the “address form” (2721). The captured image is reduced to a size (e.g., by the Integrated Development Environment (2701)) that is in the same order of the size of the iconic representation of the “address form” (2721) for display in the visual representation of the workflow (2703). Integrated Development Environment (2701) can also display a full-size version of the captured image (e.g., when the thumbnail-size version of the captured image is selected). Further, the Integrated Development Environment (2701) may display the captured image according to a size configurable by the user. For example, the user may specify a preferred size of the captured image, or a factor to reduce the capture image, to generate a version of the captured image for display in the visual representation of the workflow.

Alternatively, the thumbnail-size version of the captured image can be used to replace the generic icon that is used represent the address form in the visual representation of the workflow (2703) in the integrated development environment (2701) when the captured image is not available. When the captured image is available, the generic icon or the thumbnail-size version of the captured image can be selectively used according to a user preference.

In one embodiment of the present invention, when the thumbnail-size version of the captured image (2723) in the graphical representation of the workflow (2703) is selected by the user (e.g., through clicking a mouse button while the cursor is over the image, or through hovering or stopping the cursor over the image, etc.), the full version of the captured image can be displayed to show the details of the captured image. The thumbnail-size version of the captured image (2723) in the graphical representation of the workflow (2703) can also be selected to bring up a user interface to edit the source code of the corresponding task module. Different ways to select the thumbnail-size version of the captured image may cause different actions, such as displaying the full size image, opening a window for the editing of the source code, etc.

Further, the method processor may capture updated screen images as the user interacts with the address form displayed on the mobile device. The updated screen images can be transmitted to the integrated development environment so that the developer/dispatcher using the Integrated Development Environment (2701) can watch the real time activity of the workflow. The thumbnail-size version of the captured image (2723) can be updated according to the updated screen image.

Further, the Integrated Development Environment (2701) can store a set of captured screen images in a sequence as captured by the method processor and display a time line of the screen images in response to a user request.

In one embodiment of the present invention, the method processor (2713) of the mobile device (2707) can transmit the log data to the integrated development environment so that the developer/dispatcher using the Integrated Development Environment (2701) can watch and see graphically which of the task modules have been executed, which of the flow paths have been executed, which of the task modules have not yet been executed, which of the flow paths have not yet been executed, etc. Further, the Integrated Development Environment (2701) can show how many times a module or a flow path has been executed and/or an indicator of frequency of the execution of a module or a flow path. From the integrated development environment (2701), the developer/dispatcher can inspect the values of the variables (e.g., global variables of the workflow) as reported by the logger of the method processor (2713), while the workflow application is being executed on the mobile device. Thus, the integrated development environment (2701) can be used to debug and diagnose the workflow application that is running in the real world live.

For example, the dispatcher may monitor the execution of the workflow on the mobile device and provide help to the user of the mobile device when needed.

For example, the developer may monitor the execution of the workflow to fully debug the application.

For example, the trainer using the Integrated Development Environment (2701) can monitor the progress of a trainee who is using the mobile device (2707).

During the execution of the workflow, the method processor may log data to the fully extend (or at other specified data logging level) to provide log data related to the time, location, variable states, memory states and other sensor/meter data to the Integrated Development Environment (2701), which may display the log data in a structured way upon in response to a user request. Thus, the Integrated Development Environment (2701) can also be used in data mining the log data collected by the method processor (2713).

In general, the mobile device (2707) may transmit all the captured data to the Integrated Development Environment (2701) in real time, or part in real time and part in batch mode, or all in batch mode. For example, the log data may be stored in a file and loaded into the Integrated Development Environment (2701) when available for analysis.

The log data collected from one or more mobile devices may also be stored in a database, loaded into a spreadsheet for analysis, loaded into a custom tool for data mining and analysis, etc.

In one embodiment of the present invention, a pattern recognizer may monitor the output of the logger to detect pre-defined patterns on-the-fly. The occurrence of the pre-defined patterns can then generate a data logging event and/or an alert.

The features described can also be implemented in a stand alone application or other applications (e.g., as a plug-in module) which may not be an Integrated Development Environment (2701). For example, a stand alone application can be used to display a visual representation of the workflow (e.g., based on information provided in the method file), receive a real time stream of log data or a batch file of log data, display captured screen images of forms/graphical user interfaces, show the paths and modules that have been executed, display values of variables in the global variable pool, display memory status/device status of the mobile device, display meter/sensor data logged by the mobile device, etc. It is understood that it is not necessary to implement the monitoring, diagnosis, training, data mining, and other capabilities described above in an Integrated Development Environment. These can be implemented in a stand along tool, or other applications. Further, it is not necessary to implement all these capabilities in a same application. An application may include one or more of these capabilities, which may run on a mobile device, on a desktop computer or workstation, or a server computer.

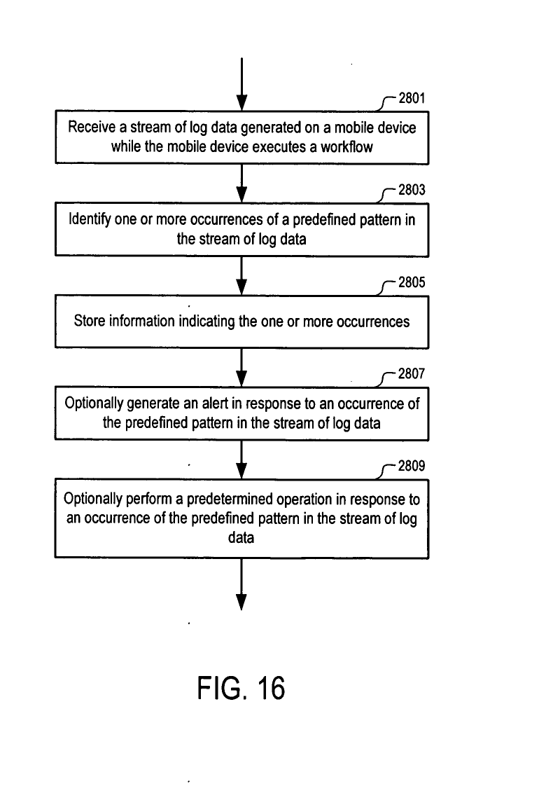

FIG. 16 shows a flow diagram of a process to utilize patterns in a stream of log data to provide a monitoring feature. In FIG. 16, after a stream of log data generated on a mobile device is received (2801) while the mobile device executes a workflow, one or more occurrences of a predefined pattern in the stream of log data are identified (2803). Information indicating the one or more occurrences is stored (2805). Optionally, an alert in response to an occurrence of the predefined pattern in the stream of log data can be generated (2807).

Optionally, the mobile device may perform (2809) a predetermined operation in response to an occurrence of the predefined pattern in the stream of log data. For example, the method processor may log the occurrence of the predefined pattern; the method processor may execute another application or module (e.g., a workflow executed in a separate thread) in response to the occurrence of the predefined pattern; and/or the method processor may alter the current execution of the workflow in response to the occurrence of the predefined pattern.

The identification of the occurrence of the predefined pattern can be performed substantially in real time on the method processor (e.g., in a background thread that monitoring the data generated by the logger). When the occurrence of the predefined pattern (e.g., a particular combination of log data items) is detected, the method processor may determine that a “signature” event happened, which may cause the logger to log additional information (e.g., time or location) and/or cause the method processor to run additional modules (e.g., in a separate thread) to provide a warning signal, to provide help information, to prompt the user to take certain action, etc.

For example, a threshold time period to perform a set of operations by a user be determined (e.g., based on statistics from log data of past execution of the operations, or based on a projected target for a group of users or an individual user). The method processor may detect a “signature” event in which the time period to perform the set of operation by the user is longer than the threshold time period. The “signature” event may cause the transmission of log data relevant to the “signature” event to a server for further analysis. The occurrences of the “signature” event can be logged and analyzed.

Further, the “signature” event may be connected with a compensation system. For example, when the user performs the set of operations in a time period less than the threshold time period, the user may be rewarded (e.g., with reward points and/or bonus pay). The “signature” event can be logged and used in a performance enhancing system and/or a reward/compensation system.

Another example of a “signature” event includes a particular execution pattern of one or more modules. For example, when a user is confused with a user interface, the user may enter a user interface form and back away from the form and try another user interface form. For example, the user may be non-product for a period of time with a user interface form, etc. Thus, a “signature” event can be defined to detect the occurrence of non-productiveness and/or confusion, which may further cause the method process to execute a help module to provide instructions to the user and/or start a training session.

Further, “signature” events may be in the determination of the performance of the design of workflow applications. For example, when many users are confused by a user interface form, the user interface form may be examined, modified, and/or re-documented to provide better training, etc.

The logger of the method processor may be directed to log information in response to events that are defined as patterns of other events/data. Events/data for the logging activity can be filtered based on the pattern recognition analyses to reduce the amount of log data to be stored/transmitted. Thus, the pattern analyzer can be used as a filter of log data. The mobile applications may be developed to selectively log data at a high level, which may increase the efficiency and usefulness of logging and reduce the memory requirement and/or the bandwidth requirement for the transmission of log data. The desired level may be specified in a number of ways, such as in the method file, in a configuration file for the mobile device, in a configuration for the application, and a combination of these. It is understood that it is not necessary to code the level in a method file.

For example, the method processor may be configured to record the time duration of a group of modules to determine how long it takes to perform a unit of work (e.g., to scan a bar code, to deliver a package, to make a phone call, to fill up a tank, to obtain a signature of a customer, etc.). Alternatively, such data mining can be performed offline on a server after the log data is collected from the mobile device (e.g., in a batch mode or in real time).

For example, the log data can be used to determine the performance of a user relative to other users, relative to a predefined goal or a user set goal. The user may be rewarded in certain ways for meeting the goals (e.g., to accumulate points which may be redeemed for vacation or be used for the evaluations for promotions). The method processor may provide feedback, suggestions, or optimization of a workflow, based on the goal. For example, when the user sets a goal to accomplish a task within a certain time limit, the method processor may, based on statistical data, determine the estimated time limits for performing the subtasks of the task and provide feedback showing a comparison between the real time performance and the estimated time limits for the subtasks. The method processor may alert the user when the user is behind the schedule. Based on the log data, the method processor may look ahead and anticipate the need to preload user interface forms, preload modules, perform communication tasks to avoid being affected by network outage, power up a radio transmitter for a scheduled communication session, etc.

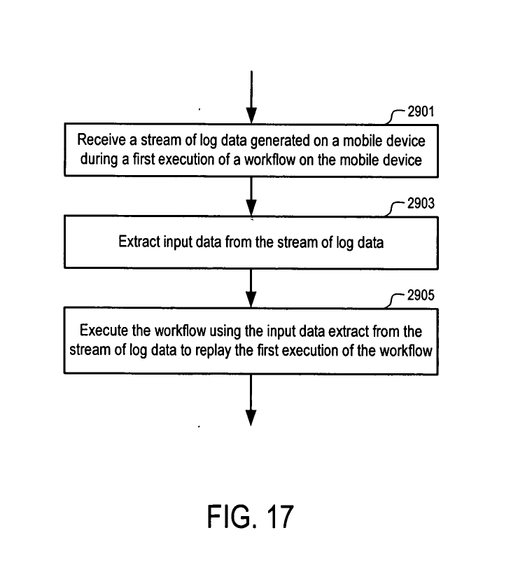

FIG. 17 shows a flow diagram of a process to replay an execution of a workflow. In FIG. 17, a stream of log data generated on a mobile device is received (2901) during a first execution of a workflow on the mobile device to extract (2903) input data from the stream of log data. The workflow can then be executed (2905) using the input data extract from the stream of log data to replay the first execution of the workflow. The capability to re-run the execution of a workflow based on the log data can be helpful in diagnosis, trouble shooting, debugging, training, etc.

Further, the recorded execution of the workflow can be used to guide further executions of workflow (e.g., by trainees). For example, the recorded log data of the execution of the workflow can be used as a standard execution path for the workflow in training sessions. When the execution path of the workflow on the mobile device of a trainee deviates the standard execution path, an alert can be generated to inform the instructor and/or the trainee. The method processor may bring the current execution back to the standard execution path, or allow the deviation to occur and continue.

For example, the method processor may run a background thread (e.g., a workflow application) on the mobile device of the trainee to compare the recorded log data of the standard execution and the log data generated from the execution by the trainee. When a deviation is detected, the method processor may alert the trainee and/or send a message to the instructor.

Alternatively, the method processor may transmit the live log data stream to the computer of the instructor. The computer of the instructor compares the live log data stream to the recorded log data of the standard execution to detect deviation, generates an alert to the instructor, and/or sends an message (e.g., as a workflow application with high priority) to the mobile device of the trainee.

In one embodiment of the present invention, a method processor may be configured to provide help information for the modules used in the workflow. For example, a help file/entry may be associated with a module (e.g., by specifying a help identifier in a tag that identifies the module in the method file that uses the module). When a “help” button on the mobile device is pressed (or other user input is received to request help) while this module is being executed, the method processor can automatically determine the help file/entry and display the corresponding help information.

Further, for example, a graphical user interface module may present a data entry form. The graphical user interface module may have a number of states, depending on the user input. For example, the keyboard focus may be at different entry boxes, depending on the user input. The help file may specify different contents for the module in different states. During a documentation run of the workflow, different states of the graphical user interface module can be identified by the method processor with corresponding captured screen images. The integrated development environment can then be used to assign different help entries to the different states of the graphical user interface module. When the “help” button is pressed, the method processor can automatically retrieve the help entry for the corresponding state of the graphical user interface module to provide the most relevant help information.

Thus, the code development of the task modules can be separate from the documentation and help system of the module.

Further, a same user interface task module used in different applications can have different help information. For example, a default help file for the module can be used when there is no application specific help information for the module. An application specific help information can be provided in addition to the default help information for the module or as a replacement to the default help information.

The help information may be specified in a configuration file (e.g., the configuration file for the module, or for the application) or specified in the method file that specifies the workflow.

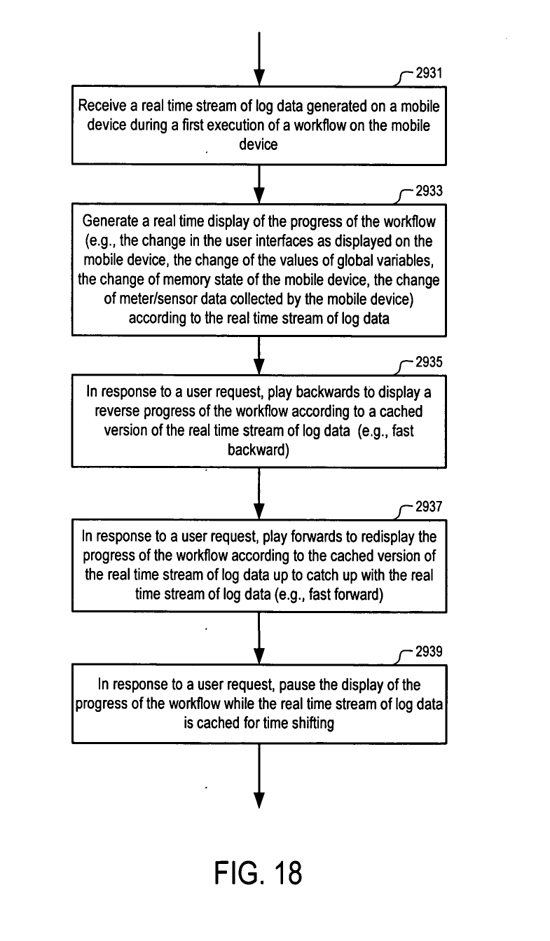

FIG. 18 shows a flow diagram of a process to display an execution of a workflow with a time shifting feature.

In FIG. 18, a real time stream of log data generated on a mobile device is received (2931) during a first execution of a workflow on the mobile device to generate (2933) a real time display of the progress of the workflow according to the real time stream of log data, such as the change in the user interfaces as displayed on the mobile device, the change of the values of global variables, the change of memory state of the mobile device, the change of meter/sensor data collected by the mobile device. The progress of the workflow may include the progress of meter/sensor data (e.g., the gas tank level, the temperature of the mobile device) in relation with the execution of the workflow.

In response to a user request, the execution of the workflow can be played (2935) backwards to display a reverse progress of the workflow according to a cached version of the real time stream of log data (e.g., fast backward).

In response to a user request, the execution of the workflow can be played (2937) forwards to redisplay the progress of the workflow according to the cached version of the real time stream of log data up to catch up with the real time stream of log data (e.g., fast forward).

In response to a user request, the display of the progress of the workflow can be paused (2939) while the real time stream of log data is cached for time shifting.

Thus, the stream of log data represents a time sequence of actions related to the workflow, which can be played in real time, paused for time shifting, played fast forward or backward, etc. Since the log data are time is stamped, the log data stream can be played at the same time scale as the stream of log data (e.g., playing at a normal speed of the data stream), or played at a different time scale (e.g., playing at a speed slower or faster than the normal speed of the data stream). Alternatively, the log data stream may be played step by step according to user control.

The display of the progress of a workflow may include display of the sequence of one or more of: graphical user interface, value of a global variable, module being executed, path from one module to the next, and measurement of a meter or sensor.

The playback of the workflow can be used to trouble shooting problems, evaluate the performance of the user, determine area of improvements, etc.

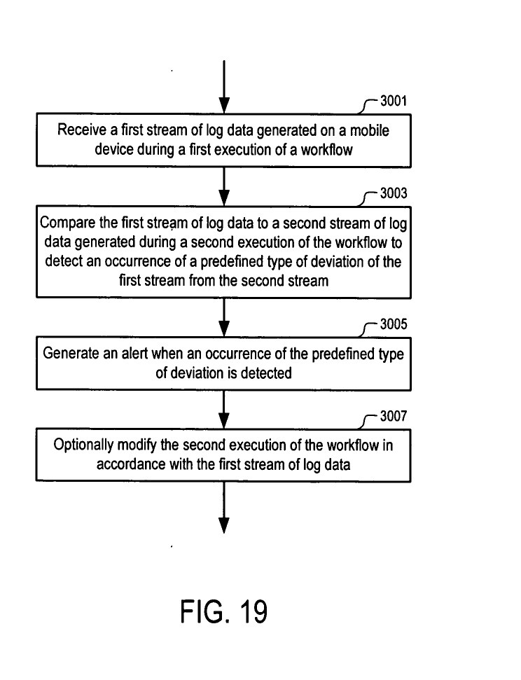

FIG. 19 shows a flow diagram of a process to monitor deviation from a reference execution of a workflow. In FIG. 19, a first stream of log data generated on a mobile device is received (3001) during a first execution of a workflow to compare the first stream of log data to a second stream of log data generated during a second execution of the workflow to detect an occurrence of a predefined type of deviation of the first stream from the second stream. An alert is generated (3005) when an occurrence of the predefined type of deviation is detected. Optionally, the second execution of the workflow can be modified (3007) in accordance with the first stream of log data.

A deviation may include one or more of: the deviation of execution path from one module to another and the deviation of data flowing into and/or out of a module.

For example, when a deviation in execution path is detected, the method processor may alert the user of the mobile device and re-execute the module that causes the deviation (e.g., in a training session). Alternatively, the user may be presented with an option to try the module again or to have the method processor to correct the execution path in accordance with the first stream of log data. Alternatively, the method processor may automatically correct the execution path after the user failed to provide the correct input a predetermined number of times (e.g., three times).

For example, the user may have selected a data option that changes a global variable to an incorrect value. The method process may re-execute the module to allow the user to select the correct data option, or alert the user about the mistake and automatically correct the global variable to the correct value to continue into the next module. Alternatively, the user may be presented with an alerting showing the mistake and an option to try the module again or to have the method processor to correct the global variable in accordance with the first stream of log data. Alternatively, the method processor may automatically correct the global variable after the user failed to provide the correct input a predetermined number of times (e.g., three times).

The method processor may selectively tolerate deviations in some global variables and force the execution in the training session to have certain values for other global values with or without alerting the user. For example, the method processor may automatically override some input values taken from the user to allow the execution in the training session to follow a prior recorded execution.

The method processor may selectively tolerate deviation in some execution paths. When the deviation is detected, the method processor may locate a corresponding location in the recorded stream of log data of the reference execution to match the current execution to a corresponding point in the reference execution and then continue the monitoring operation. The matching may be based on matching a continues execution path from one module to another, where the path may or may not include intermediate modules in between. The matching may be further based on the value of one or more global variables and/or other conditions.

In response to a deviate, the method processor may execute a help module to guide the user. For example, the help module may determine the possible source of errors and provide instructions to the user to avoid the errors (or deviation). The help module may provide information to explain the current module of the workflow. The help module may play back a recorded message or video to illustrate a way to interact with the current module of the workflow.

The method processor may record the deviation and generate statistics to assess the progress of the trainee. The mobile device of a trainee may transmit information to a system of a trainer, such as the alert of deviation, a portion of the log data generated at the mobile device in executing the workflow, and/or statistics about the progress of the trainee. Thus, the trainer may monitor the progress of multiple trainees and provide help to those who need help based on the deviation in their execution from the reference execution.

For example, the system of the trainer may display the locations of deviation in the workflow by different trainees, the different values generated in the different executions of the trainees, time durations spent by a trainee on modules that cause deviations, and others. The difficult to use modules may be identified for modification and/or for the generation of improved training instructions.

The information related to the trainee may be provided to the trainer in a real time, or in a batch mode. The help system may provide the guide and/or instructions with or without input for the trainer. For example, the help system may include the prerecorded narrative for different user interface modules. When the deviation is detected, the help system locates the relevant information for presentation to the user.

The help system may also be invoked during the execution of the workflow (e.g., through pressing a help button on the mobile device). When in the help system, the user may be offered a training session (e.g., running in a separate thread to isolate the data from the current execution of the workflow) to run a portion of the workflow in a training mode (e.g., guided by a pre-recorded stream of log data). After the user becomes familiar with the portion of the workflow, the user may end the training session and resume the original workflow.

The training module may be specific to a particular workflow application. When a new workflow application is provided to the mobile device of a user, the training module may also be provided (e.g., as a help file for the application to a generic help workflow application, or as a configuration file for the particular workflow application, or as a custom help workflow application). When the user views the list of pending applications to be executed, the mobile device may alert the user about the new workflow application and offer a training session for the user. The workflow may playback the pre-recorded execution of the workflow application (e.g., according to the log data of the workflow application). The user may run the workflow in a training mode; and the method process guides execution in the training mode based on the pre-recorded execution.

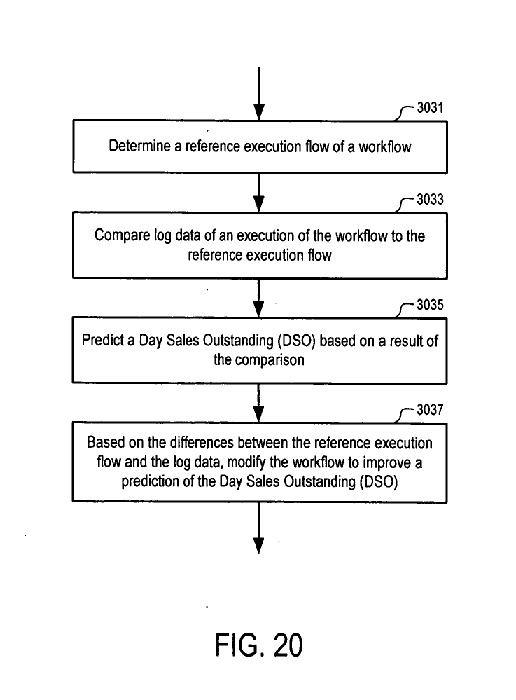

FIG. 20 shows a flow diagram of a process to perform prediction and optimization based on monitoring an execution of a workflow. In FIG. 20, after a reference execution flow of a workflow is determined (3031), the log data of an execution of the workflow is compared (3033) to the reference execution flow. A Day Sales Outstanding (DSO) is predicted (3035) based on a result of the comparison. Based on the differences between the reference execution flow and the log data, the workflow can be modified (3037) to improve a prediction of the Day Sales Outstanding (DSO). For example, when an execution sequence is determined to be more efficient to reduce the prediction of the Day Sales Outstanding (DSO), the workflow may be modified to guide further execution toward the preferred execution path. For example, the business logic of the workflow may be modified to reduce the prediction of the Day Sales Outstanding (DSO).

The log data collecting capability and the flexibility to customize mobile applications according to embodiments of the present invention can be used in many different environments.

In one example, a mobile device can be used to monitor certain behavior of the user. For instance, a mobile device may be equipped with a RFID reader, which is capable to read the RFID attached to the end caps in a grocery store. The mobile device may read the RFID as part of the log data while the mobile device is working based on a workflow near an end cap. Based on the log data, the mobile device can determine and/or monitor for how long the mobile operator stands near the end cap and servicing the end cap.

In another example, a mobile device may be operated near or in a refrigerated room at a grocery store. The refrigerated room can have a temperature sensor, which may report the current temperature, or a recorded history of temperatures for a period of time, to the mobile device (e.g., through a wireless communication connection, such as Bluetooth). The mobile device may take the data as part of the log data which can be used in further analysis. Thus, when the mobile operator enters the room, the mobile device may communicate with a device that tracks the temperature of the refrigerated room. The temperature data is downloaded to the mobile device and then either analyzed or passed on to the ERP system. Alternatively, or in combination, the mobile device may have a temperature sensor, which is used to get the temperature of the room while the mobile operator is in the room.

In a further example, the software architecture according to embodiments of the present invention allows a vendor (for example the store owner, such as Safeway) to design screens for the truck driver who delivers to Safeway. In this way the truck driver can present the mobile device to the Safeway manager or the Safeway personnel and have the Safeway personnel carryout Safeway functions (designed to the Safeway user interface and the Safeway specification) while the truck driver is at Safeway. The architecture allows Safeway to remotely and uniformly, quite easily change the experience that's going to happen in each Safeway store by changing screens or process sequences. In this way Safeway has control of the programs that are being carried out on-site by third-party truck drivers. It should be noted that not only can the vendor (e.g., Safeway) change the screen images that are presented to the operator (for the operators use or for use by the Safeway personnel) but that the bender can also change the tasks that are given on-the-fly to the mobile operator. This presents a new method of doing business in providing a service that allows the vendor to custom design the processes and the user experience that happens for delivery people or other service people coming to their sites.

Data Integration and Integrity

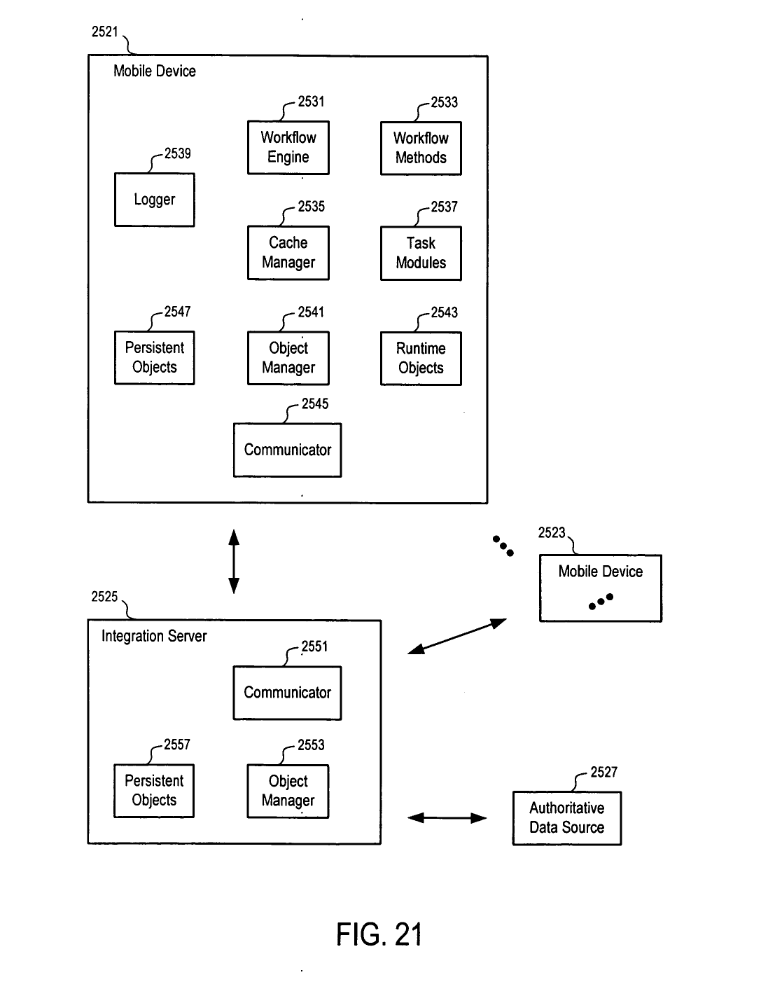

FIG. 21 shows a diagram of a data management system for the management of detached objects. In FIG. 21, data may be managed as detached objects on various systems, such as the authoritative data source (2527), the integration server (2525) and mobile devices (e.g., 2521 and 2523).

In FIG. 21, a mobile device (2521) may include a workflow engine (2531) and a cache manager (2535) for the efficient execution of workflow methods (2533), which define the execution flow between task modules (2537) and/or workflow modules (e.g., as sub-workflows, such as some of workflow methods 2533). The flow among the modules and how the data are provided to and extracted from the modules are specified in the workflow methods (2533). The workflow methods (2533) are interpreted by the workflow engine (2531) to load the task modules (2537) for execution and to connect the data flow among the task modules. The cache manager (2535) can manage the pre-loading and caching of task modules to improve the responsiveness of the workflow-based applications.

The mobile device (2521) may include the logger (2539) to automatically collect information in response to the execution events in the workflow engine (2531) and/or other events (e.g., based on the input from sensors, network connection, etc.).

In FIG. 21, data can be checked out to an object manager from a source over a network. The object manager can maintain the data as a local object, detached from the source (e.g., when the network connection to the source becomes unavailable). The local, detached object may be further checked out from the object manager to other devices or systems. Thus, the object manager may have a source of the data and one or more drains for the data. The object manager may check out the data from the source, check back in changes to the source, receive updates from the source, update the drains, and check in changes made to the data from the drains.

The changes to the data object may be generated at various locations in the system. The locally managed, detached object may be changed locally. The object manager may receive changes to the detached object from other systems, such as the device that checks out a version of the object from the object manager (e.g., in terms of changes checked in) or a server that checks out a version of the object to the object manager (e.g., in terms of updates).

In FIG. 21, the co-existence of multiple versions of an detached object can be managed locally by the object manager (e.g., 2533 or 2541) such that conflicts can be detected and resolved over time and a consistent version of the data can be checked back into the source.

For example, in response to a data request from one or more of the mobile devices, the object manager (2553) of the integration server (2525) can check out data from the authoritative data source (2527). The object manager (2553) then check out the data from the integration sever to the requesting mobile devices. The integration server (2525) may maintain one or more versions of the objects (2557). Preferably, the objects (2557) are maintained on a non-volatile memory for data protection.

Changes to the objects may be made locally on the integration server (2525), and/or remotely on one or more mobile devices (e.g., 2521 or 2523). Thus, the object manager (2553) may maintain multiple versions of the objects checked out onto the integration server (2525). The communicator (2551) of the integration server (2525) and the communicators (e.g., 2545) of the mobile devices facilitate the data communication among the integration server (2545) and the mobile devices. The communicators package data for transmission. The communicator (2551) of the integration server may have the capability to access data in a variety of formats from the authoritative data source (2527).

Further, the communicators can handle the movement of the data and guarantees the delivery of data between devices. The communicators may provide advanced data routing based on available connection type, time of day, and type of data; on-the-fly compression; data prioritization; check-point restarting of failed data transfers; battery power saving technologies; extensible architecture; unattended operation; support for WLAN, WAN, LAN, and PAN network connections; etc.

The object manager (2553) of the integration server (2525) allows multiple mobile devices to submit changes to a data object concurrently. The integration server (2525) may concurrently received changes to a data object from the mobile devices, which may develop into different versions of the data object. Such an approach is advantageous over a traditional synchronization approach. When a traditional synchronization approach is used, a server synchronizes with the mobile devices one at a time; and while one mobile device is synchronizing with the server; other mobile devices are locked out for the synchronization access to the server; thus, other mobile devices have to wait while the synchronization between the server and one mobile device is in progress.

In FIG. 21, a mobile device (2521) may also include an object manager (2541), which manages the persistent objects (2547) on the mobile device (2521). The persistent objects (2547) may be checked out from the object manager (2553) of the integration server (2525) (or from other sources, such as another mobile device 2523). As a source, the mobile device (2521) may check out a version of the persistent object (2547) to another mobile device, or to a running application.

For example, some of the runtime objects (2543) may be initialized by the object manager (2541) according to the persistent objects (2547). The object manager (2541) may further manage template objects for the creation of new runtime objects. During the execution of an application on the mobile device, the runtime objects (2543) may be modified according to user interaction. To save the updated data, the object manager (2541) may determine the changes after comparing the runtime objects (2543) and the corresponding persistent objects (2547) and store the changes. Alternatively, the object manager (2541) may store the complete version of the updated object with the existing version(s) of the updated object. Prior versions of the object may be deleted when no longer needed. The prior version may be needed, if the prior version is still checked out to a drain, since the drain may submit back changes based on the prior version. The prior version may be needed, if changes since the prior version have not yet been submitted to the source.

For example, if the persistent objects (2547) on the mobile device (2521) are checked out from the integration server, the object manager (2541) of the mobile device (2521) can check in the changes to the object manager (2553) of the integration server (2525) via the communicators (2545 and 2551).

The object manager (2541) may store the persistent objects (2547) in a way independent from how the corresponding data are stored on the authoritative data source (2527) and/or how the corresponding data are stored on the integration server (2525). The object manager (2541) may store the persistent objects as rows in tables. For example, a database manager, such as Structured Query Language (SQL) database manager (e.g., SQLCE), can be used to manage the tables; and the object manager can access the persistent objects through the database manager. Alternatively, the persistent objects may be stored in a flat file, or in a directory of files.

In FIG. 21, the task modules access the persistent objects through the runtime objects. The runtime objects may provide member methods (e.g., get and set) to access the corresponding fields. The object manager (2541) bridges the runtime objects (2543) and the persistent objects (2547). For example, the object manager (2541) uses the persistent objects (2547) to initialize the corresponding runtime objects (2543); and the object manager (2541) compares the runtime objects (2543) and the persistent objects (2547) to determine changes made to the persistent objects (2547). The changes are stored and transmitted to the integration server when a communication connection is available for the transmission of the changes. The changes may be accumulated for submission to the integration server.

The changes to the prior version of the object may be stored separately from the prior version of the object such that multiple versions of the object are accessible on the mobile device. If the mobile application crashes after the changes are saved locally and before the changes are transmitted to the server, the changes can be used to re-initialize the runtime objects.

After the successful transmission of the changes to the integration server, the data storage used for the object may be reduced, if the prior version of the persistent objects (2547) is no longer checked out from the object manager (2541) (e.g., from the object manager to a running application or to other data object managers). For example, the changes can be applied to the prior version of the persistent object to generate the current version of the object; after the current version of the object is stored, the prior version and the change data can be deleted.

A simplified version of the object manager may also be implemented, which allows a persistent object to be checked out to only one running application. Such an arrangement can greatly simplify the object manager adapted for the mobile devices and may be adequate for a variety of applications.

An object manager may store information to indication which version of a data record is checked to who, such that when updates are available, the object manager may send the updates to the corresponding recipients. The updates may include changes checked in from one of the drains (e.g., an application running on the same mobile device, or an object manager running on a remote mobile device). The updates may include changes propagated from the source (e.g., changes determined to reconcile different versions of the record).

An object manager may store multiple versions of a data record based on one complete version of the data record. Subsequent versions of the data record can be stored as changes made to prior versions of the data record, since it is not necessary to store the unchanged fields. It can be more efficient to transmit or store the changes, instead of the entire record, especially when the changes are sporadic.

Alternatively, an object manager may store multiple complete versions of the data record. Changes can be determined from comparing complete versions of the data record. Based on the size of data to be transmitted, the object manager may determine whether to transmit the change or the entire version of the data record.

An object manager may store a reference count to indicate the number of checkouts of a version of a data record to different entities. The reference count increases by one when this version of the data record is checked out to an entity. The reference count decreases by one when a change based on the version is checked back in from an entity (or when the checkout to an entity times out). When one version of the data record is no longer referenced (e.g., when the reference count decreases to zero), this version of the data record may be deleted.

On a mobile device a persistent object is typically checked in from an integration server and checked out to a running application on the same mobile device. In general, a persistent object may also be checked out to the mobile device from another mobile device, or from the mobile device to another mobile device, via peer to peer communication. A persistent object may also be checked out to multiple running applications on the same mobile device. Alternatively, multiple running applications may share the same run time object.

On an integration server a persistent object is typically checked in from an authoritative source and checked out to one or more mobile devices.

The object managers may be used to perform Predictive Data Sourcing (PDS), in which data that a mobile application will need is predicted based on a configurable time/data window. Before or during the execution of a workflow application, data can be pre-fetched. The predictive data source allows the smooth running of a mobile application even if the mobile device goes in and out of wireless communication coverage areas. Based on a configurable set of rules the mobile device can predicatively source the data for the mobile application, ensuring that the data is present on the device at the time the workflow is engaged.

Since mobile phones have limited data storage capacity, the data is stored locally while it is in the “context” (e.g., to be needed during the configurable window). When the data is no longer needed in the “context”, it may be purged to make space for other data that will be used in near future.

For example, the cache manager (2535) may identify the data that is needed in the current “context”; and the object manager (2541) then pre-fetches the persistent objects (2547). When some of the persistent objects (2547) are no-longer needed according to the current “context”, these objects can be deleted from the mobile device.

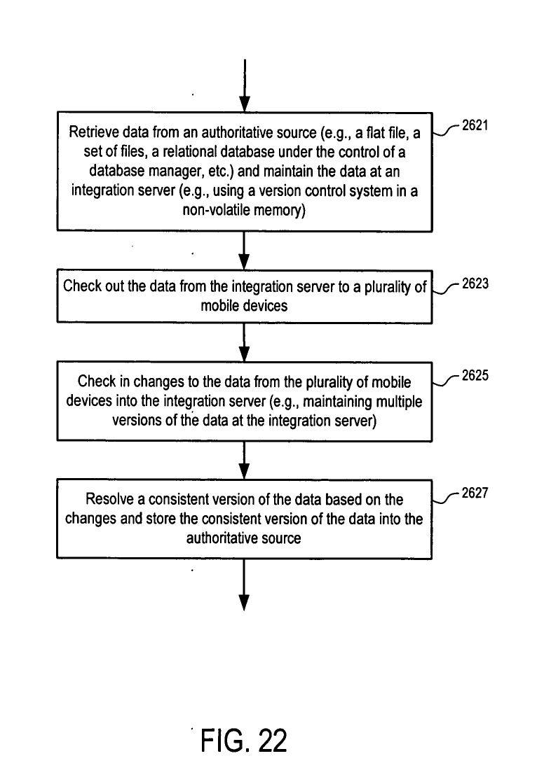

FIG. 22 shows a process at an integration server to provide data connection between mobile devices and an authoritative data source. In FIG. 22, data can be retrieved (2621) from an authoritative source (e.g., 107 or 2527) and maintained at an integration server (e.g., 105 or 2525). The authoritative source may be a flat file, a set of files, or a relational database under the control of a database manager on a server. The integration server may use a version control system and maintain the data in a non-volatile memory. If the integration server is crashed or shutdown for some reasons, the data maintained by the integration server is not lost.

The data can be checked out (2623) from the integration server to a plurality of mobile devices. Changes to the data are checked in (2625) from the plurality of mobile devices into the integration server.

The same data can be checked out to multiple mobile devices without being locked. Changes to the same data can be checked in from multiple mobile devices without being locked. Multiple versions of the data can be maintained at the integration server. Thus, the plurality of mobile devices may concurrently work on the same version or different versions of the same data record (e.g., to modify the data). When there are conflicts between changes to the data checked in from the plurality of mobile devices, the conflicts can be resolved over time.

A consistent version of the data can be resolved (2627) eventually based on the changes and stored into the authoritative source.

The integration server may communicate with one of the mobile devices to resolve the conflict. For example, the integration server may present the conflict to a mobile device and ask a user to select the desired changes. The integration server may present a consistent version to at least one of the mobile devices which provided the changes that caused the conflict and then accept a consistent version if one or more of the mobile devices confirm the consistent version. The integration server may selectively (e.g., based on availability of the mobile devices) determine a mobile device to resolve the conflict; and the selected mobile device may or may not the mobile device which provided the changes that caused the conflict.

Alternatively, the integration server may resolve some conflicts without requesting further inputs for the mobile devices (e.g., when no appropriate mobile device can be connected to for resolving the conflict). For example, the integration server may use the change received later in time to overwrite the change received earlier; or the integration server may resolve the conflict based an reliability indicator associated with the mobile devices.

When a traditional synchronization approach is used, the conflict is to be resolved at the time of synchronization between a server and a mobile devices. During the synchronization period, other mobile devices are locked out for synchronization with the server. Thus, the use of the synchronization approach significantly limits the options for conflict detection and resolution.

When the object manager according to embodiments of the invention is used, a flexible system can be implemented for conflict detection and resolution.

The integration server may maintain a record to show which data is checked out to which mobile devices. When all of the mobile devices that checked out the data either have checked in again or have reach the timeout period for checking out the data, the integration server can store a consistent version back to the authoritative data source,

Alternatively, the integration server may check the conflict as the changes are submitted. Non-conflicting changes are applied at the integration server in response to check in operations. When a conflict is detected, multiple versions of the data are generated and maintained on the integration server. Further changes to conflicting versions are maintained on the integration server, until the different versions converge into a consistent version, which is then committed into the integration server. Thus, when there are conflicts, the mobile devices can continue to work with different versions of the data without being locked or forced to resolve the conflicts immediately. The integration server may be configured to allow a degree of conflict tolerance (e.g., over a predetermined period of time).

Although some of the embodiments are described in the context of mobile applications, it is understood that such a data check in/check out system can also be applied to a non-mobile application. For example, the data can be checked out to wire-connected computers or workstations from the integration server.

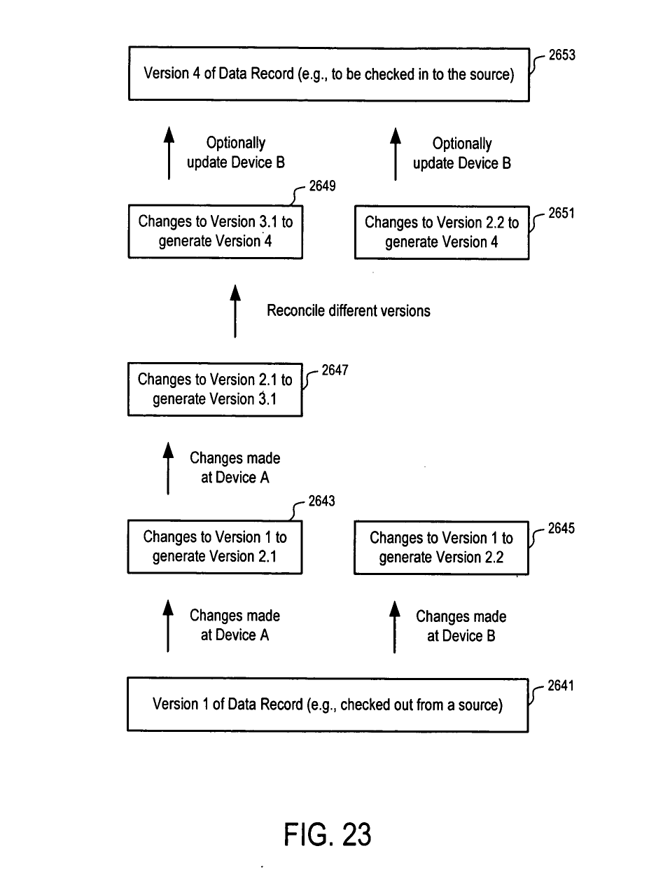

FIG. 23 illustrates a process to manage changes to a data record. A version of the data record (2641) that is checked out from a source is under the control of an object manager. For a period of time, the data recorded may be detached from the source. The object manager may further give out the data recorded to different entities for concurrent modification. For example, device A and device B may make changes based on the version 1 of the data recorded that is under the control of the object manager. The changes (2643 and 2645) can be checked in to the object manager concurrently. The object manager allows the concurrent submission of changes from the devices, since the object manager does not have to perform synchronization with the devices one at a time. Instead of blocking the submission of changes from some of devices, the object manager can concurrently receive changes to the same data record from different devices. For example, both changes (2643 and 2645) can be received and stored by the object manager to generate multiple versions of the data record.

The object manager may store information to indicate that version 1 of the data record (2641) is checked out to devices A and B. After devices A and B check in the changes (2643 and 2645), the object manager may update the stored information to indicate that version 1 of the data record is no longer checked out to devices A and B.

The devices may indicate whether the new versions of the data record as being changed on the corresponding devices are still being used on the device (e.g., at the time of submitting the changes). The object manager can then store information to indicate whether the updated versions are checked out to the devices. For example, if the devices A and B are still working on the data record, the object manager may update the stored information to indicate that version 2.1 of the data record is checked out to device A and the version 2.2 of the data record is checked out to device B.

In FIG. 23, the device A may make further changes based on the updated version 2.1 of the data record and provide changes (2647) for the generation of version 3.1 of the data record.

At a suitable time, the object manager may start to reconcile different versions of the data records. The object manager may detect conflicts in the changes and consolidate the changes. For example, the operation to reconcile different versions of the data record may be postponed to a time when the system is idle or in a low workload state, or when there is no submission from the devices for the data record, or when the devices have finished working on the data records, or at the end of the submission of changes to the data record from one or more devices. A set of rules may be used to configure the object manager and determine when to reconcile different versions of the data record.

The object manager may reconcile the versions in one of many different ways. For example, the object manager may automatically determine a reconciled version and provide the changes from the prior versions to the reconciled version to corresponding mobile devices as updates (or for confirmation). For example, the object manager may detect and resolve conflicts and generate a reconciled version when there is no conflict. For example, the object manager may detect conflicts; when there is a conflict, the object manager may determine a change to one or more of the existing versions to resolve the conflict; when there is no conflict, the object manager merges the changes to generate a reconciled version.

Conflicting changes may be defined by a set of configurable rules. Further, based on a set of configurable rules, the object manager may resolve some of the conflicts automatically without human intervention, resolve some of the conflicts via a request to a mobile device (such as the last or first device that submits the changes, a device currently working on the data record, etc.), and resolve some of the conflicts via a request to an administrator. A workflow may be defined for the object manager to resolve the conflict.

For example, in FIG. 23, the object manager may determine a reconciled version (2653) from the existing versions (e.g., 3.1 and 2.2) and the changes (e.g., 2649 and 2651) made to update corresponding versions to the reconciled version (e.g., 2653). Optionally, the object manager may send the changes (2649 and 2651) to update the corresponding mobile devices.

The changes may include the before and after state of the changed field. Thus, the object manager can derive the corresponding versions (e.g., 3.1 and 2.2) from the changes (2649 and 2651) and the reconciled version (2653). Since version 1 (2541) can be derived from a chain of changes from the reconciled version (2653), version 1 (2541) can be deleted after the reconciled version (2653) is stored. Some of the changes may no longer be needed and thus can also be deleted.

The object manager may determine whether there is a conflict in versions of the data record generated by different devices. When there is no conflict, the object manager may not update the corresponding devices, if updates are not requested. When there is a conflict, the object manager may update the corresponding devices as a way to resolve the conflict. The object manager may request the corresponding devices to confirm the acceptance of the updates. The object manager may further indicate the change that is made the resolve the conflict so that the user may determine whether the reconciled version proposed by the object manager is correct. For example, the object manager may send a workflow (or an update to the workflow that is running on the mobile device) to alert the mobile user about the changes and conflicts; and the user may make further changes to the reconciled version, if needed.

When there is no pending decision on conflict resolution, the reconciled version can be checked back into the source. In this case, if the devices A and B are no longer interested in the data record, the object manager may not attempt to update the devices A and B to the consistent version; otherwise, the object manager can send silent updates to the devices to cause the devices to silently update their copies without having to alert the mobile users.

A device may indicate the level of interest in the data record to the object manager. For example, the device may indicate that the data record is no longer checked out to the device; when is data record is needed subsequently, the device may need to retrieve the entire a data record from the data manager. Alternatively, the device may indicate that the data record is maintained for future use; thus, when an updated version is available, the object manager may send the changes to update the version of the data record on the device. Alternatively, the device may indicate that the data record is actively being used in a workflow application; thus, when a new change is available, the change may be forwarded to the device for consideration. For example, when device A is actively working on the data record, the changes made by device B can be forwarded to device A so that the user of device A may consolidate the changes and resolve any potential conflicts. Thus, the object manager may selectively update the device based on the status of the data record on the device.

When there is a conflict, a reconciled version may not include all the changes submitted. For example, when both device A and device B change the same field of the data record, the reconciled version of this field may contain the value submitted from device A or the value submitted from device B, but not both. Thus, one of the changes submitted from the devices is modified. The object manager may submit the modification to at least one of the devices for confirmation, if any of the devices is actively working on the data record. If the devices A and B are no longer interested in the data record, the object manager may not attempt to update the devices A and B to the generated consistent version; otherwise, the object manager can send updates to the devices with a request to solve the conflict.

Thus, different versions of the data record are reconciled over time. Conflicts may be resolved on the integration server, on device A or device B or another device, or on another server. It is not necessary to lock the data record for the synchronization between the server and one of the devices.

Conflict may be resolved automatically, or manually. The object manager may select a path to solve the conflict based on the current situation and a set of policy. For example, the object manager may merge the changes into one temporary version; and send the changes to update the mobile devices to the temporary version so that the mobile devices may resolve the conflicts by submitting further changes to the temporary version. The object manager may automatically resolve a conflict according to a latest change rule, or a first change rule, or a confidence level rule. When a latest change rule is used, the change that is committed latest in time supersedes other conflicting changes. When a first change rule is used, the change that is committed first in time supersedes other conflicting changes. When a confidence level rule is used, the object manager determines a confidence level indicator of the changes; and the change that has the highest confidence level supersedes other conflicting changes. The confidence level indicator may be based on statistical data indicating the error rate of the mobile users, the work experience level of the mobile users, etc. The object manager may automatically determine a temporary version for confirmation by the mobile users, or an administrator. The object manager may determine if any of the mobile device is still actively using the data record. When one of the mobile device is still actively using the data record, the object manager may send the modifications to the mobile device for confirmation and for further changes. When no mobile device is actively using the data record, the object manager may select a mobile device for conflict resolution (e.g., based on a predestinated status of the mobile device, based on the user of the mobile devices, etc.), or send the conflict resolution request to an administrator.

A conflict may be defined in many ways. For example, a set of related data records may be grouped for consistency. Changes to the set by different entities may be considered as conflicting changes. Alternatively, changes to the same data record by different entities may be considered as conflicting changes. Alternatively, only changes to the same data field is considered as conflicting changes. The system may be configured to receive a set of rules that define the conflicting situations. Different sets of data records may have different rules for conflicting detection and confliction resolution.

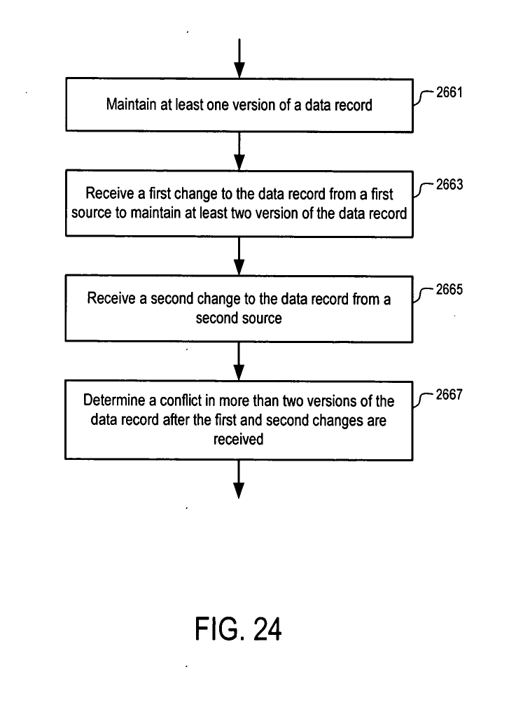

FIG. 24 shows a flow diagram to maintain versions of a data record. In FIG. 24, at least one version of a data record is maintained (2661) by an object manager. A first change to the data record is received (2663) from a first source to maintain at least two version of the data record by the object manager. A second change to the data record is received (2665) from a second source. After the first and second changes are received, a conflict is determined (2667) in more than two versions of the data record after the first and second changes are received. Since the conflict detection and resolution are postponed, it is not necessary to synchronize a server with the mobile devices one at a time. The changes can propagate quickly in the system. Conflicts are tolerated and resolved eventually. The tolerance of conflicts allows the flexibility to detect and resolve conflicts in a variety of ways.

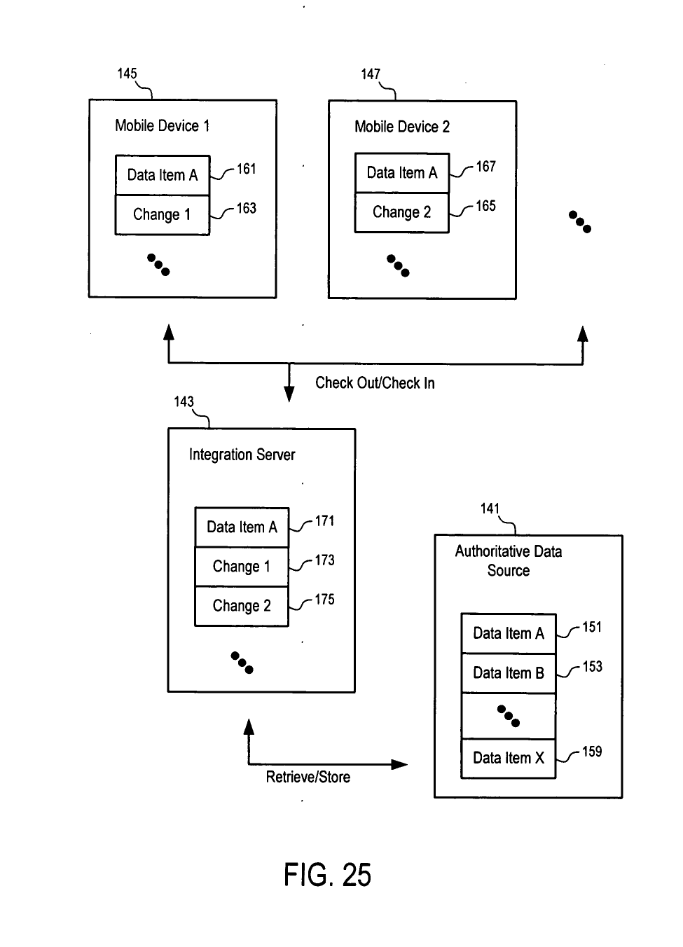

FIG. 25 shows a data connection system. In FIG. 12, an authoritative data source (141) maintains data items (e.g., 151, 153, . . . , 159). The data items (e.g., 151, 153, . . . , 159) may be maintained in a same way, such as in a relation database controlled by a single database manager, in one single flat file, in a file system, or in a custom designed database product. Alternatively, the data items (e.g., 151, 153, . . . , 159) may be maintained in a number of different ways. For example, some of the data items may be in a relation database controlled by a single database manager, some of the data items in a flat file, some of the data items in a file system, and some of the data items in a custom designed database product. These different data sources can be collectively viewed as an authoritative data source; and the integration server (143) has the capability to communicate with each of the individual data sources to retrieve, store, insert data items according the their corresponding interfaces and/or communication protocols.

When the data items are requested by the mobile devices, the integration server (143) is used to provide the mobile devices with access to the authoritative data source. The integration server (143) has a common interface for the mobile devices to access data, such that the implementation details of the authoritative data source (141) is shielded from the mobile applications. The intelligence to access a variety of different data sources can be implement in the integration server (143) such that the mobile devices can have a unified way to access any data via the integration server (143).

When a data item (151) is requested by a mobile device (145 or 147, or others), the integration server (171) retrieves the data from the authoritative source (141), if the data is not already cached on the integration server (171). The integration server (143) stores the data item (171) in a non-volatile memory to prevent data loss in case the integration server (143) is shutdown unexpectedly. The data item stored on the integration server is under the control of an object manager, which manages the changes and versions of the data items.

The integration server (143) then further checks out the data to different mobile devices (145 and 147) so that the mobile devices may work on the data concurrently (e.g., to make changes). The data checked out to the mobile devices (145 and 147) are also cached on the non-volatile memory of the mobile devices (e.g., as data item 161 in mobile device 145 and data item 167 in mobile device 147). After the changes (e.g., 163 and 165) to the checked out data (e.g., 161 and 167) are developed, the mobile devices may check in the changes to the integration server (143) at concurrently (or at different time instances).

For example, the change (163) from the mobile device (145) may be checked in as the change (173) to the data item (171); and the change (165) from the mobile device (147) may be checked in as the change (175) to the data item (171) received after the change (173).

A mobile device provides the integration server (143) with information on how the data item is changed. For example, a field of the data item may be changed from one value to another. The mobile device determined the difference; and only the difference is sent from the mobile device, so that the transmission of the unchanged data portions can be avoided.

For example, the data change information submitted from the mobile device includes an indication of the previous state and the current state of a changed field. The integration server (143) can then determine whether the previous state as specified in the data change information matches the latest version of the data item as modified by already received data change. If there is a match, it can be determined that the data field has not been changed by the previous received data changes; otherwise, the data field has been changed previously, which indicates a conflict between different changes.

Further, based on the values of the previous state, the integration server may select a non-conflicting version of the data item. Thus, the integration server (143) may reorder the changes to reduce the number of conflicts.

Alternatively, the data change information may not include the actual data for the previous state, but include a version indicator which can be used by the integration server to determine the previous state.

When there is no conflict in received data changes, the integration server (171) may concatenate the changes.

When a further mobile device requests the data item, the integration checks out the version of the data as modified by the recent changes. When there are conflicting changes, the integrations server may check out the most recent non-conflicting version to the requesting mobile device, or one of the latest conflicting versions.

When there are conflicts, the integration server can maintain different versions of the data, until the conflicts are resolve and the branches converge back into one consistent version, which is then stored back into the authoritative data source.

Thus, when concurrent changes result in conflicts, the integration server generates cached branches of the data items, which is maintained until the branches converge. Thus, conflicts can be handled gracefully.

The data used by the mobile devices can be grouped together into units to facilitate the detection of conflicts and to improve communication efficiency. For example, the data that are of the “part-of” relation to an object can be grouped so that changes to the group are transmitted from the mobile device to the integration server in a unit. The communication lay of the system is designed to ensure that the transmission of such data is either completely successful or fail. Thus, the change information from a mobile device is either applied to bring the data into a consistent state, or not applied. Even when the changes from different mobiles are conflicting with each other, each of the changes from the different mobiles still puts the data into a different consistent state. Thus, consistency is maintained.

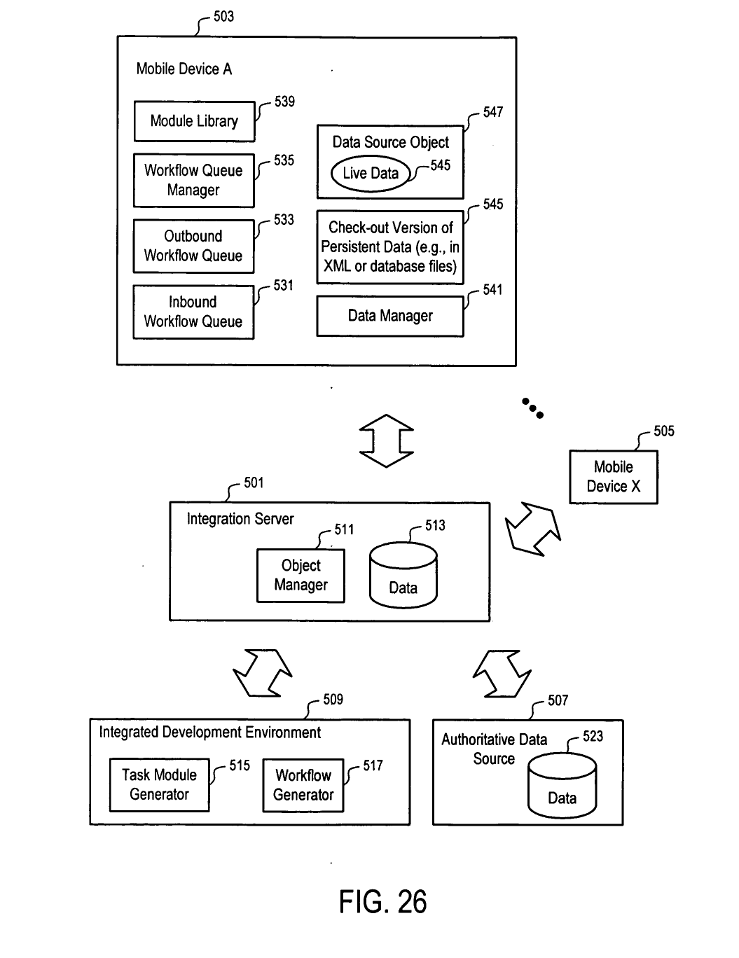

FIG. 26 illustrates a combined data and execution model. In FIG. 26, the integration server (501) is used to provide a communication integration point between mobile devices (e.g., 503, 505, . . . ) and an authoritative environment, which may include the authoritative data source (507), integration development environment (509) (e.g., of a dispatch system, a control center, etc.).

The authoritative data source (507) may include one or more different types of data sources, such as flat files, file system, relational database tables under control of a database manager server, etc. The data of the authoritative data source (507) is collectively represented as data (523). The integration server allows the mobile devices to use a uniformed way to access data (523), which may be in a variety of different formats.

The integrated development environment (509) can be used to develop new applications for execution on the mobile devices (e.g., 503, 505, . . . ). Applications developed in the integrated development environment (509) are in the form of workflow methods using the workflow generator (517) and task modules using task module generator (515). A workflow method typically includes specifications of flow directions among modules in a document (e.g., in XML), which can be easily modified to accommodate different needs. An example of a workflow method is illustrated in FIG. 4.

In one embodiment, the modules can be selected from a set of library modules, which are typically developed for common tasks, such as a Graphical User Interface (GUI) Form, a database access call, a messaging call, a print routine, etc. A module is typically designed to be independent of the application environment in which the module may run. Thus, the module can be used in different workflows for different applications. A module typically has no specific knowledge of the application as a whole and/or other modules which may or may not exists in a particular application in which the method module is used. A module communicates with other modules and the application as a whole through the input/out variables and/or other communication channels (e.g., database access, etc.).

Task modules are typically developed using an object oriented programming language, such as Java or C#. For example, a module can be programmed as an individual class, which can be extended through class inheritance. The integration development environment (509) can be used to provide a class template for the development of custom modules.

For example, the integrated development environment (509) may include a composer implemented as a plug-in to existing integrated development environment (IDE), such as Visual Studio and/or Eclipse, for the design, develop, and/or deploy of workflow modules and/or task modules. Such an integrated environment (509) may provide access to Microsoft Visual Studio (C#), user interface oriented towards the methodology of workflow/task, reusability and expandability, XML task orchestration, SQL (structured query language)/DAO (Data Access Object) code generation, access to Eclipse Studio (Java), etc.

Using the integrated development environment (509), mobile software applications can be built and deployed using a large number of non-integrated, software development, middleware, communications, screen scraper, screen painter, database, business process mapping, etc. Software tools may be from multiple vendors.

The integrated development environment (509) may use business process modeling paradigm based on an Universal Modeling Language (UML) (e.g., for integration with Microsoft Visual Studio). It may feature round-trip engineering from business process workflow diagrams to .NET or Java code and back. The business process can be represented as a workflow of connected tasks. Tasks in the workflow can be self contained code components. A workflow can be saved, re-used, or customized, using the integrated development environment. A workflow can be created, or modified, by visually dragging connectors between tasks.

The integrated development environment (509) can provide extensions and programming guidelines in support of the mobile task workflow. It allows for the use of objects, supported programming languages, auto-coding, and debugging tools that are available from software vendors, such as Microsoft or others. The user is guided through the creation of task oriented coding that enforces MVC architecture. Such a framework helps the developer to create clean, task driven applications without being locked in dependencies between individual tasks. When the integrated development environment (509) is used, the applications are easier to debug and maintain and having higher levels of code reuse through the “plug and play” task architecture.

The integrated development environment (509) may automatically generate data access code or the model interfaces and the XML required for moving from one task to another within the environment of a method processor. Outcomes and global variables in support of the workflow architecture are generated and encapsulated in supporting documents which are also used by the method processor.

The integrated development environment (509) can provide a unified view of the application to designers, developers, project manager and customers. While the customers and/or the project managers may have the access to the business process via the workflow, the designers and developers may have further access to the task modules at the source code level in additional to the business process level access. The designers and developers may provide the template for a general business process, which may be further customized by the customers and/or the project managers to include the best practices, which the customers may not want to reveal.

For example, during development the developer can view, in real-time, the method execution path, what tasks have access to what global variables, what tasks are reading and writing what global variables, how long each task or group of tasks take to run, advanced debug logging and more.

The quality assurance (QA) team may use the integrated development environment (509) to test overall application performance, observe what tasks were never executed for testing, observer what task branches were never executed, and provide the developer with an exact recorded session when an issue is found.

The back office personal may use the integrated development environment (509) to obtain an unprecedented view into the mobile business process—view orders in real-time as they happen, identify weakness in application usability, identify what users may need additional training based on performance feedback compared to the average, identify the problem customers, identify the exceptional customers and how they differ from the norm, etc.

The integration server (501) has an object manager (511), which tracks versions of data (513) for resolving conflicts and for providing the mobile devices with data access without blocking data access requests.

Traditionally, when a network resource is needed in an application running on a node, it is typically assumed that the network resource will be available when needed; and the application is typically designed to wait for the network resource become available, while maintaining the application in a running state. The application is maintained in the memory such that as soon as the network resource need is satisfied, the application continues to run.

One embodiment of the present invention recognizes that the application does not have to wait. For example, a workflow approach can be used to package the remaining part of the application as a new workflow method, which can be queued for transmission and execution at a suitable time. Further, the data needed for the execution of the application can be sourced based on the prediction of the need and provided with the workflow application.

For example, when a resource required for the execution of an application is not available, a new workflow method can be generated based on the current state of the application. The new workflow method may present the remaining part of the application as an independent new application, such that it is not necessary to maintain the current application in a running state. The current application is completed and moved out of the memory. The new application that is equivalent to the remaining portion of the current application can be queue for execution when the resource becomes available.

For example, when the network resource is needed but cannot be satisfied immediately, the current application is converted into a new application in the form of a new workflow method, which is queued for transmission and for execution. Once the new application is queued, the current application is completed; and the workflow engine does not have to maintain the state of the current application that is completed. Thus, the workflow engine can free up resources used by the applications that are blocked by the network resource needs and devote the resources to speed up other applications. This also provides a greatly simplified way to manage applications, which may have unsatisfied needs for network resources.

For example, the mobile device may package the new workflow application for execution at a later time when the network resource is available. For example, the availability change in the network resource may cause the execution of the new workflow application.

For example, the mobile device may package the new workflow application for execution on a remote device. The new workflow application may be queued and transmitted to the remote device (or server) for execution. For example, the new workflow application may cause the remote device (or server) to obtain data and/or process the data and transmit a further workflow application back to the mobile device to finish the remaining part of the operations.

For example, the mobile device may package the new workflow application for transmission to a nearby mobile device, so that the remaining operations is delegated to that mobile device.

For example, when the data manager (541) of the mobile device (503) need to check out data from the object manager (511) of the integration server (501), or check in changes to the data to the object manager (511) of the integration server (501), the data mobile device (503) may wrap the request in a dynamically generated workflow method that is queued in the outbound workflow queue (533) for delivery to the integration server (501). The queued workflow method can be delivery to the integration server over a sometime connected network, even if no direct, real time communication connection is available. Similarly, the integration server may provide work orders, data checkouts, data updates, conflict resolution requests, etc., to the mobile device (503) as workflow methods, which when delivered at the mobile device are queued in the inbound workflow queue (531).

The mobile device (503) has a data manager (541) which manages the check-out version of data (545) (e.g., stored in an XML file, or a SQL database such as SQLCE, or in other types of data storage formats). The check-out version of data (545) can be stored in a non-volatile memory. A data source object (547) may be used to manage the live data (545), which is used by the modules of a workflow application. For example, the data manager (541) can populate the data source object (547) use the check-out version of the data (545) to generate the live version of the data (545), which may be modified by according to user input during the execution of a task module. The task module can access the live data (545) using an object oriented approached.

In one embodiment, the mobile device (503) further includes a manifest manager (537) which couples with the data manager (541) to fetch data across a network connection and to upload data changes to the integration server (501).

The mobile device (503) typically includes a module library (539) which may include task modules and workflow modules. Commonly used modules are typically pre-loaded; and other modules may be downloaded on-demand. A workflow typically identifies the modules used, as well as the locations from which the modules can be downloaded if the modules are not already on the mobile device. Further, the mobile devices may use the location information to check for updates to the modules.

The mobile device (535) further includes a workflow queue manager (535), which manages the inbound method queue (531) and outbound method queue (533). For example, when the mobile device (503) encounters unsatisfied needs for network resources (e.g., services and/or data), the mobile device can convert the current application into a new application for execution by the remote node that provides the network resources. The new application is generated in the form of a workflow method (e.g., in an XML format) which includes the data and workflow to complete the remaining part of the current application. The workflow queue manager (535) places the new application in the outbound method queue (533) for delivery to the remote node for execution. For example, the workflow queue manager (535) can use an email system, or a message delivering system similar to an email system, to queue and transmit the new application. The new application may include instructions for the remote node to performed the task related to the unsatisfied needs and then send back another application that is to be queued in the inbound workflow queue for the remaining part of the operations.

For example, a workflow application may need to submit changes to the check-out version of the data to the integration server (501). The mobile device (503) may dynamically generate a “submit-this-change” workflow application for the integration, including the changes to be submitted. Once the “submit-this-change” workflow application is queued for transmission to the integration server, the current workflow application is no longer blocked for waiting to submit the changes. The workflow application may run to an end and exit. After the integration server executes the “submit-this-change” workflow application, the integration server may detect a conflict. The integration server may then dynamically generate a “resolve-this-conflict” workflow application for delivery to the inbound workflow queue.

Further, the mobile device may include information about the original workflow application in the “submit-this-change” workflow application. Thus, the integration server may include the proper workflow, generated based on the original workflow application, to resolve the conflict.

When a new application arrives in the inbound method queue (531) of the mobile device, the workflow queue manager (535) can be used to manage which application is to be executed (e.g., in a workflow engine). For example, the workflow queue manager (535) may prompt the user to select one of the applications queued in the inbound method queue (531) for execution.

Certain applications can have a sufficiently high priority such that the workflow queue manager (535) may automatically execute the application when the application arrives in the inbound method queue (531). The workflow queue manager (535) may format the current unfinished application into a new application and queue the new application into the inbound method queue (531), when the current application is to be interrupted for execution of another application (e.g., to run a high priority application, to response to a request from the mobile user to postpone or interrupt the execution of the current application, etc.). The workflow queue manager (535) may generate a workflow module based on the currently unfinished application, such that an incoming reply application can run the workflow module for the remaining portion of the unfinished application.

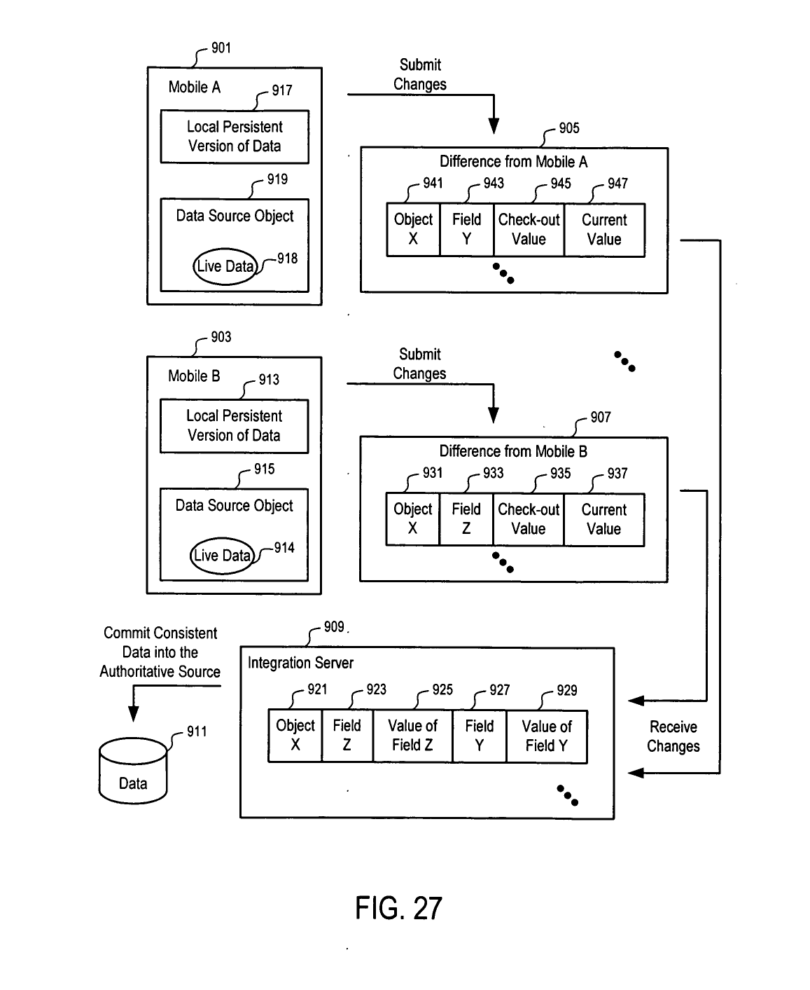

FIG. 27 illustrates a way to collect changes to data from mobile devices. In FIG. 27, the mobile devices (901 and 903) cache the check-out versions of data (917 and 913) (e.g., in XML). The data is checked out from the authoritative source (911) through the integration server (909). The mobile devices (901 and 903) use the check-out versions of data (917 and 913) to load the data source objects (919 and 915). The live data (914 and 918) in the data source objects (919 and 915) may be changed according to user input to the mobile devices (901 and 903). The changes can be made concurrently.

To commit the changes to the integration server, the mobile devices compare the live data to the check-out version of the data. The mobile devices submit the differences to the integration server (909). The size of the difference is typically smaller than the size of the data. Thus, sending the difference can be an efficient way to transmit information to update the data.

For example, the difference (905) submitted from the mobile device (901) may include the identification of the object (941), the field (943), the check-out value (945) and the current value (947). Thus, the integration server can obtain the before and after states of the changes. Similarly, the difference (907) submitted from the mobile device (903) may include the identification of the object (931), the field (933), the check-out value (935) and the current value (937).

After the difference submitted from a mobile device is received, the changes for an object group (e.g., linked by “Part-Of” relations) can be applied in an atomic operation. Thus, each applied change for an object group brings the objects from one consistent state to another consistent state in an atomic operation (e.g., either successful applied or not applied). The integration server (909) determines whether the check-out value of the difference to be applied matches the value of corresponding field as cached on the integration server. For example, to apply the difference (905) submitted from the mobile device (901), the integration server (909) determines whether the check-out value (945) matches the cached value (929) on the integration server. If the check-out value (945) is the same as the cached value (929), it can be determined that the data field (927) has not yet been changed by other mobile devices. Thus, the current value (947) submitted in the difference (905) can be used to replace the corresponding value (929). Otherwise, there might be a conflict.

Similarly, the check-out value (935) submitted in the difference (907) from the mobile device (903) can be compared to the value (925) cached on the integration server (909) to determine whether there is a conflict in setting the field (923) to the current value (937).

The non-conflicting changes can be applied to the cached data on the integration server (909). When the changes are committed to the authoritative source (911), the cached data on the integration server (909) becomes the new check-out version of data from the authoritative source. When a conflict is detected, the integration server starts to resolve the conflict. For example, the integration server may generate a workflow method to send the conflicting data values back to the mobile device which submits the differences so that the mobile user may confirm or revise the data. The workflow method for resolving the conflict can be queued as a new application to be delivered to the mobile device.

The integration server may cache the differences so that various versions of the data can be computed from the stored complete version of the data and the changes. When there is a conflict to the latest version of the data, the integration can determine the latest non-conflicting version of the data. The difference can then be designated to be applied to the latest non-conflicting version of the data. Thus, the development of versions of data branches into different directions, resulting multiple conflicting latest versions. The integration server may allow the existence of such branches and may further generate workflow applications for the mobile devices to resolve the conflicts. After the branches converge into a single version and all mobile devices which checked out the data either checked in the changes or timed out, the integration server commits the final version of the data back into the authoritative source (911).

Alternatively, the integration server may determine the latest root version and commit the latest root version to the authoritative source (911). The latest root version may be the latest version that is the root of all current check-outs and all unresolved conflicting versions.

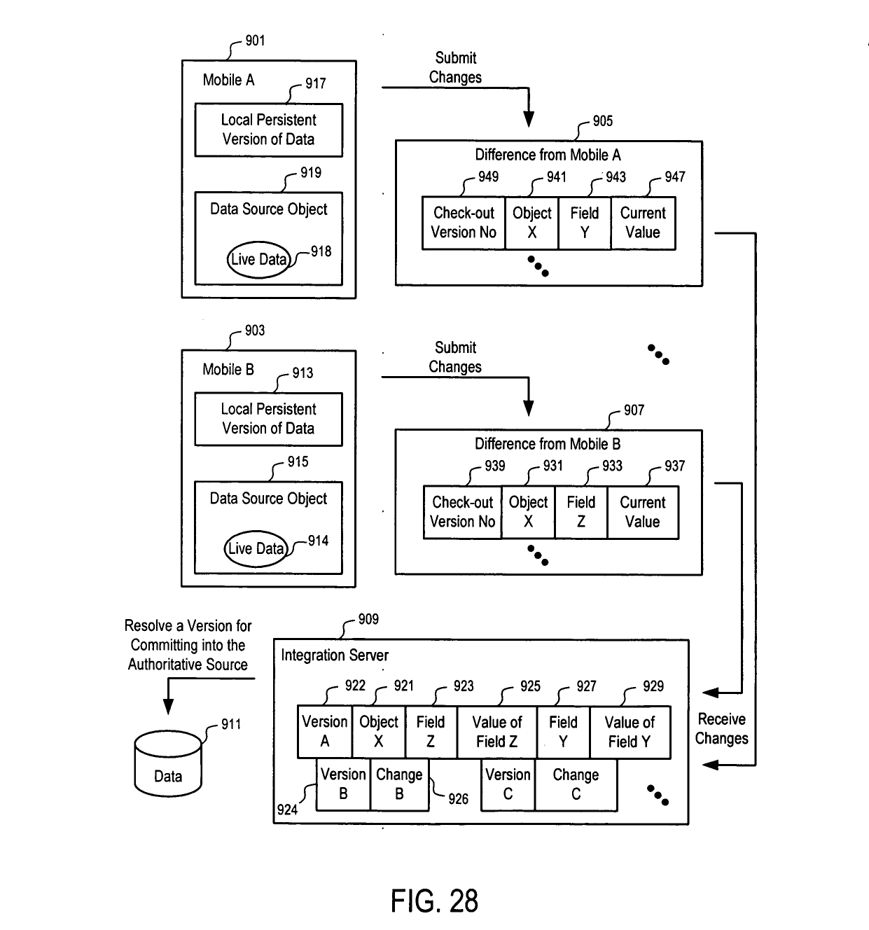

FIG. 28 illustrates another way to collect changes to data from mobile devices. In FIG. 28, an indication of a version of the check-out data, such as the version number of the check-out data is used to indicate the prior state (check-out value) of the corresponding data field. A check-out version number (e.g., 949 or 939) can be used to indicate the state of multiple data fields of an object (or an object group). Thus, the amount of data to be transmitted from the mobile device to the integration server can be reduced.

The base version (e.g., represented by the version number 922) may include values of the complete set of data fields. Non-conflicting changes may be concatenated. When a version has pending expected changes to be checked in, the changes are not concatenated onto that version, since the expected changes may start a branch at that version. For example, when the integration server expects changes to be checked in from one of the mobile devices (901 or 903) based on the version (922), other non-conflicting changes submitted based on the version (922) are concatenated into a different version (924) which contains the change (926) over the prior version (922). When there is a conflict, a different version based on the version (922) can be generated.

Alternatively, the integration server may store the values of the complete set of data fields for each of the versions. When a version is no longer needed, it can be eliminated. Thus, the integration server typically stores the versions that may start a branch and the latest version or latest conflicting versions.

When there are multiple versions on the integration server, a mobile device can check out any of the versions (or the latest version created in time, or the base version). The integration server may present the conflicts between multiple version in a workflow method as a new application (e.g., with high priority) for conflict resolution.

Since conflicts are resolved by the mobile users, the conflicts can be better resolved than simply following a rigid rule, such as the first change rule, or the last change rule.

In one embodiment of the present invention, the determination of the changes to data object is based on the identity of the object instances. Changes are made to objects of the same identity but not to objects of different identities.

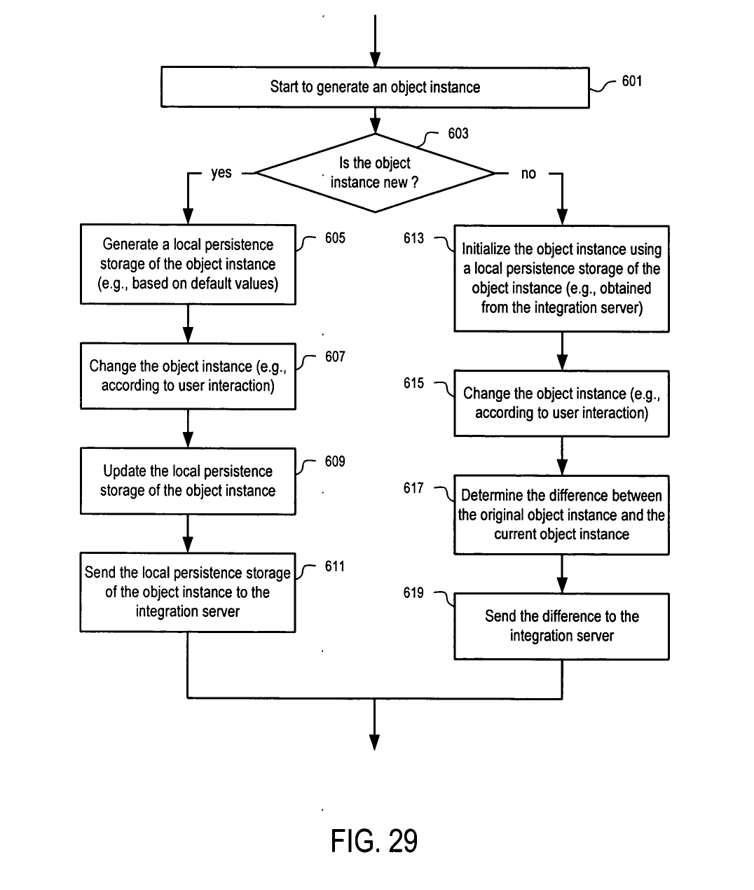

FIG. 29 shows a flow diagram of a process to upload data from the mobile device. In FIG. 29, after an operation (601) starts to generate an object instance, it is then determined (603) whether the object instance is new to the authoritative data source.

If the object instance is new to the authoritative data source, a local persistence storage of the object instance is generated (605) (e.g., based on default values). After the object instance is changed (607) (e.g., according to user interaction), the local persistence storage of the object instance is updated (609) accordingly. Thus, even if the application is crashed for some reasons, the object instance can be recovered from the persistence storage.

The local persistence storage of the object instance is sent (611) to the integration server for committing into the authoritative data source. For example, a method workflow can be generated to instruct the integration server to insert the new object instance into the authoritative data source; and the method workflow can be queued for transmission to the integration server for execution.

If the object instance is not new to the authoritative data source, the object instance is initialized (613) using a local persistence storage of the object instance (e.g., obtained from the integration server). After the object instance is changed (615) (e.g., according to user interaction), the difference between the original object instance and the current object instance is determined (617). The difference is sent (619) to the integration server for committing into the authoritative data source.

An object manager may be used to control the operations illustrated in FIG. 29. The object manager uses a unified way to communication with the integration server to access data based on the construction of the object (e.g., through reflection to determine what data is involved, or through metadata generated from the object model), such that the implementation details of the data sources at the authoritative data source is completed shielded from the mobile application.

Typically, object instances are in a hierarchical construction, in which an object may have one or more child objects and one or more parent objects. A parent object points to a child object. Thus, objects related to each other in the tree or network of connections.

In one embodiment of the present invention, objects are grouped into units for data consistency reasons and for data transmission.

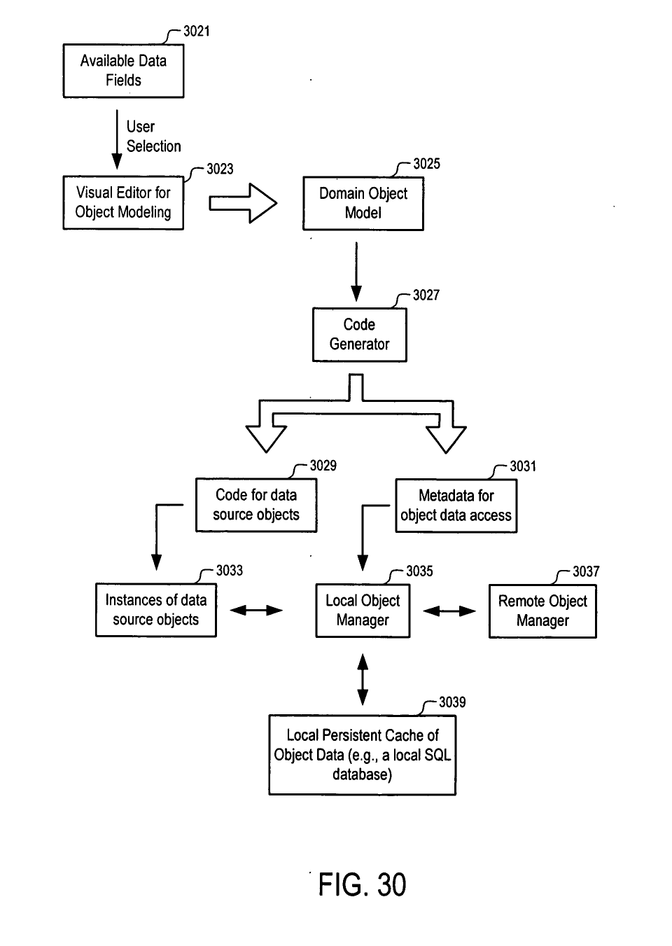

FIG. 30 illustrates an integrated development process for the access and management of detached objects. In FIG. 30, the available data fields (3021) are presented in an integrated development environment for selection. The data fields may include the data fields that are maintained on one or more data sources. The data sources may have different storage systems, such as a flat file, a directory of a file system, a database file or partition, etc.

Further, the integrated development environment may allow a user to create new data fields which may not be currently in the data sources. When the data for such new data fields are available (e.g., on an integration server), the system may prompt an administrator for instructions on how to store such data in the backend data stores (e.g., on an Enterprise Resource Planning (ERP) system). Thus, the development of the system does not have to be started with the backend data store. The system may develop and evolve in time, as driven by need and expertise gained in the field.

A user may use a visual editor for object modeling (3023) to create object models. The available data fields (3021) can be presented in the visual editor so that the user can easily create a graphical representation of an object model, such as domain object model (3025). The object model created is specific for an application domain, which may represent a particular view of the available data fields (3021). Alternatively, a user may create the domain object model using a text editor. Alternatively, a user may annotate a piece of programming code, from which a software tool may be used to extract the domain object model. Alternatively, the domain object model may be generated through reflection or introspection.

A domain object model may include information to identify the data entities and the structural relationships. For example, a domain object model may include the following specification.

```
<Entity> Invoice
  <Part Iteration=None> InvoiceHeader </Part>
  <Part Iteration=List> InvoiceLine </Part>
</Entity>
<Entity> InvoiceHeader
  <Ref Iteration=None> Customer </Part>
</Entity>
<Entity> InvoiceLine
  <Ref Iteration=None> Product </Part>
</Entity>
<Entity> Customer </Entity>
<Entity> Product </Entity>
```

In the above specification, Invoice, InvoiceHeader, InvoiceLine, Customer, Product, etc. are defined as entities. A data entity has an identification which can be used to uniquely identify the data entity among other data entity of the same type. For example, two products may be otherwise the same except their identities.

Further, the above specification indicates that InvoiceHeader and InvoiceLine are part of Invoice. An InvoiceHeader or InvoiceLine cannot exist without its associated Invoice; and an InvoiceHeader or InvoiceLine cannot shared among different Invoices. An InvoiceHeader may refer to a Customer. The Customer may be referenced by different InvoiceHeaders associated with different Invoices. The Customer may exist without the InvoiceHeader. Similarly, an InvoiceLine may refer to a Product. The Product may exist without the InvoiceLine.

After the structural relation between the objects are defined in the object model, the system can enforce the referential integrity automatically in the management of the objects. For example, when an object corresponding to an entity is initialized, the object manager can also initialize the objects corresponding to the entities referenced by the entity, if these objects do not already exist. Since a sub-entity that is part of a parent entity cannot exist without the parent entity, the object manager may automatically delete the sub-entity when the parent entity is deleted. A referenced entity that is not part of a referencing entity may exist without the referencing entity; thus, when the referencing entity is deleted, the object manager may not delete the referenced entity.

A code generator (3027) can then be used to generate the code for data source objects (3029) and the metadata for object data access (3031), based on the domain object model (3025). The code for data source objects (3029) can be executed to generate instances (3029) of data source objects, which have the runtime data fields as specified by the domain object model (3025). The code for data source objects (3029) may be further modified by the user to specify other aspects of the objects.

The metadata (3031) are generated in a format readable by the local object manager (3035) running on the same device as the instances of data source objects (3033). The metadata (3031) can be used by the local object manager (3035) to manage the local persistent cache of object data (3039). The object data may be stored in a local SQL database, or in a flat file (e.g., in an XML format), or in a set of hierarchical files. The local object manager (3035) on the device has the capability to store data to the local cache, retrieve data from the local cache, and update the local cache, based on the metadata (3031). Further, the local object manager (3035) communicates the object data with a remote object manager (3037) using the metadata (3031). Thus, how the object data is stored and used locally on the device, on which the local object manager (3035) is running, can be completely independent from the representation of the object data in its remote authoritative source. This arrangement allows the separation of the development of mobile applications from the management and representation of the backend data sources.

In one embodiment, the visual editor (3023) and the code generator (3027) are provided in an integrated development environment, which may also support the visual development of workflow modules/applications.

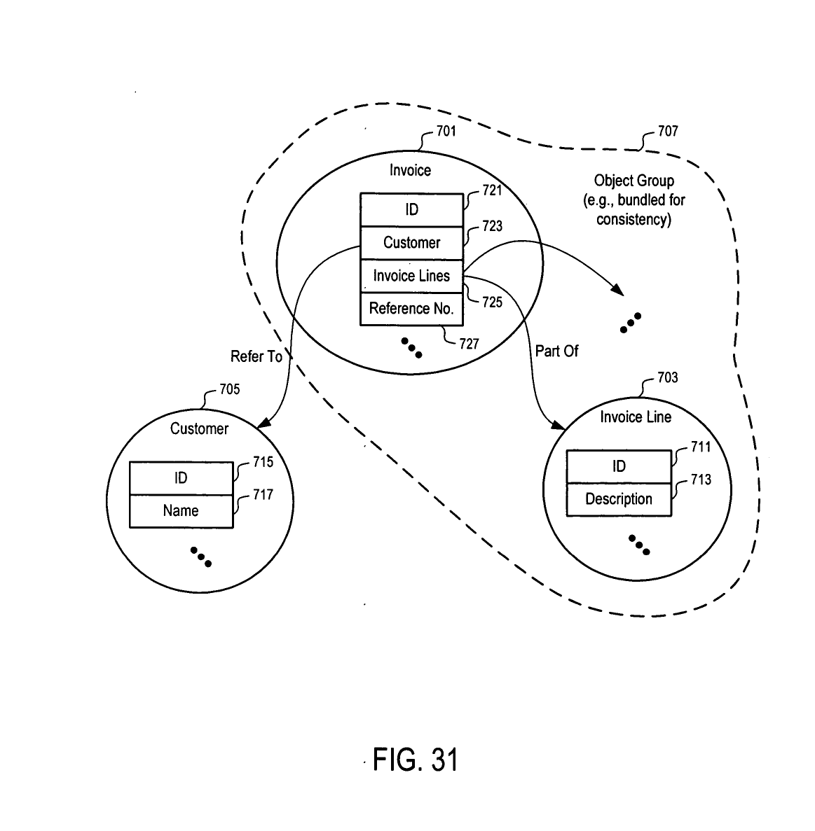

FIG. 31 shows a process to segment an object tree into object groups for data management.

In FIG. 31, an object (e.g., 701) that represents an invoice may include a number of data fields (e.g., 721, 723, 725, 727, . . . ). Some of the data fields directly contain the data for the object, such as ID (721), reference no. (727), etc. Some of the data fields points to other objects (e.g., 703, 705, . . . ) for further data fields.

The data fields that are considered as part of an object can be grouped for data transmission and update.

For example, invoice lines field (725) points to objects that are “part of” invoice object (701), such as invoice line object (703). Thus, data fields (e.g., 711, 713) of the invoice line object (703) can also be considered as “part of” invoice object (701). The invoice object (701) and invoice line object (703) are then grouped as part of a data record for transmission and update. The data fields of the object group are fetched together and updated in an atomic operation. For example, either the data for the entire object group is checked out or not checked out. Similarly, the changes to the entire object group is committed or not committed, for consistency. Thus, the data obtained for the object group is typically self-consistent; and the changes submitted for the object group is also self-consistent.

In FIG. 31, the customer field (723) of the invoice object (701) points to the customer object (705) which includes additional fields (705). Since the customer object is only referred to by the invoice object (701), the customer object is not considered as part of the invoice object. Thus, the customer object (705) is excluded from the object group (707).

When a child object cannot meaningfully exist without its parent object, the child object is considered as part of the parent object; otherwise, the child object can be independent of the parent object.

The relation between the parent objects and child objects may be provided in one or more resource files (e.g., as metadata for the objects). An object manager can use the information to manage the objects. For example, the metadata may be generated from a domain object model.

Alternatively, the relation between the parent objects and child objects may be indicated in the way the pointers are declared in the definition of the corresponding classes of the objects. For example, when the relation between a parent object and a child object is a “part of” relation, the variable of the data field pointing from the parent object to the child object is declared in one way; and the relation between a parent object and a child object is a “part of” relation, the variable of the data field pointing from the parent object to the child object is declared in anther way. Thus, through reflection/introspection (e.g., to examine the declaration of the data fields at runtime), the relation can be dynamically determined. For example, a process can interrogate the code (e.g., Java byte code) that is to be executed, or that is being executed, to determine the relations between objects and group the objects accordingly.

Some of the classes of objects include an identification field to indicate the identity of an object (e.g., ID field 721 of the invoice object 701, ID field 711 of the invoice line object 703, ID field 715 of the customer object 705, etc.) When different versions of objects (e.g., the live object, the cached data field of the object, etc.) are compared to determine the changes, comparison is made between versions of the objects of the same identity. When the identities of two objects do not match, the two objects are not compared. For example, if the identity of the cached data field of the object does not match that of any live objects, it may be determined that the cached object is to be deleted; similarly, if the identity of a live object does not match that of any cached objects, it may be determined that the live object is a newly inserted object.

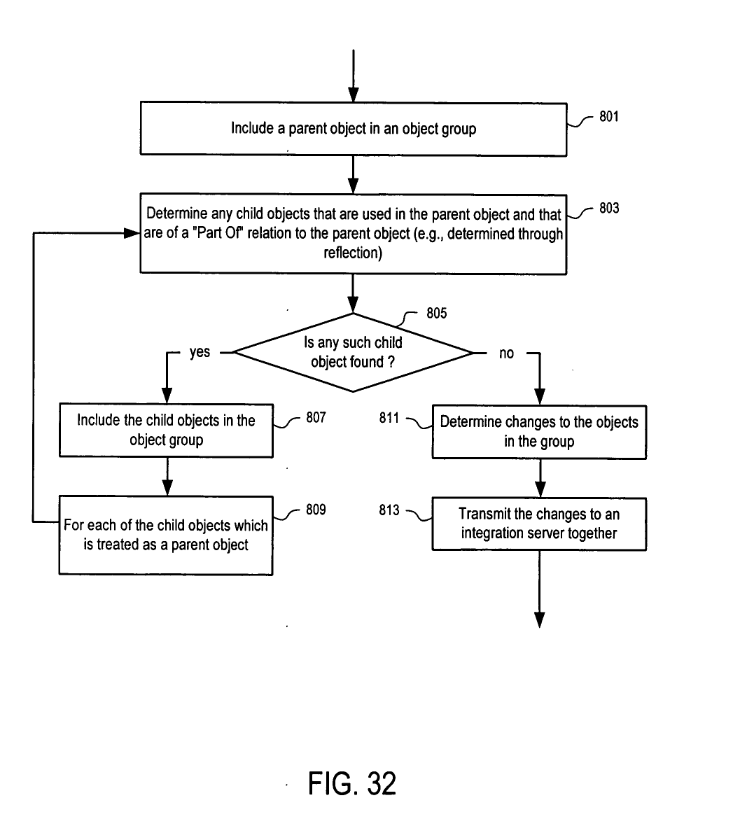

FIG. 32 shows a flow diagram of a process to segment an object tree. In FIG. 32, after a parent object is included (801) in an object group, any child objects that are used in the parent object and that are of a “Part Of” relation to the parent object are determined (803) (e.g., determined through reflection/introspection, or based on a domain object model). Operation 805 determines (805) whether any such child object is found.

If one or more such child objects are found, the child objects (870) are included in the object group. For each of the child objects which is treated as a parent object (809), the operations to search for child objects that are used in the parent object and that are of a “Part Of” relation to the parent object are performed for inclusion in the object group, in a recursive/progressive fashion.

After objects in the group are identified, changes to the objects in the group are determined (811). The changes are transmitted (813) to an integration server together.

An object group may be treated on the mobile device as one data record, or a combination of multiple data records. When the object group is treated as one data record on the mobile device and as a combination of multiple data records, the integration server may maintain a map to indicate the version mapping between the data records, if version numbers are used for version control.

In general, the objects may be connected by the links of referencial relations in a form of a network. In the network, the links representing the non-“Part Of” relations can be broken to leave the links that represent the “Part Of” relations. Thus, the network of objects may be broken down into sub-networks interconnected only by the “Part Of” relations. Each of the sub-networks of objects can then be treated as an object group. The objects connected by the links representing the “Part Of” relations are included in the same object groups; objects not connected by the links representing the “Part Of” relations are included in different object groups. Thus, the objects can be grouped together for transmission and caching; and changes or updates are transmitted in the unit of the object groups.

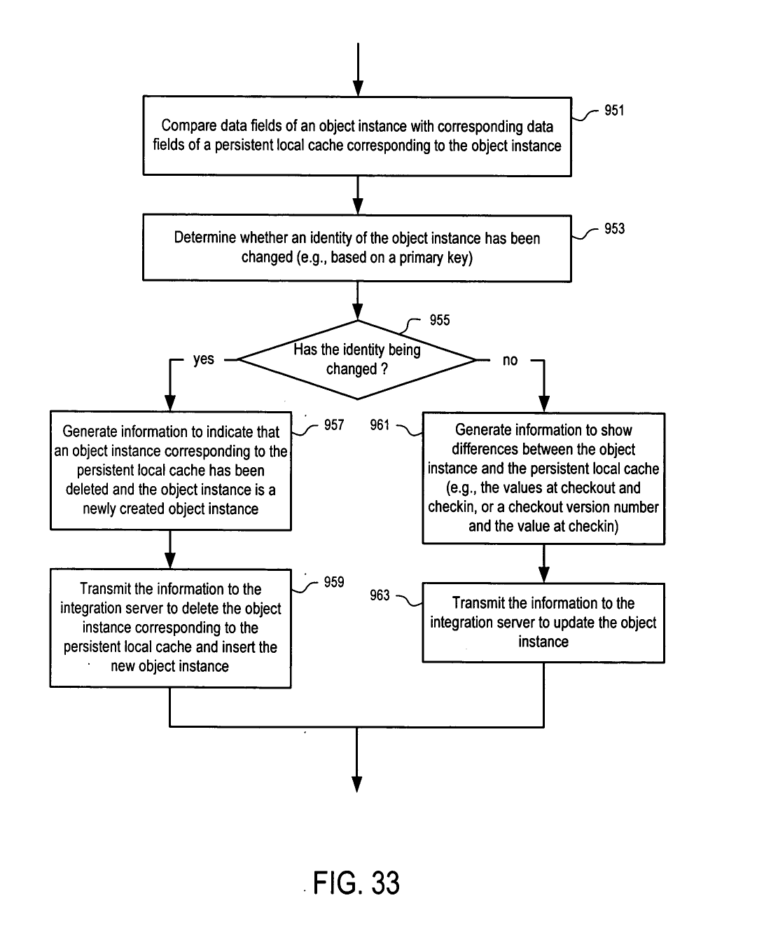

FIG. 33 shows a flow diagram of a process to determine changes in data. In FIG. 33, data fields of an object instance are compared (951) with corresponding data fields of a persistent local cache corresponding to the object instance. It is determined (953) whether or not an identity of the object instance has been changed (e.g., based on a primary key field).

If operation 955 determines the identity of the object instance has being changed, information is generate (957) to indicate that an object instance corresponding to the persistent local cache has been deleted and the object instance is a newly created object instance. The information is transmitted (959) to the integration server to delete the object instance corresponding to the persistent local cache and insert the new object instance.

If operation 955 determines the identity of the object instance has not being changed, information is generated (961) to show differences between the object instance and the persistent local cache (e.g., the values at checkout and checkin or a checkout version number and the value at checkin). The information is transmitted (963) to the integration server to update the object instance.

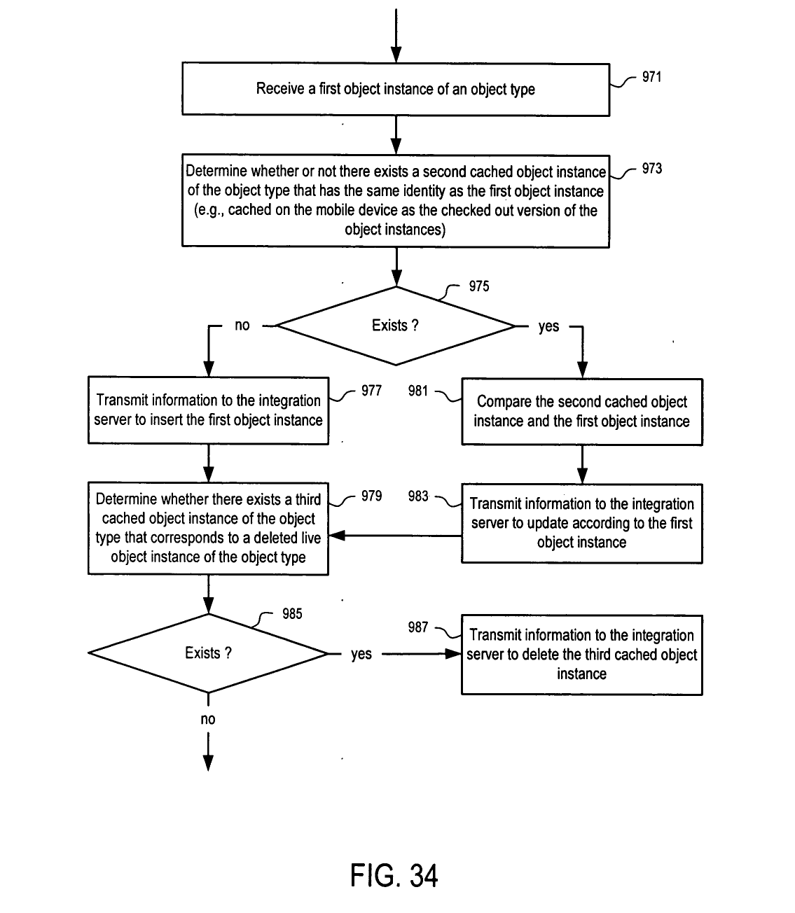

FIG. 34 shows a flow diagram of another process to determine changes in data. In FIG. 34, after a first object instance of an object type is received (971), it is determined (973) whether or not there exists a second cached object instance of the object type that has the same identity as the first object instance (e.g., cached on the mobile device as the checked out version of the object instances).

If operation 975 determines that such a second cached object instance exists, the second cached object instance and the first object instance are compared (981). Information is transmitted (983) to the integration server to update according to the first object instance.

If operation 975 determines that such a second cached object instance does not exist, information is transmitted (977) to the integration server to insert the first object instance.

It is determined (979) whether or not there exists a third cached object instance of the object type that does not has the same identity as any live object instance of the object type. If operation 985 determines that such a third cached object instance exists, information can be transmitted to the integration server to delete the third cached object instance.

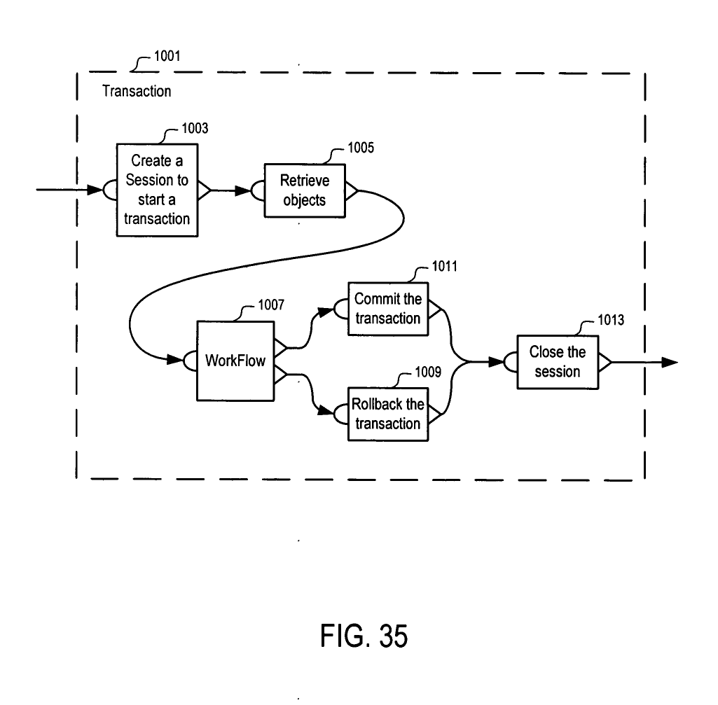

FIG. 35 illustrates a way to implement transactions for consistency. In FIG. 35, a transaction mechanism is used together with a session of workflow. A session is used to define the scope of a transaction (1001). A session is created (1003) to start a transaction. Before the close of the session (1013), the tasks performed in the workflow may save different changes to objects. A change to the objects used in the session may cause the state of the objects being in an inconsistent state. When the changes made in the sessions are all saved, the objects are moved from one consistent state to another consistent state. To maintain consistency in a systematic way, changes in the session are automatically grouped as one transaction. Before the close of the session, the system commit (1011) the transaction or rollback (1009) the transaction, after the execution of the workflow (1007). Some of the objects may be retrieved (1005) for the execution of the workflow (1007); some of the objects may be created during the execution of the workflow (1007); some of the objects may be retrieved during the execution of the workflow (1007).

For example, the changes saved by the workflow (1007) may be stored locally on the mobile device and maintained by the object manager. The changes may be submitted from the mobile device to an integration server before the end of the session. In such an embodiment, the integration server may be made aware of the transaction, such that the transaction may be committed or rolled back.

Alternatively, the object manager may maintain the changes in the transaction until the session is closed. After the session is closed, the transaction is either committed or rolled back. To rollback the transaction, the object manager may simply delete the changes made in the transaction; and no submission to the integration server is necessary. To commit the session, the object manager may concatenate the changes made in the transaction and transmit the concatenated changes from the mobile device to the integration server. The transmission of the changes for the transaction may be made at a time when the communication connection is available. The total data transmission may be reduced through the concatenation of changes.

For example, when a session is opened, the object manager may automatically start a transaction. The objects may be retrieved after the starting of the session. Alternatively, the objects may be pre-fetched and cached before the session is started, based on a prediction that the session is to be started in a time window. The pre-fetching and caching of data objects during communication idle periods that can improve the responsiveness of the mobile application and improve user experience. The pre-fetching and caching of data objects can also improve performance when the mobile device moves in and out of a communication blind spot. Alternatively, the objects may have already been retrieved in a prior segment of the workflow (e.g., for the view of the data records before entering the editing mode).

At the closing of the session, the system may indicate to the object manager whether the transaction is to be committed or rolled back. If the application does not finish the session properly, the transaction will not be committed. For example, if the application crashes, the transaction may be rolled back to restart the session. Such an arrange can avoid submitting partial, inconsistent data to the backend server. For example, if the user wants to cancel the session, the transaction may be rolled back.

The changes in the transaction can be grouped for application in an atomic operation. Multiple changes may be optimized to reduce the overall size of the information needs to be transmitted. For example, intermediate changes that is overwritten by subsequent changes can be eliminated. Such optimization at the mobile device may reduce the need for the communication bandwidth and reduce the processing workload at the backend server.

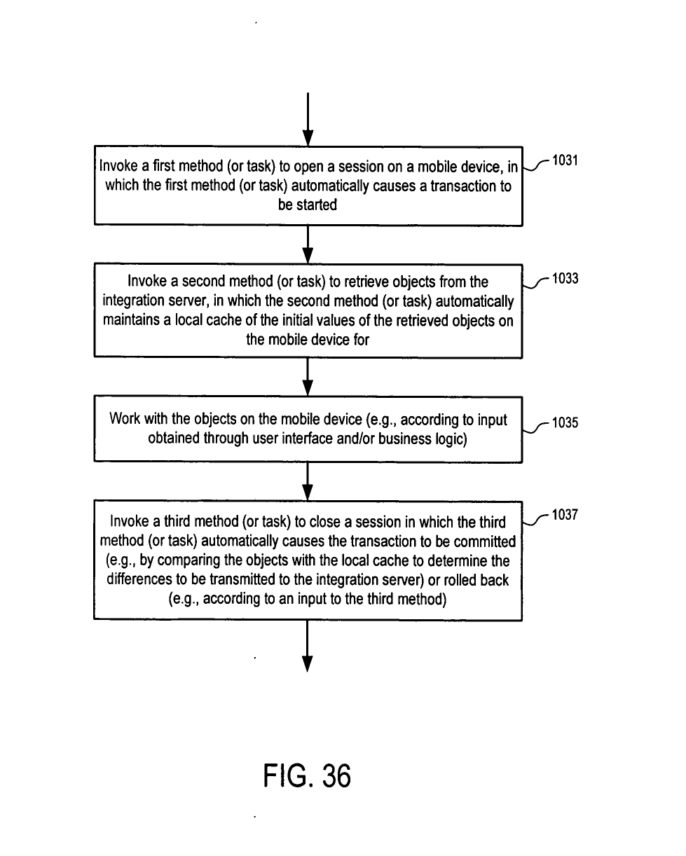

FIG. 36 shows a flow diagram of another process to implement transactions for consistency. In FIG. 36, operation 1031 invokes a first method (or task) to open a session on a mobile device, in which the first method (or task) automatically causes a transaction to be started. Operation 1033 invokes a second method (or task) to retrieve objects from the integration server, in which the second method (or task) automatically maintains a local cache of the initial values of the retrieved objects on the mobile device for. Operation 1035 works with the objects on the mobile device (e.g., according to input obtained through user interface and/or business logic). Operation 1037 invokes a third method (or task) to close a session in which the third method (or task) automatically causes the transaction to be committed (e.g., by comparing the objects with the local cache to determine the differences to be transmitted to the integration server) or rolled back (e.g., according to an input to the third method).

Sometime Connected

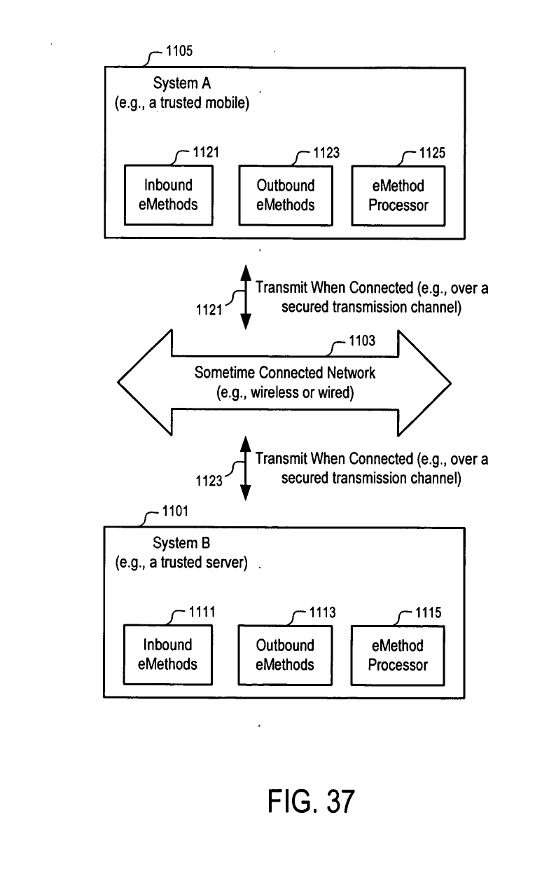

FIG. 37 illustrates a way to execute applications over a sometime connected network. In FIG. 37, the systems (e.g., 1105 and 1101) are sometime connected for communication and sometime disconnected from each other. When connected the systems (e.g., 1105 and 1101) may transmit (or receive) (e.g., 1121 and 1123) over the sometime connected network (1103) to communicate with each other. The network (1103) may temporarily store the communications received, forward the communications to the destination system when the connection to the destination is available.

In FIG. 37, a system (1105) has an eMethod processor (1125), an inbound queue for eMethods (1121), and an outbound queue for eMethods (1123). An eMethod includes a workflow method module and associated data to be used in the execution of the workflow. The workflow method module may be in the form of an workflow application. The associated data may be embedded in the workflow method module or provided in a separate file.

eMethods can be suitable for service oriented architecture. eMethods can provide “building blocks” of on-demand business process automation. Users can subscribe or accept workflows. Sending party can “push” a change in workflow to mobile device via an eMethod. Services or information can be shared across eMethods.

The eMethod processor (1125) processes the inbound queue of eMethods, without the need to wait for immediate data communication with a remote system, such as the system B (1101), which has its own eMethod processor (1115), inbound eMethods (1111) and outbound eMethods (1113). When there is an unsatisfied communication need, the eMethod processor (1125) generates an outbound eMethod for transmission to the remote system. The outbound eMethod includes a workflow that is to be executed on the remote system and the data to be used in the execution of the outbound eMethod. Thus, the current workflow is converted into the outbound eMethod in the outbound queue for delivery to the remote system via the sometime connected network (1103).

For example, the connection between the system A (1105) and the sometime connected network may be available to transmit the outbound eMethods to the network (1103), even when a connection to the system B (1101) is not available at that time. When the network (1103) is connected to the system B (1101) to delivery the eMethods originated from the outbound queue of the system A (1105), the system A (1105) may not be connected with the network (1103). The eMethods are routed reliably from one system to another over the sometime connected network without the need for a real time communication connection.

When a real time communication connection between the systems (e.g., 1105 and 1101) is available (e.g., after the outbound eMethod is queued), the real time communication connection can be used to transmit the eMethod.

When a real time communication connection between the systems is available during the execution of the original workflow, the use of an eMethod is optional. For example, a mobile system may try to use a remote procedure call or a web request to obtain the network based resource. If the mobile system fails to obtain the resource through the real time communication connection (e.g., within a time window), the mobile system can then convert the current workflow application into an eMethod for transmission to the remote system. If the mobile system determines that it may have to wait to obtain the network based resource for a time period that is longer than a threshold (e.g., based on statistical data, or after having waited for a period of time), the mobile system can convert the current workflow application into an eMethod.

Thus, the eMethod processor (e.g., 1125 or 1115) does not have to wait for the availability of the real time communication connection.

Further, the system may convert the current workflow application into an eMethod in the inbound queue. For example, when the mobile device is waiting for the access to a peripheral device which is not yet attached to the mobile, the mobile device may convert the current workflow into an eMethod in the inbound queue; and the eMethod can be marked so that the mobile device may automatically start the execution of the eMethod when the peripheral device is available.

In one embodiment of the invention, the mobile applications are developed in a way to avoid the wait for real time communication connections. When the real time communication connection is not available, a corresponding outbound eMethod is generated according to the workflow and queued for delivery over the sometime connected network; and the current workflow comes to an end.

Alternatively, the workflow engine may automatically generate the outbound eMethod. For example, the workflow engine may generate a workflow module from the current workflow through embedding the values of the global variable pool in the workflow module and modifying the specification of the starting module. The workflow engine may further generate an outbound eMethod which requests the remote system to embed the requested data in a reply workflow that calls the generated workflow module.

After the current workflow application is converted into an eMethod that has to wait for a period of time, the eMethod processor can free up the resources and start to process other applications.

If a conventional technique were used, such as remote procedure calls or web access, the mobile application would be forced to wait for the real time communication connection; and the mobile application would not work until a real time communication connection can be established between the systems. When the eMethod queue approach is used, the eMethods can be propagated from one system to another for execution, even without a need for a real time communication connection.

For instance, the connection from the system A (1105) to the network (1103) may be available in the morning; and the connection from the network (1103) to the system B (1101) may be available in the afternoon. The propagation of an eMethod may be performed in two separate time periods to deliver the eMethod from the system A (1105) to the system B (1101). Since there is no real time connection between the systems A and B, a mobile application using remote procedure calls or web access would not work.

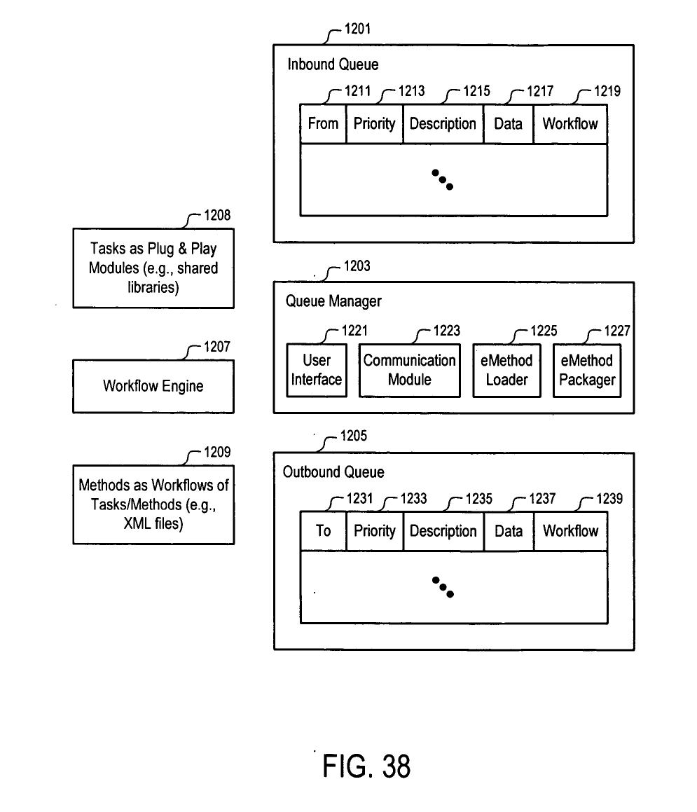

FIG. 38 illustrates a way to implement eMethods. In FIG. 38, a queue manager (1203) provides an user interface (1221). A communication module (1223) is used to propagate the eMethod files toward destination systems and to receive the eMethod files from the sometime connected network. An eMethod loader (1225) is used to process the inbound queue (1201) and load eMethods according to priority (1213) or user selection. The queue manager may show the inbound queue with various attributes, such as the source of the eMethod (“From” 1211), the priority of the eMethod (“Priority” 1213), a brief description of the eMethod (“Description” 1215), etc. An eMethod may include data (1217) and a workflow (1219).

The queue manager (1203) may also include an eMethod packager (1227) which packages a workflow as an outbound eMethod for continued execution on a remote system. The outbound eMethod is then queued in the outbound queue (1205) for delivery to the remote system. An outbound eMethod may include attributes, such as the destination of the eMethod (“To” 1231), the priority of the eMethod (“Priority” 1233), a brief description of the eMethod (“Description” 1235), data to be used in the eMethod (“Data” 1237), a workflow (1239), etc.

The eMethods may be delivered via an email system, or a custom designed messaging system. When an email system is used, the workflow can be packaged as an attachment to an email message, which may include an optional subject line to briefly describe the workflow, an optional detailed message, etc. The workflow and data may be encrypted and digitally signed to provide communication security.

Some of the modules referenced in the workflows of the eMethods may be tasks implemented as plug and play modules (1208), which may be provided in shared libraries. Some of the modules referenced in the workflows of the eMethods may be methods (1209) as workflow of tasks and/or methods, which may be provided in XML files. The workflow engine (1207) interprets the workflows of the eMethods to load and execute the task modules (1208).

The queue manager may be implemented as a workflow of modules. The queue manager and the workflows of the eMethods may be executed in different threads, or in the same thread.

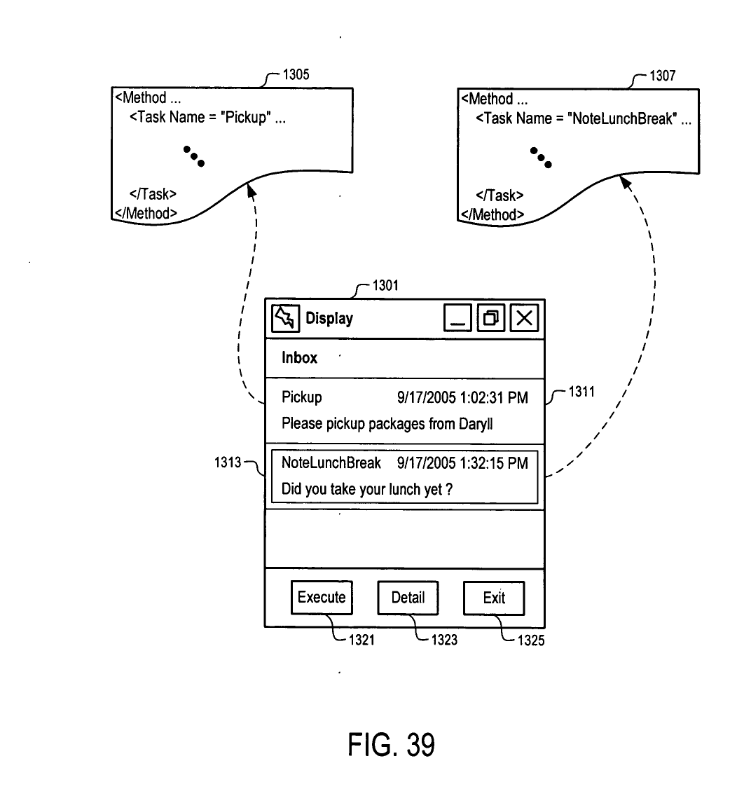

FIG. 39 illustrates user-level eMethods. In FIG. 39, a user interface (1301) is provided to show the queue of inbound eMethods (e.g., 1311 and 1313). An eMethod is shown with a name (e.g., “Pickup”), the date and time of the eMethod (e.g., “Sep. 17, 2005 1:02:31 PM), and a brief description (e.g., “Please pickup package from Daryll”). Each of the eMethods has a corresponding workflow (e.g., 1305 or 1307). A user may select one of the eMethods and execute the workflow (e.g., by selecting the eMethod to highlight the eMethod and then press the “Execute” button (1321)). The user may see further details of the eMethod by selecting the “Detail” button (1323) which may cause the system to display a screen showing a detailed message, or a workflow diagram of the eMethod, or a list of modules to be performed, or the XML file of the eMethod, or other detailed representations of the selected eMethod. The user may select the “Exit” button to close the queue without executing one.

The eMethods may be transmitted via an email system or other store-and-transmit messaging system. A custom communication system may also be used. In such a system, an email client program may be used to display the eMethods; and the email client program is configured to call an eMethod processor when a workflow attachment is selected.

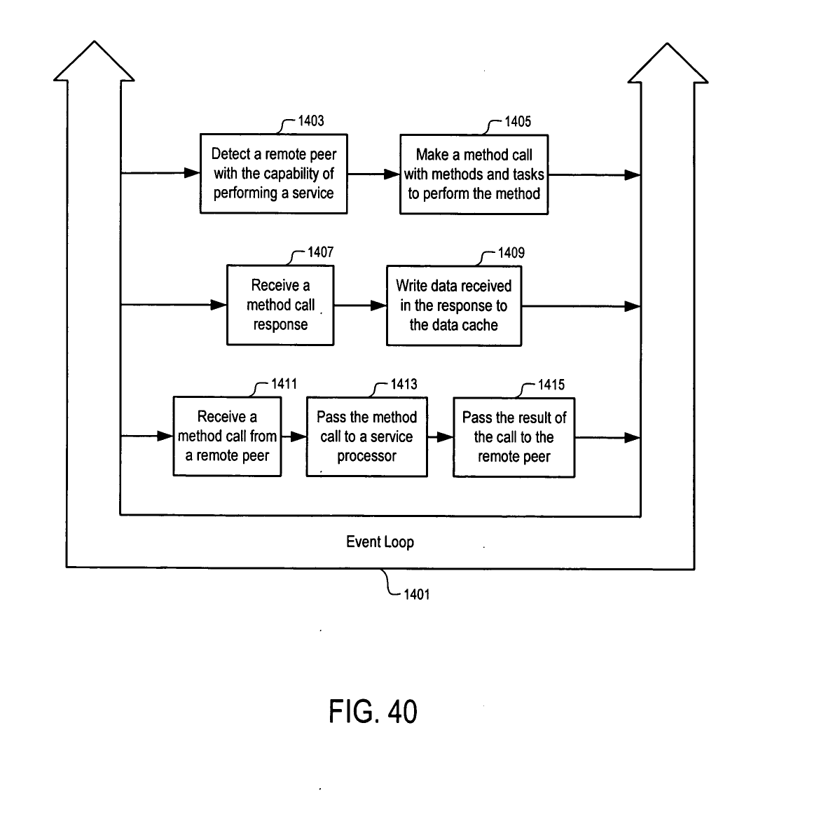

FIG. 40 illustrates a way to delegate tasks from one system to another. In FIG. 40, operation 1403 detects a remote peer with the capability of performing a service; operation 1405 makes a method call with methods and tasks to perform the method; and the system enters into an event loop without having to wait for the result of the method call. The method call can be implemented as an eMethod having a workflow specifying the flow of modules and data needed during the execution in the eMethod.

During the event loop, operation 1407 may receive a method call response; and then operation 1409 writes data received in the response to the data cache. The method call response may be implemented as an eMethod, which when executed, causes the data to be written into the data cache. For example, the response eMethod may check out objects to the object manager so that the data are stored in the local persistent cache.

Alternatively, the response may further cause the system to execute a workflow that is the continuation of a previous workflow application.

The method call response may be queued in a queue for the selection by the user, or automatic selection by the system according to priority.

During the event loop, operation 1411 may receive a method call from a remote peer; operation 1413 then passes the method call to a service processor; and operation 1415 passes the result of the call to the remote peer. The method call may be implemented as an eMethod, which includes a workflow and data to be used during the execution of the workflow. The service processor may include a workflow engine.

When the network connection to the remote peer is not available, the system may generate an eMethod to make a method call.

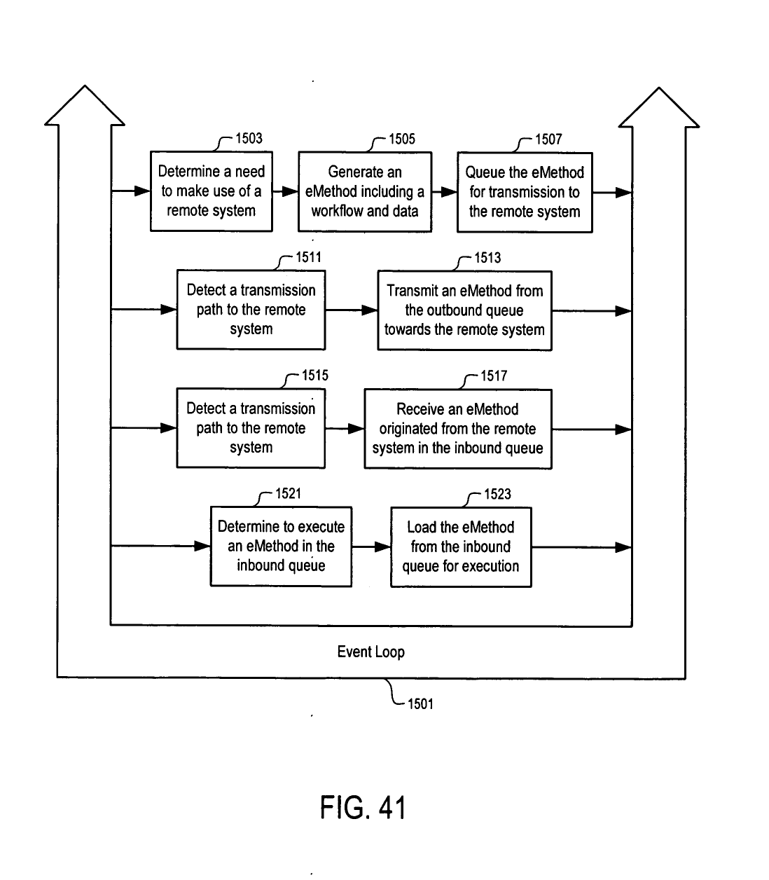

FIG. 41 illustrates a way to push tasks from one system to another. In FIG. 40, after operation 1503 determines a need to make use of a remote system, operation 1505 generates an eMethod including a workflow and data; and then operation 1507 queues the eMethod for transmission to the remote system. The workflow may include the information to continue the current workflow application; and thus, the current workflow application can exit, after the eMethod is queued.

During the event loop, operation 1511 may detect a transmission path to the remote system. Operation 1513 transmits an eMethod from the outbound queue towards the remote system. For example, the eMethod may be transmitted to a server, which will further forward the eMethod to the remote system when a connection to the remote system is available.

Similarly, during the event loop, operation 1515 may detects a transmission path to the remote system so that operation 1517 can receive an eMethod originated from the remote system. The eMethod received is placed in the inbound queue.

During the event loop, operation 1521 may determine to execute an eMethod in the inbound queue; and operation 1523 then loads the eMethod from the inbound queue for execution. After the execution of the eMethod, the system enters the event loop (1501) again.

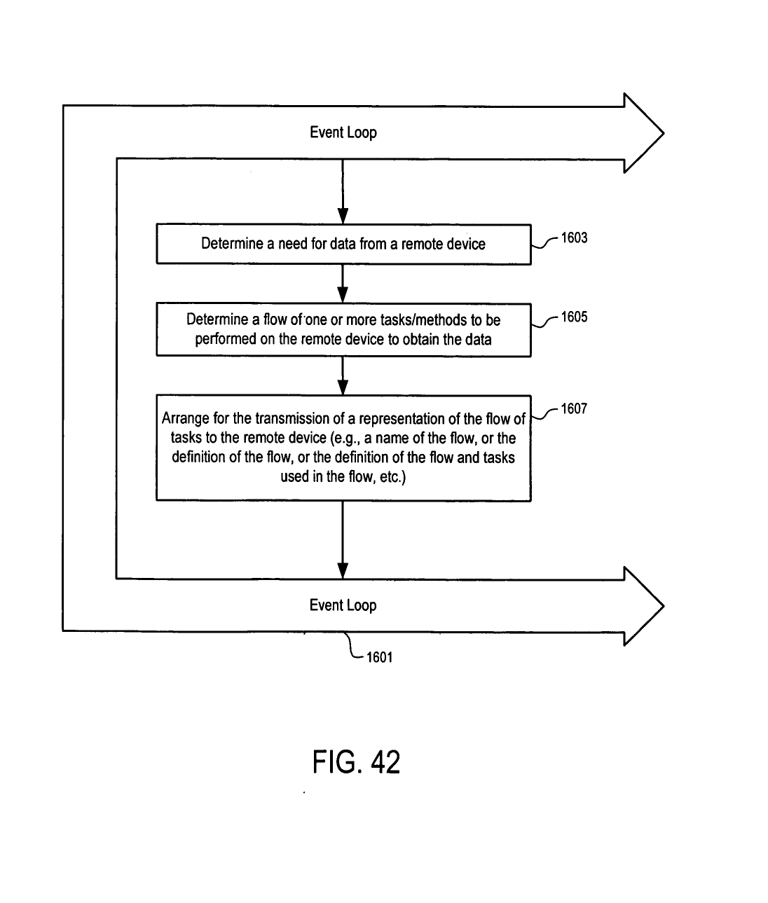

FIG. 42 shows a flow diagram of a process to transfer task from a remote device in response to a need for data from the remote device. In FIG. 42, in the event loop 1601, operation 1603 determines a need for data from a remote device. Operation 1603 then determines a flow of one or more tasks/methods to be performed on the remote device to obtain the data. Operation 1603 arranges for the transmission of a representation of the flow of tasks to the remote device (e.g., a name of the flow, or the definition of the flow, or the definition of the flow and tasks used in the flow, etc.). After the request is queued for transmission, the current application that needs the data from the remote device may exit, since the system knows how to continue the application after the transmission of the request.

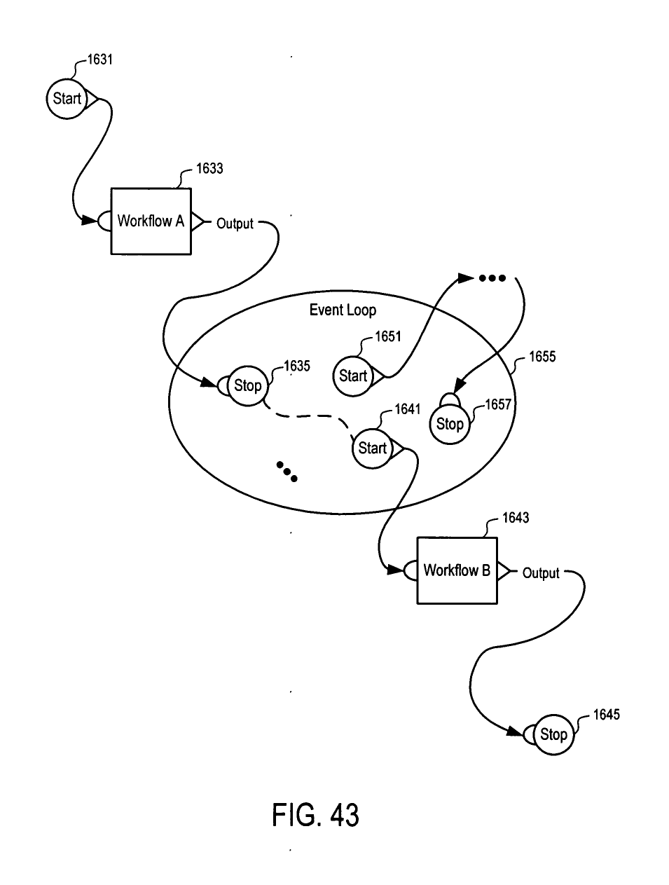

FIG. 43 illustrates a way to break a workflow into sub workflows that are coupled by an event loop. In FIG. 43, a visual representation of the workflow is displayed in an integrated development environment. A symbol (1631) represents the starting point of the workflow; a symbol (1645) represents the ending point of the workflow. The workflow may be broken into multiple sub workflows, which are connected by an event loop (1655). For example, one sub workflow (1633) stops inside the event loop (1655) at the symbol (1635); and one sub workflow (1643) starts from the symbol (1641) inside the event loop (1655).

The workflow may further include other sub workflows, starting from a symbol (e.g., 1651) inside the event loop and ending at a symbol (e.g., 1657) inside the event loop.

Different sub workflows may be performed on different systems. For example, the sub workflow (1633) may be performed on a mobile device; and the sub workflow (1643) may be performed on an integration server (or another mobile device).

For example, the workflow (1633) may be used for data collection at the mobile device. The workflow (1643) may be used for the processing of the collected data at the integration server. After the data is collected at the mobile device, the sub workflow (1643) can be packed with the collected data as an eMethod for transmission to integration server. Thus, the sub workflow (1633) can be stopped without having to wait for the transmission of the data. The sub workflow (1643) may be arranged to invoke a workflow module on the integration server.

In another example, both the sub workflow (1633) and the sub workflow (1643) may be performed on the same mobile device. After the execution of the sub workflow (1633), further data may be need from an integration server (or a remote mobile device). When the data is available, the sub workflow (1643) may be executed without having to wait. When the data is not available, the sub workflow (1643) may be stopped; and the sub workflow (1643) can be queued for execution. Since the sub workflow (1643) is stopped, the method processor may unload the task modules used by the sub workflow (1643) and start to process other workflows. The method processor can pre-fetch required data for the execution of the workflows in the queue. Thus, the data needed in the sub workflow (1643) can be fetched when a communication connection to the integration server (or the remote mobile device) is available. When the data for the sub workflow (1643) is available, the system may alert the user for the execution of the queued workflow.

It may not be necessary to have a real time communication connection to fetch the data. The method processor may send over a sometime connected network an eMethod to request the data and obtain the data in a responding eMethod, which invokes the sub workflow (1643). For example, the requesting eMethod may include information on how to construct the responding eMethod with the requested data such that the responding eMethod may be constructed to invoke the sub workflow (1643).

In a further example, the sub workflow (1633) and the sub workflow (1643) may be performed on the same mobile device; and an intermediate sub workflow starting from symbol (1651) and ended at symbol (1657) is to be performed on a separate system (e.g., on an integration server or on remote mobile device). Thus, the sub workflow (1633) can be stopped, when the resource of the separate system is needed. The separate system is instructed to provide the resource via the workflow transmitted as an eMethod. The response from the separate system is obtained via a further workflow transmitted back to the mobile device as an eMethod.

After the relations between sub workflows are defined in the integrated development environment, the system can automatically manage the correct execution of the workflow through the event loop.

Some of the eMethods may be explicitly specified by the user in the integrated development environment, or implicitly indicated in the workflow. For example, the outputs of a communication module that correspond to the success and the failure of a real time communication session may be indicated in the integrated development environment. The data exchange in the communication module can also be specified. The output corresponding to the failure in the communication module flows into a special node that causes the method processor to automatically generate a requesting eMethod for the remote system and transform the current workflow into a module that is to be invoked by the replying eMethod from the remote system.

Further, based on the data exchange needed in the communication module, the integrated development environment may automatically generate the communication module as a workflow module (or as a task module). For example, when the objects to be fetched is specified, the integrated development environment can automatically generate the workflow module to communicate the object with one or more data sources. When a communication failure is detected at the mobile device, the method processor can automatically generate the eMethods for the continuation of the workflow. Alternatively, the integrated development environment may generate a workflow for an object manager to communicate the object with one or more data sources.

The user may specify what information can be supplied by a sub workflow when the sub workflow ends in the event loop, and what information a sub workflow needs to initialize the sub workflow when the sub workflow starts in the event loop, and what information a sub workflow is needed in continuing the execution of a subsequent workflow. Thus, the development of the sub workflows can be separate from each other. For example, the sub workflows can be developed as workflow modules.

The specifications of the sub workflows and the event loop allow the mobile device to schedule and connect different sub workflows intelligently. The mobile device may further connect the sub workflows of different applications. For example, based on what is provided and what is needed, the method processor may determine a list of candidates sub workflows; the list may be sorted according to a degree of match between what is provided and what is needed. A user may select one from the candidates to run a relevant workflow. The system may automatically run a sub workflow, if certain criteria or rules are satisfied. Thus, composite applications can be dynamically generated in run time based on context and the input of the user.

Thus, to replace a complex, rigid workflow, a set of relative small workflows applications can be developed and connected via the event loop. Based on the context of the execution, the small workflows can be dynamically combined. An selection module may be used to help the scheduling of workflow applications. If an inclusive workflow were to be develop to allow the similar functionality, the specification of the workflow can be very large and complex. Based on the run time selection and dynamic coupling, the overall specification of the workflows can be simplified, since many flow directions among the sub workflows can be dynamically selected or scheduled without an explicit specification.

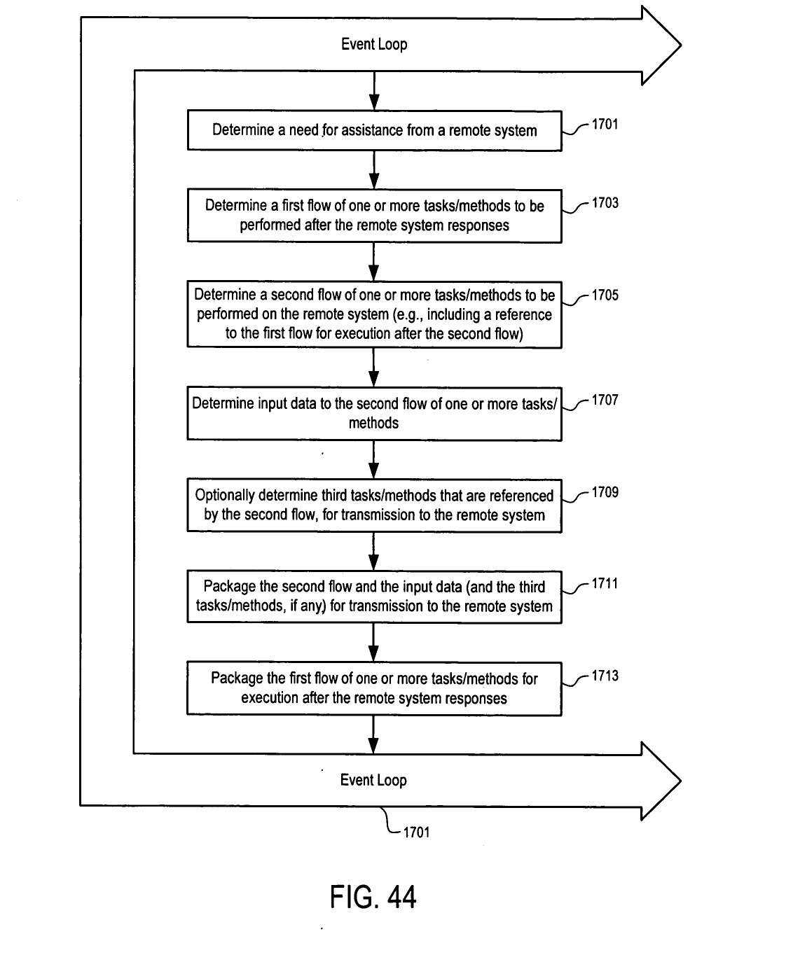

FIG. 44 shows a flow diagram of a process to request a service from a remote system and to prepare entering an event loop. In FIG. 44, during the event loop 1701, operation 1701 determines a need for assistance from a remote system. For example, the method processor may determine that a workflow application needs assistance from a remote system.

Operation 1703 determines a first flow of one or more tasks/methods to be performed after the remote system responses. Operation 1705 determines a second flow of one or more tasks/methods to be performed on the remote system (e.g., including a reference to the first flow for execution after the second flow). Operation 1707 determines input data to the second flow of one or more tasks/methods.

Operation 1709 optionally determines third tasks/methods that are referenced by the second flow, for transmission to the remote system. Some of the tasks/methods used in the second flow may be already pre-installed on the remote system. The remote system may be able to download some of the tasks/methods used in the second flow from a server (e.g., an integration server). Some of the tasks/methods used in the second flow may need to be transmitted from the local system to the remote system.

Operation 1711 packages the second flow and the input data (and the third tasks/methods, if any) for transmission to the remote system. The second flow and the input data may be packaged as an eMethod. For example, the second flow and the input data may be packaged as an attachment to an email to the remote system. Alternatively, a custom designed messaging system may be used.

Operation 1713 packages the first flow of one or more tasks/methods for execution after the remote system responses. For example, the first flow may be packaged as a workflow module with global variables initialized to the current state of the workflow application.

Alternatively, the local system may package both the first and second flows with the data in one eMethod for transmission to the remote system. After the execution of the second flow, the remote system may then decide which system will be in a better position to execute the first flow. For example, the remote system may continue to execute the first flow, or transmit the result of the execution of the second flow with the first flow to another system for execution, or transmit the result of the execution of the second flow with the first flow back to the local system for execution.

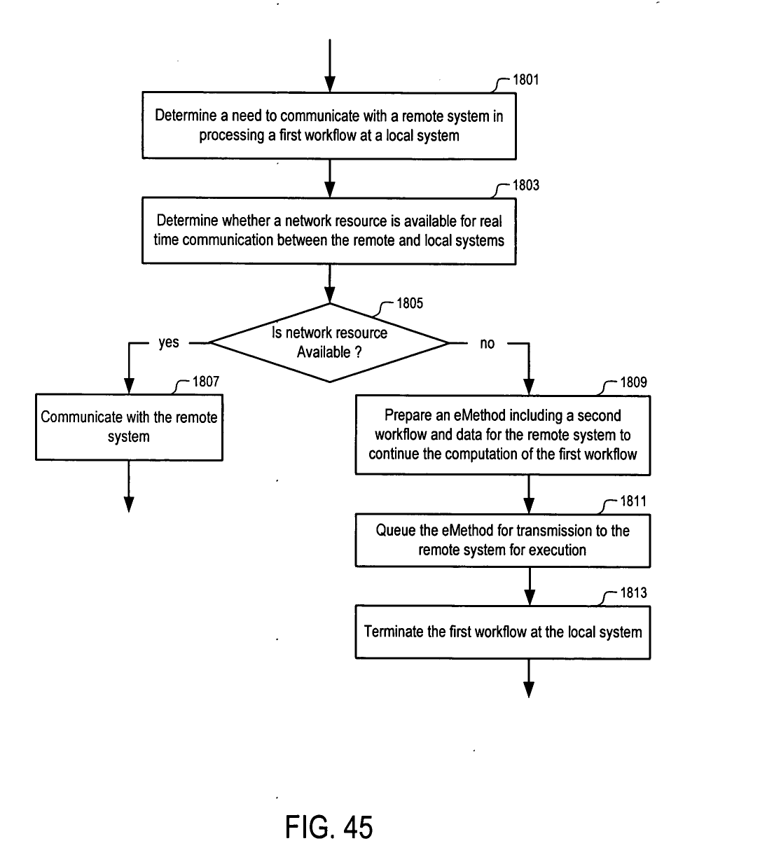

FIG. 45 shows a flow diagram of a process to handle communication needs operation 1801 determines a need to communicate with a remote system in processing a first workflow at a local system. Operation 1803 determines whether a network resource is available for real time communication between the remote and local systems. If operation 1805 determines that the network resource is available, operation 1807 communicates with the remote system. Thus, the execution of the first workflow continues if the communication need can be satisfied (e.g., satisfied within a predetermined period of time).

Otherwise, operation 1809 prepares an eMethod including a second workflow and data for the remote system to continue the computation of the first workflow. Operation 1811 queues the eMethod for transmission to the remote system for execution. Operation 1813 terminates the first workflow at the local system. Thus, the first workflow is automatically converted into an eMethod queued for execution on the remote system if the communication need can not be satisfied (e.g., not satisfied within a predetermined period of time).

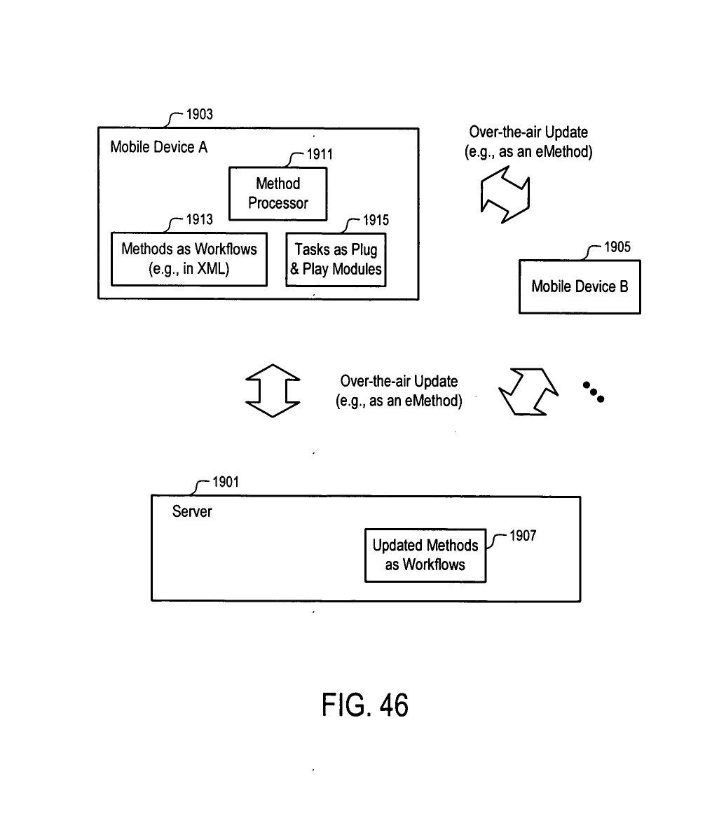

FIG. 46 illustrates a way to provide over the air (OTA) update. In FIG. 46, the mobile devices may be updated through eMethods. The server (1901) packages an update as an eMethod, which includes the data to update a mobile device and a workflow which is to be executed on the mobile device to update the mobile device according to the data packaged in the eMethod. The eMethod may update a workflow module, a task module, a library (e.g., including a set of workflow modules or a set of task modules), or objects that have been checked out to one or more of the mobile devices. The server transmits the eMethod over a sometime connected network, which may store and forward received messages. The mobile devices (e.g., 1903 and 1905) may further transmit the eMethod in a peer to peer mode.

When the eMethod arrives in the inbox of the mobile device (1903), the method processor (1911) may automatically execute the eMethod or keep the eMethod in the queue until the eMethod is selected by the user, based on a priority setting of the eMethod. The eMethod may be digitally signed to prevent tempering. The eMethod may further be encrypted to prevent unauthorized access to the data. The eMethod may include references to various modules, such as methods (1913) as workflows (e.g., in XML) and tasks (1915) as plug and play modules (e.g., in shared library). The eMethod may be executed to replace one of the modules, to add modules to the libraries, to provide/update data objects, etc.

The modules (e.g., task modules or workflow modules) may also be treated as data objects, which can be checked out from the server to the mobile devices. To update the modules, the changes are determined and transmitted (e.g., by the object managers). Since only the changes are transmitted, the amount of data to be transmitted to update the mobile devices can be reduced. Further, the mobile devices may modify the workflow modules to generate customized versions of the workflows. The changes can be checked in back to the server. The server may maintain multiple versions of the workflow modules, which may or may not be consolidated into a single version. For example, the development of the different versions of the workflow can be monitored and used to derive a best practice version out of the changes; and then the update to the best practice version can be sent to the mobile devices. Such a system allows the dynamic creation of workflow applications to track the best practices in the field.

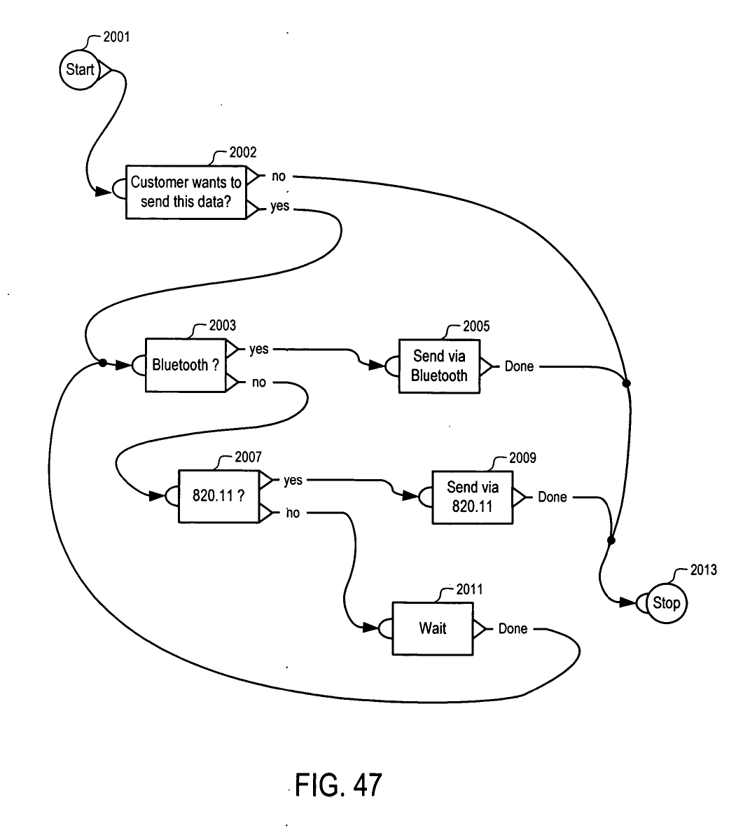

FIG. 47 illustrates a way to implement a portion of a virtual machine using a workflow. In FIG. 47, a portion of the method processor is implemented as a workflow module, which has a start point (2001) and an end point (2013). This portion of the method processor determines a way to transmit the data to a remote system (e.g., to an integration server, or another mobile device). The workflow uses a number of modules, such as module 2005 to send data via a bluetooth connection, module 2009 to send data via an IEEE 820.11 connection (e.g., WiFi), etc. Module 2002 determines whether the customer wants to send this data. If the customer wants to send this data, module 2003 determines if a bluetooth connection is available. If a bluetooth connection is available, module 2005 sends the data via the bluetooth connection. If module 2007 determines that an IEEE 820.11 connection is available, module 2009 sends the data via the IEEE 820.11 connection. When no bluetooth and no IEEE 820.11 connections are available, module 2011 may wait for a period of time and then check the availability of connections.

Since this portion of the method processor is implemented as a workflow (e.g., specified in XML), this portion of the method processor can be updated on the fly without having to restart the method processor. For example, the method processor can be updated to check the IEEE 820.11 connection before checking the bluetooth connection. When an updated version of the module is available, the method processor can start to execute according to the new workflow, without having to restart the mobile device. The server may send the difference between the prior checked out version and the updated version to the mobile device. The changes can be applied on the mobile device to generate the updated version based on the prior checked out version and the changes. Such a system can further reduce the data to be transmitted over the air to update the mobile device.

Using eMethods business process can be pushed to and/or pulled from a mobile device. For example, a server or dispatcher can package the data needed for the execution of a work order together with a customized workflow application for the processing of the work order into an eMethod. The eMethod is queued for transmission to the mobile device. After the eMethod is delivered into the inbox of the mobile device, it is queued for execution, or for selection by the user to execute.

Alternatively, the mobile device may request such an eMethod through sending a message to the server or dispatcher; and the message may be an eMethod which requests the server or dispatcher to provide feedback.

For example, the mobile device may send an eMethod which includes a copy of a workflow to be executed, and a message describing a request to customize the workflow. When executed, the eMethod shows the request to a dispatcher, and then presents the workflow to the dispatcher for modification. After the modification is finalized, the eMethod composes a replying eMethod which includes the modified workflow (and the data needed for the execution of the workflow, if any). When executed on the mobile device, the replying eMethod may update the workflow module on the mobile device according to the modified workflow, or simply run the modified workflow.

Thus, the effectiveness of the mobile staffs can be enhanced by allowing the corporate stuff, or an automation agent, to push support for business process into the mobile devices. The best practices of the business process can then be encapsulated and pushed or pulled on demand.

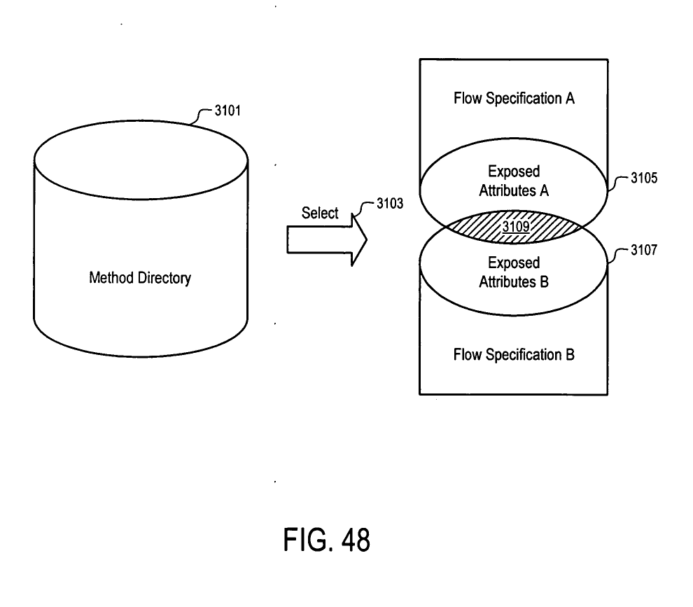

FIG. 48 illustrates a way to generate composite applications through joining attributes of workflows. In FIG. 48, a method directory (3101) is used to store information about a collection of workflow methods. The workflow methods may be workflow modules or workflow applications for a method processor. The method directory (3101) stores at least the set of exposed attributes of the workflow methods. The exposed attributes may be the variables in the global variable pools that accessible to external workflows. The exposed attributes may further include keywords which may be used to characterize aspects of the workflow methods.

The exposed attributes can be used to select (3103) relevant workflow methods for the generation of a composite application. For example, a workflow application (3107) has a set of exposed attributes. When another workflow application (3105) has a set of exposed attributes that at least partially matches the exposed attributes of the workflow application (3107), the at least partially matching workflow application (3105) can be selected for the generation of a composite application.

The selection may be based on the degree of matching. For example, a software tool may be used to rank the workflow applications according to an indicator that shows the matching levels computed based on the exposed attributes. A user interface may then present the top ranking workflow applications to the user for selection.

To start a composite application, the software tool may automatically combine the exposed attributes. For example, the new composite application may use the same exposed attributes as the union of the exposed attributes of the selected workflow applications, or the common part of the exposed attributes of the selected workflow applications.

The system may provide a plurality of options to combine the workflows. For example, the workflows of the selected applications may be connected one after another; alternatively, an option module may be used to receive an input; different input values lead to the different workflows of the respective applications. The user may have further modify the workflow generated by the system to create the composite application.

In one example, the software tool generates a composite application which keeps the common part (e.g., 3109) of the exposed attributes as the attributes of the composite application to link the selected workflow applications. For example, the software tool may automatically configure the composite application to update its attributes according to the corresponding attributes of a workflow application when the workflow leaves that workflow application; and automatically initialize the common part of the exposed attributes according to its attributes when the workflow enters the workflow application. The user may have further modify the workflow generated by the system to customize the composite application.

For example, an order management application may have public variables of a global variable pool such as activity, date, location, phone number, reason, title, who, etc. A delivery management application may have public variables of a global variable pool such as activity, custom, date, location, restaurants, store, who, etc. A composite application may be generated to have use public variables of a global variable pool including activity, custom, date, location, phone number, reason, restaurants, store, title, who, etc., which is the union of public global variables of the order management application and the delivery management application. Alternatively, a composite application may be generated to have the public global variables including activity, date, location, who, etc., which is the common part of the public global variables of the order management application and the delivery management application.

In another example, during the execution of the workflow (e.g., 3107), the matching workflow (e.g., 3105) may be automatically selected. The mobile device then provides a user interface element to allow the user to selectively launch the matching workflow (e.g., 3105). For example, a popup menu may be use to show the top list of the matching application which can be executed in the context of the current workflow (e.g., 3107). For example, key words in a user interface of the current application may be highlighted so that when selected the corresponding matching workflow application is launched. The matching workflow application may be executed in a separate thread. Alternatively, the current application may be converted into an eMethod queued in the inbound queue for later execution, after the matching workflow application is selected. When the matching workflow application is selected, the method processor automatically may initialize the matching workflow application using the common part of the exposed attributes of the current workflow application. Thus, information exposed from the current workflow application is automatically carried into the newly launched matching application.

The method processor may be configurable in how to carry information from one application to another. The initialization based on the common part of the attributes may be used as default. The user may further specify other customized ways of carrying data from one application into another. For example, before starting the matching application, the user may specify a customized way to initialize the matching application. The user may combine a set of variables of the current application to generate a value for a global value of the matching application. The customization may be stored as preferences of the user, which can be used subsequently. The user may further adds default values to some of the global values. Further, a workflow may be used to specify the conversion of variables.

The user may also specify a prefer the starting point of the matching workflow. The user may specify the conditions for the selection of applications. The method processor may be configured to select and run some of the applications automatically (e.g., under certain conditions).

The context for the selecting and/or launching of a matching application may be defined by a combination of multiple applications. For example, the context may be defined as two or more related application (e.g., running in different threads). A matching application may take data from the two or more related applications in the context.

Thus, over a period of time, the method process can learn how the user would like to run multiple applications. Different users may have different preferences. Some of the preferences may be used to derive best practices of a business process.

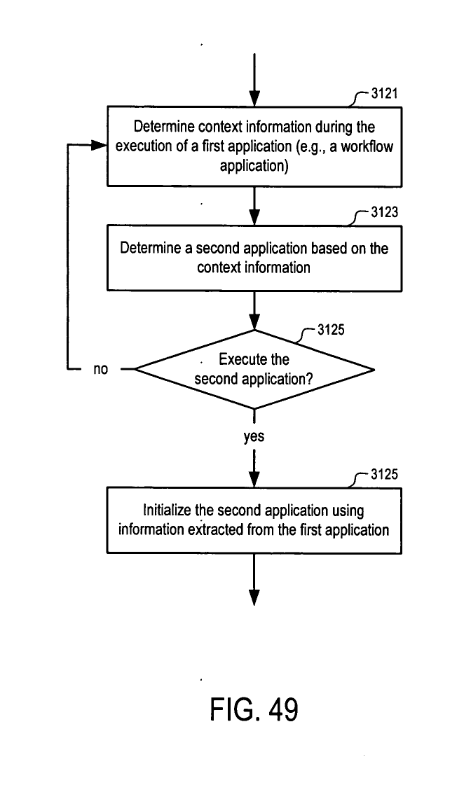

FIG. 49 illustrates a way to connection applications based on context. Applications may be discovered and executed based on the current context. In FIG. 49, context information is determined (3121) during the execution of a first application (e.g., a workflow application). For example, the method processor may monitor the entering and exiting of the flow into or out of various modules of a workflow application and determine the context. The context information may be derived from the value of a global variable accessed during the execution of the workflow application. The context information may be derived from the module that is being executed. A module may provide information during the execution (e.g., through a channel designed to collect context related information). The context information may be derived from the log data generated from the logger of the method processor.

A second application is determined (3123) based on the context information. For example, a set of selection criteria may be provided to the method processor to configure the selection of applications. When the context information matches a selection rule, an application can be selected according to the rule.

It is then determined whether to execute the second application (3125). The user may be prompt to execute the second application. For example, a dialog box may be opened to ask the user to indicate whether to run the second application; and the user may dismiss the offer to run the second application, accept the offer to run the second application, place the second application in an application queue, adjust the rule used for selecting the second application, etc. To place the second application into a queue, the system may package the data extracted from the current context with the second application as an eMethod and place the eMethod in an inbound queue.

Alternatively, the suggested application may be listed in an area for selection by the user. The user may ignore the suggestion, or select the application if interested. For example, the suggested application can be listed in a separate window on the screen; or, an alert may be displayed to indicate the availability of one or more suggested applications, which when selected can bring up a window that shows the list of suggested applications.

Certain applications may be configured to be executed when selected according to the context, without the need for further user interaction to indicate whether to run. Certain application may be configured to be automatically queued in the inbox of eMethods when selected according to the context.

To execute the second application, the system may initialize (3125) the second application using information extracted from the first application. This relieves the user from the burden of copying data that is available in the current context into the second application.

Thus, the system can intelligently combine workflow applications based on the context.

The intelligence to detect the current context for the launching of a related application may be implemented as part of the method processor (e.g., running on the mobile device), or implemented on a server which monitors the stream of log data from the mobile device, or implemented as a separate workflow application that runs in a separate thread.

The method processor may have a set of rules to select and launch workflow applications (or eMethods). A workflow application may be selected by another workflow application (or a set of applications). A workflow application may be selected by events, such as a phone call, a GPS location, a calendar event/alert, an email or instant message, a credit card alert, a timer or alarm clock, etc.

Various horizontal consumer market applications can be dynamically connected based on context. For example, applications for purchases, price comparisons, coupons, advertising, content and media searches, stock market tracking and transactions, instant messaging, etc. These applications can be transmitted to handhelds when needed. The execution of the applications are context sensitive, tailored to where the mobile device is and what the user is doing.

For example, a mobile device may have an “Instant Messaging Method” application, an “Entertainment Finder Method”, a “Mapping Method”, and other workflow methods.

During the use of the “Instant Messaging Method”, the method processor may detect the keyword “movies” appeared in the instant messages. The method processor determines that the user may now be interested in the service of the “Entertainment Finder Method”. Thus, the method processor caches the “Entertainment Finder Method” and highlights the keyword “movies”. If interested, the user may select the highlighted keyword “movies” to jump into the “Entertainment Finder Method”.

As the instant messaging continues, the “Entertainment Finder Method” (EFM) sees terms “Spiderman” and “Doom” for movie titles, and collects location information for these movies.

The method processor then detects the keyword “where” in the instant message sent, which indicates that the user may want to map a location. Thus, the method processor caches the “Mapping Method” and highlights keyword “where” as active; If interested, the user may select the highlighted keyword “where” to jump into the “Mapping Method”.

When the user clicks on the highlighted keyword “movies”, the method processor switches to the “Entertainment Finder Method”, which is pre-populated with information on “Spiderman” and “Doom”, such as the show times and theater location information determined based on the location of both users of the instant messaging session. Using the “Entertainment Finder Method” (EFM), the user can now easily reserve tickets for the interested show.

In another example, a mobile device has a “Calendar Method”, a “Jog Log Method”, a “Mapping Method”, a “Travel Method”, a “Store Finder Method”, a “Friend of a Friend Method”, an “Expense Method”, and other workflow methods.

A user may decide to get in shape and scheduled a 30 min jog every day using the “Calendar Method” on a mobile device. During the scheduled time for the jog, the method processor retrieves the “Jog Log Method” which can provide turn-by-turn directions through a headset for over 15,000 pre-set jogging paths in North America, including historic and “points of interest” voice-over. Optionally, cardio performance can also be monitored and recorded.

A meeting request may be presented and accepted (e.g., to discuss upcoming partner/customer presentation preparation with the vice president of business development and the chief technology officer). Thus, the “Calendar Method” marks the corresponding time slot for the meeting. The location of the meeting may be at the office.

Before the meeting, the method processor may determine that the user may travel to the office for the meeting and thus load the “Travel Method”.

The “Travel Method” can estimate that the user will be driving. Based on the activities of the car (e.g., in the last week), the “Travel Method” may calculate that the user will probably need to buy gasoline. Thus, the “Travel Method” may cause the “Calendar Method” to schedule an alert to remind the user to leave for the office 15 min earlier than normal to refuel.

Since the “Travel Method” determines the user may need to buy gasoline, the method processor loads the “Store Finder method” to find a recommended gas station with driving directions, based on price and the preference that the user likes fresh coffee during commute in the morning.

The user receives a phone call from a client on the mobile device. The user agree to attend an emergency meeting at the headquarter of the client. The emergency meeting is then scheduled using the “Calendar Method”.

The method processor uses the “Mapping Method” to determine the location of the emergency meeting. Since the meeting is to be held in another city (e.g., Pittsburgh, Pa.), the method processor loads the “Travel Method” to book for the user hotel, flights, car service to the airport and rental car at the destination.

From the information provided in the “Calendar Method”, the “Jog Log Method” knows that the user will be in Pittsburgh, Pa. and prepares a jogging session for the user to follow in the next morning.

The method processor may determine that the user may need an introduction in Pittsburgh. The “Friend of a Friend Method” is used in combination with the “Mapping Method” to find an introduction in Pittsburgh. A friend may introduce the user to an executive with whom the user confirms a meeting in Pittsburgh. The “Mapping Method” and the “Travel Method” can then arrange a car to the meeting and shuffle the flights home.

The user may receive a message from the daughter of the user. The message indicates that she needs a ride home from school at 5:00 p.m. The “Calendar Method” is then used to schedule an event to the daughter's school. Based on the statistical data, a thirty-minute event of one-on-one time with the daughter on the ride home is scheduled.

The “Travel Method” can then reschedule the return flight and the car service so that the user can stop by the school to pick-up the daughter.

Based on the calendar information, the “Expense Method” prepares the travel expense information for reimbursement.

Preparation of expense reports is time consuming. When filed late, they may distort earning reports. An “Expense Method” driven by a composite application approach can simplify the reparation of expense reports.

For example, an expense report application may automatically load various information into the appropriate forms (e.g., for each day), based on information available on the mobile device. The mobile device has the logger, the “Calendar Method”, and/or other workflow methods which can provide answers to various questions such as “where did you stay”, “where did you eat”, “who did you eat with?”, “what airline did you fly on”, “from where to where”, etc. Such information can be collected automatically from various sources to relieve the user from the burden of entering such information once again just for the expense reports.

For example, when the “expense report” application is opened, the workflow method may open to the current day and allow to user to:

1) scroll forward and backward to the day for which the user would like to enter or view data;

2) view flagged fields where additional information is needed;

3) make changes to information that is automatically populated by the mobile device; and

4) bring up one or more embedded applications (e.g., to obtain routing information by using a mapping service, such as Goole Local for Mobile).

The expense report form can be downloaded, which may include additional information such as mileage rates, etc. The expense report form can be implemented as a workflow, which can be changed as rules change. For example, new mileage allowances or different criteria for hotel room can be used; flight or meal charges may require further explanation; new questions, such as “Was there personal business part of this trip?”; can be added, source of lead can be collected; the time spent completing the expense report as well as when the expense report was worked on can be collected for later analysis. Depending on the capability of the device, the mobile device may further capture the signature for the expense report.

Further, as the device capability, the peripheral devices and supporting infrastructures are developed, the workflow method can be dynamically updated to include new functionalities. For example, receipts may be scanned (e.g., into a PDF format); amounts for airline fares, hotels and items purchased with a credit card may be configured to be downloaded automatically; etc.

Thus, in a composite environment, expense reporting can be built on calendar data and reservation data; customer updates may be supported using web based information sources; trip planner may use contact, travel and mapping resources; etc. Database access, small business CRM (customer relationship management), proof of delivery, route management, etc., can be combined in a on-demand, as needed basis to provide a flexible environment for mobile applications.

Similarly, various consumer market applications can be joined to generate a composite system, which may include modules for one or more of purchases, price comparisons, coupons, content and media searches, stock market tracking and transactions, purchases at fast food outlets, news, context sensitive information—tailored to where you are and what you are doing (e.g., if you're at a hotel, what restaurants, movies and fitness alternatives do you have), intelligent instant messaging with interactive multiparty opinion sharing, etc.

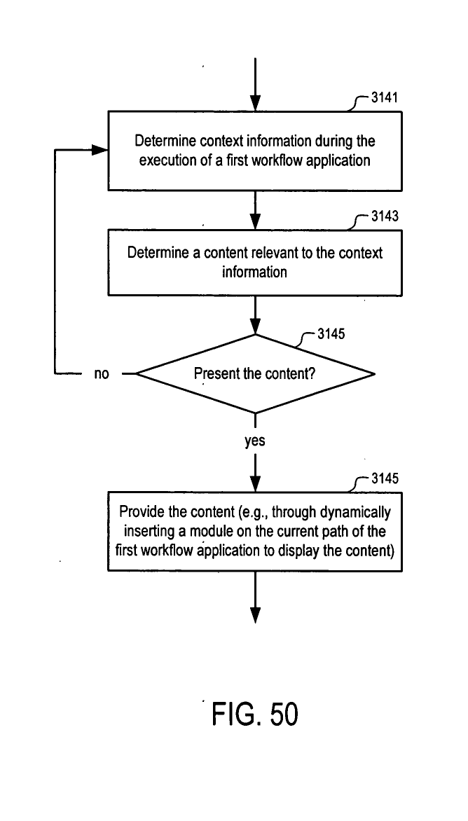

FIG. 50 illustrates a way to provide content based on context. Content may be discovered and provided based on the current context. Thus, the delivery of content can be targeted at the moment when the content is likely to be needed. In FIG. 50, context information is determined (3141) during the execution of a first application (e.g., a workflow application). For example, the method processor may monitor the entering and exiting of the flow into or out of various modules of a workflow application and determine the context. The context information may be derived from the value of a global variable accessed during the execution of the workflow application. The context information may be derived from the module that is being executed. A module may provide information during the execution (e.g., through a channel designed to collect context related information). The context information may be derived from the log data generated from the logger of the method processor.

A content relevant to the context information is determined (3143) based on the context information. For example, a set of selection criteria may be provided to the method processor to configure the selection of contents. When the context information matches a selection rule, a content can be selected according to the rule.

The content may include help information. For example, if the context information indicates that the user is deviating from a reference execution pattern, help information may be provided to train the user on-the-fly. Tips on techniques of using the workflow application may displayed. For example, a training session may be generated based on the current context, while preserving the state of the current workflow.

The content may include advertisement information. For example, if the current context indicates that the user is about to have a lunch break, advertisements for nearby restaurants may be provided to the user. For example, if the user is scheduling an out-of-town meeting, advertisements for hotel, flights and rental car services can be provided.

The content may include information related to the workforce management. For example, a performance goal with a current performance indicator may be displayed when the performance of the mobile user is improving, degrading, etc.

If it is determined to present the content (3145), the content is provided (3145). For example, a dialog box may be opened to present the information automatically; the user may dismiss place information in a message queue; and the user may adjust the rule used for selecting the content.

Alternatively, the suggested content may be listed in an area for the selection by the user. The user may ignore the suggestion, or select the content if interested. For example, the titles of the suggested content can be listed in a separate window on the screen; or, an alert may be displayed to indicate the availability of the suggested content, which when selected can bring up a window to show the list of titles.

Certain contents may be configured to be presented automatically when selected according to the context, without further user interaction. Certain contents may be configured to be automatically queued in the inbox of messages. Certain contents may be configured to be presented to the mobile user. Certain contents may be configured to be presented to a remote system (e.g., to a remote mobile user, or to a server).

The system may provide the content in a variety of ways. For example, the method processor may dynamically modify the first workflow application to insert a module on the current path to display the content. For example, the method processor may execute a separate workflow application to display the content. For example, the method processor may have a built-in module that displays the content without affecting the first workflow application.

The logic to detect the current context for the determination of a context sensitive content may be implemented as part of the method processor (e.g., running on the mobile device), or implemented on a server which monitors the stream of log data from the mobile device, or implemented as a separate workflow application that runs in a separate thread.

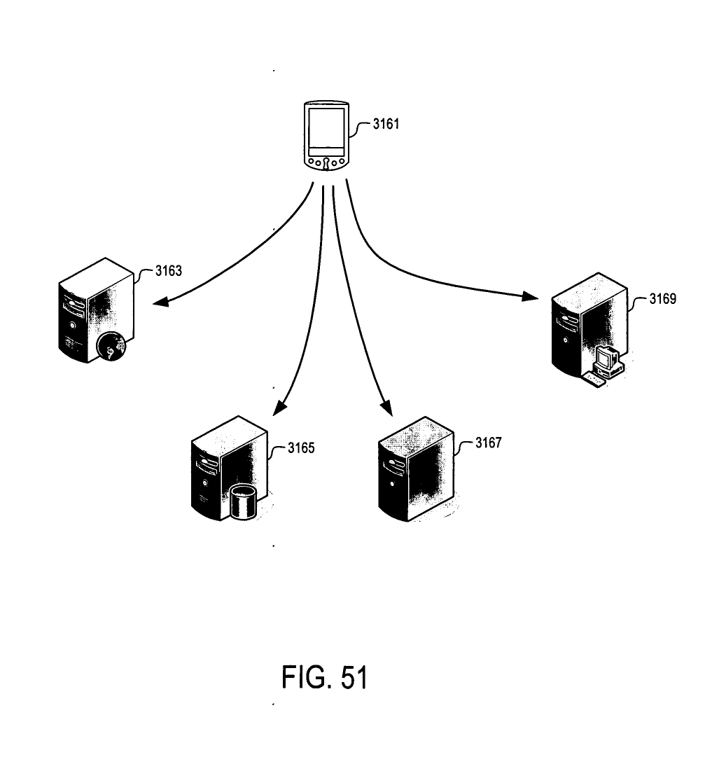

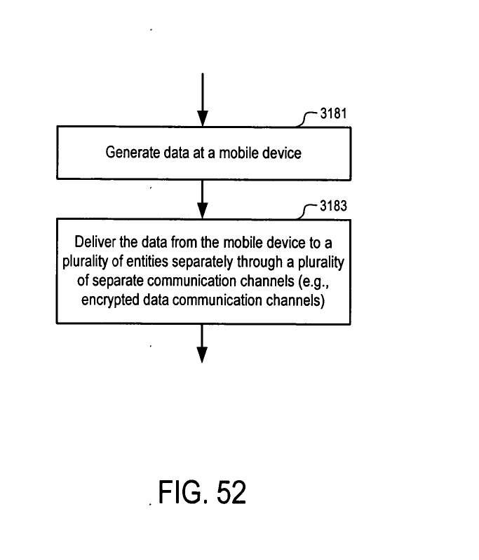

FIGS. 51-52 illustrate a way to distribute information. In FIG. 51, information collected at a mobile device (3161) can be transmitted to a plurality of systems (e.g., 3163-3169) directly over separate, secure data communication channels. Thus, each of the plurality of systems (e.g., 3163-3169) obtains the data from the mobile device (3161) independently from each other. Each of the plurality of systems (e.g., 3163-3169) obtains the original data directly from the source, the mobile device (3161), over a secure data communication channel (e.g., an encrypted data communication channel).

For example, the mobile device (3161) may establish a secure, authenticated communication channel with each of the plurality of systems (e.g., 3163-3169) to transmit the data. Each of the plurality of systems (e.g., 3163-3169) can authenticate the identity of the mobile device and determine that the data is from the mobile device (3161) without modification. The communication channels may share a portion of the physical data transmission media (e.g., a cable). However, data encryption ensures that the content for one of the system cannot be decrypted by another system without authorization. Thus, the data communication can be considered as being performed on separate logical communication channels.

For example, the encrypted data to the system (3169) may be accessible to the system (3163). However, since the system (3163) cannot decrypt the data, the data is not accessible to the system (3163).

The mobile device (3161) may send each of the plurality of systems (e.g., 3163-3169) an individual message including the data, encrypted with the public key of the corresponding recipient and signed with the private key of the mobile device (3161). Thus, each of the individual messages can be decrypted by the designated recipient but not by others (if the plurality of systems do not share their private keys); and each of the plurality of the system (e.g., 3163-3169) can verify that the data is from the mobile device (3161) using the public key of the mobile device (3161) (if the mobile device does not share its private key with others). The message may be transmitted over a real time communication connection (e.g., via web access, instant messaging, etc.) or over a sometime connected network (e.g., via email, eMethod, etc.).

If the communication links are available, the mobile device (3161) may send the data to the plurality of systems (3163-3169) substantially concurrently. Thus, the plurality of systems obtain the same data at substantially the same time.

Alternatively, the mobile device (3161) may send the data to the plurality of systems sequentially, one after another. If the communication links are available, the plurality of systems obtain the same data within a short time window. The order of the transmission to the plurality of systems may be randomly determined, or predetermined, or dynamically determined based on priority considerations.

In FIG. 52, after data is generated (3181) at a mobile device, the data is delivered from the mobile device to a plurality of entities separately through a plurality of separate communication channels (e.g., encrypted data communication channels.)

For example, a supplier may send merchandizes to a retail store. The driver of the delivery truck may carry a mobile device which can capture the signature after the retail store receives the merchandizes. The signature may be loaded into the server of the delivery company so that from the portal the interested party may check and determine the status of delivery.

To facilitate a new business model, the delivery order may include the request to send the delivery confirmation (e.g., data, time and content of the delivery and the signature of the retail store) to a plurality of entities, such as the supplier and a bank. The supplier may need a loan from the bank, secured by the merchandizes delivered to the retail store. The delivery confirmation may be needed for the bank to provide the loan. Thus, having the mobile device to transmit the delivery confirmation to the bank and the supplier can speed up the processing of the loan.

Further, the interest paid for the loan may be a function of the average period for the supplier to collect the payment from the retail store. When the delivery confirmation is made available to the supplier, the bank and the retail store, their can enter a new business relationship. For example, the retail store and the supplier may negotiate the average period for the payment of the delivered merchandizes, in view of the interest to be paid for the loan; and the supplier and the bank may negotiate the interest for the loan, in view of the promise of the retail store to pay for the delivered merchandizes.

In one example, the bank may purchase the account receivable from the supplier. Thus, upon the delivery of the merchandizes, the bank may collect the payment directly from the retail store.

In the above description, terms such as “first” and “second” may have been used to identify items or operations, such as image, form, module, stream of log data, execution of a workflow, etc. The use of such terms is intended to clearly identify items of a same type within an individual example. The use of such terms does not imply a particular time sequence relative to the operations described or implied in the individual example. For example, a “first” image may or may not be created before a “second image”; a “first” execution of a workflow may or may not have prior instances of execution of the workflow; a “second” execution of the workflow may or may not be prior to the “first” execution of the workflow; and there may or may not be other instances of execution of the workflow between the “second” execution of the workflow and the “first” execution of the workflow. Any item or operation may be identified as “first”, or “second”, or “third”, etc.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method, comprising:
maintaining a local persistent cache of an object of a workflow application;
communicating with the object to update the local persistent cache of the object; and
communicating with a remote system over a network communication link to check the object into the remote system.

2. The method of claim 1, wherein the network communication link is a sometime connected link.

3. The method of claim 1, further comprising:
initializing the object according to a schema of the object.

4. The method of claim 3, wherein said communicating with the remote system is based on the schema of the object.

5. The method of claim 3, further comprising:
determining a difference between a version of the object in the remote system and a version of the object in the workflow;
wherein the object is checked into the remote system via a transmission of the difference.

6. A method, comprising:
generating an object model based on input to an integrated development environment (IDE);
generating a source code for a class of objects based on the object model; and
generating metadata for object data access based on the object model.

7. The method of claim 6, wherein the object model includes a reference to a child object and an indication of whether the child object is part of an object generated according to the object model for data integrity.

8. The method of claim 7, wherein the object model includes a field to represent an identity of an object generated according to the object model.

9. A method, comprising:
maintaining at least one version of a data record;
receiving a first change to the data record from a first source to maintain at least two version of the data record;
receiving a second change to the data record from a second source; and
determining a conflict in more than two versions of the data record after the first and second changes are received.

10. The method of claim 9, wherein a conflict is detected when one same field is changed based on a same version.

11. A method, comprising:
retrieving data from an authoritative source;
maintaining the data at an integration server;
checking out the data from the integration server to a plurality of mobile devices;
checking in changes to the data from the plurality of mobile devices into the integration server;
resolving a consistent version of the data based on the changes; and
storing the consistent version of the data into the authoritative source.

12. The method of claim 11, wherein said maintaining the data at the integration server comprises: maintaining multiple versions of the data at the integration server via a version control system.

13. The method of claim 11, wherein said resolving a consistent version comprises:
transmitting a workflow application to one of the mobile devices to resolve a conflict.

14. A method, comprising:
determining an identity of an object;
determining an update to the object relative to a previous version of the object based on the identity of the object.

15. The method of claim 14, wherein the identity of the object is stored in a field of the object.

16. The method of claim 15, wherein the field of the object is identified based on an object model associated with the object.

17. The method of claim 14, further comprising:
determining whether a previous version of the object exists on a persistent memory based on the identity of the object.

18. A method, comprising:
including a parent object in an object group;
determining any child objects that are referenced to in the parent object and that are of a “Part Of” relation to the parent object; and
including the child objects in the object group.

19. A method, comprising:
storing one or more sets of differences between two or more versions of an object on a persistent memory of a local system; and
transmitting the one or more sets of differences from the local system to a remote system as a transaction to update a version of the object on the remote system.

20. A method, comprising:
determining a need to communicate with a remote system in processing a first workflow at a local system; and
preparing a second workflow and data for transmission to the remote system to continue the computation of the first workflow.

21. The method of claim 20, wherein the first workflow running on the local system is terminated after the second workflow and the data are prepared for the transmission to the remote system.

22. The method of claim 20, wherein the local system does not keep the first workflow running to wait for a response from the remote system.

23. The method of claim 20, wherein the second workflow and the data are transmitted to the remote system via an electronic mail system.

24. A method, comprising:
providing a graphical user interface to facilitate a visual manipulation of a workflow application that comprises a plurality of workflows connected by an event loop.

25. A method, comprising:
determining a combination of attributes of a plurality of applications; and
automatically generating a composite application based on the combination of attributes and the plurality of applications.

26. The method of claim 25, wherein the plurality of applications comprise workflow applications; and the combination is a union of exposed attributes of the plurality of applications.

27. The method of claim 25, wherein the plurality of applications comprise workflow applications; and intersects of exposed attributes of the plurality of applications are used to provide communication links between the plurality of applications.

28. A method, comprising:
determining context information during the execution of a first workflow application;
determining a content relevant to the context information; and
providing the content.

29. The method of claim 28, wherein said providing the content comprises dynamically inserting a module on the current path of the first workflow application to display the content.

30. The method of claim 28, wherein said determining a content comprises determining a second workflow application based on the context information.

31. The method of claim 30, wherein said providing the content comprises:
initializing the second application using information extracted from the first application.

32. A method, comprising:
generating data at a mobile device; and
delivering the data from the mobile device to a plurality of entities separately through a plurality of separate communication channels.

33. The method of claim 32, wherein the separate communication channels comprise encrypted data communication channels.

34. The method of claim 33, wherein the data is delivered from the mobile device to the plurality of entities concurrently.
